(19) United States
(12) Patent Application Publication
(10) Pub. No.: US 2008/0297703 A1
(43) Pub. Date: Dec. 4, 2008

(54) Optical Cellulose Acylate Film, Polarizing Plate And Liquid Crystal Display

(75) Inventors: Hiroyuki Kawanishi, Kanagawa (JP); Sumio Ohtani, Kanagawa (JP); Yosuke Nishiura, Kanagawa (JP); Takako Nishiura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/631,362

(22) PCT Filed: Jul. 1, 2005
(86) PCT No.: PCT/JP2005/012632

§ 371 Date: Jul. 7, 2008

(30) Foreign Application Priority Data
Jul. 1, 2004 (JP) 2004-196011
Sep. 27, 2004 (JP) 2004-278942
Feb. 25, 2005 (JP) 2005-051963

(51) Int. Cl. G02F 1/1335; C08F 251/02; B32B 23/04; C09K 19/02

(52) U.S. Cl. 349/96; 527/300; 428/220; 428/532; 428/1.31

(57) ABSTRACT

A cellulose acylate film is provided and includes a cellulose acylate as a polymer component. The cellulose acylate is a fatty acid ester of cellulose, obtained by substituting a hydroxyl group of cellulose with an acetyl group or an acyl group with 3 or more carbon atoms. The cellulose acylate film is a film stretched substantially by 10% or more in a casting direction or in a transversal direction to the casting direction, the film having a linear thermal expansion rate D(MD) in a casting direction (machine direction) and a linear thermal expansion rate D(TD) in a transversal direction to casting direction (i.e., perpendicular direction to casting direction) in a specified relationship. A polarizing plate utilizing such film and a liquid crystal display equipped with such polarizing plate are provided.

### TECHNICAL FIELD

The present invention relates to an optical cellulose acylate film, a polarizing plate utilizing the same as an optical compensation film, and a liquid crystal display provided with such polarizing plate.

### BACKGROUND ART

A liquid crystal display is employed widely in a monitor of a personal computer or a mobile equipment, a television and the like, owing to various advantages such as a low-voltage drive, a low electric power consumption, a compact and thin structure. Such liquid crystal display is proposed in various modes depending on an arrangement of liquid crystal molecules in a liquid crystal cell, but there has been principally utilized a TN mode in which the liquid crystal molecules are twisted by about 90° from a lower substrate to an upper substrate of the liquid crystal cell.

In general, a liquid crystal display is formed by a liquid crystal cell, an optical compensation sheet, and a polarizer. The optical compensation sheet is employed for canceling a coloration on an image and for expanding a viewing angle, and is formed by a stretched birefringent film or a film formed by coating a transparent film with a liquid crystal. For example Japanese Patent No. 2587398 discloses a technology of applying an optical compensation sheet, formed by coating, orienting and fixing a discotic liquid crystal on a triacetyl cellulose film, to a liquid crystal cell of TN mode thereby widening the viewing angle.

However, in a liquid crystal display for a television which has a large image size and is anticipated to be observed from various angles, a requirement for a dependence on the viewing angle is very strict and cannot be met with the aforementioned technology. For this reason, liquid crystal displays of various modes other than the TN mode, such as an IPS (in-plane switching) mode, an OCB (optically compensatory bend) mode and a VA (vertically aligned) mode. In particular, the VA mode has a high contrast and a relatively high production yield and is thus attracting attention as the liquid crystal display for the television application.

A cellulose acylate film has a feature of a relatively high optical isotropy (low retardation) in comparison with other polymer films. Therefore, a cellulose acylate film is commonly employed in an application requiring an optical isotropy such as a polarizing plate.

On the other hand, an optical compensation film (phase difference film) of a liquid crystal display requires an optical anisotropy (high retardation). In particular, an optical compensation film for VA mode requires a retardation (Re) in a film plane of 30 to 200 nm and a retardation in a thickness direction (Rth) of 70 to 400 nm. It is therefore common to utilize a synthetic polymer film of a high retardation such as a polycarbonate film or a polysulfone film as the optical compensation film. A retardation in a film plane and a retardation in a thickness direction are respectively defined by following equations (2) and (3):

Re=(nx−ny)×d (2)

Rth={(nx+ny)/2−nz}×d (3)

wherein, nx represents a refractive index in a direction of an x-direction in the film plane; ny represents a refractive index in a y-direction in the film plane; nz represents a refractive index in a direction perpendicular to the film plane; and d indicates a film thickness (μm).

Thus, in the technical field of optical materials, it has been a general rule to employ a synthetic polymer film in case an optical anisotropy (high retardation) is required, and a cellulose acylate film in case an optical isotropy (low retardation) is required.

EP-A No. 0911656A2 proposes, contrary to such general rule, a cellulose acylate film having a high retardation, applicable also to an application requiring an optical anisotropy. In such proposal, in order to realize a high retardation in cellulose triacetate, an aromatic compound having at least two aromatic rings, particularly a compound having a 1,3,5-triazine ring, is added and a stretching process is executed. In general, cellulose triacetate is known to be a polymer material difficult to stretch and to realize a large birefringence, but a high birefringence is made possible by orienting the additive simultaneously at the stretching process. Such film can also be used as a protective film of a polarizing plate, thus capable of providing a thin liquid crystal display inexpensively.

JP-A No. 2002-71957 discloses an optical film characterized in including a cellulose ester having an acyl group with 2 to 4 carbon atoms as a substituent and satisfying simultaneously:

2.0≦A+B≦3.0 and

A<2.4

wherein A is a substitution degree of an acetyl group and B is a substitution degree of a propionyl or butylyl group, and in that a refractive index Nx in a direction of a phase retarding axis and a refractive index Ny in a direction of a fast axis at a wavelength of 590 nm satisfy:

0.0005≦Nx−Ny≦0.0050.

JP-A No. 2002-270442 discloses a polarizing plate for use in a VA-mode liquid crystal display including a polarizer and an optically biaxial film of a cellulose ester of mixed fatty acids, in which such optically biaxial film of a cellulose ester of mixed fatty acids is positioned between the liquid crystal cell and the polarizer.

The methods disclosed in the aforementioned references are effective in obtaining a thin and inexpensive liquid crystal display. However, the liquid crystal display is recently often used in various environments such as a high humidity or a high temperature, and the cellulose ester film utilizing the aforementioned technologies is associated with a drawback that the optical compensating function is lowered under such environments. More specifically, in case the film has a large linear thermal expansion rate, the film tends to cause a dimensional change under a high temperature to induce a deterioration in the optical compensation function thereby resulting in an unevenness or the like. Also under a high temperature, the film causes a coloration thereby resulting in a deterioration in the optical compensation function.

Therefore, there is desired a development of a film showing little change in the optical compensation function under such environments and capable of providing a thin and inexpensive liquid crystal display.

### DISCLOSURE OF THE INVENTION

An object of an illustrative, non-limiting embodiment of the invention is to provide an optical film excellent in developing a retardation in a film plane (an in-plane retardation) and a retardation in a thickness direction, and showing little change in the optical compensation function by environmental conditions such as temperature.

Another object of an illustrative, non-limiting embodiment of the invention is to provide a liquid crystal display showing little change in viewing angle characteristics under environmental changes and a polarizing plate for use in such liquid crystal display.

As a result of intensive investigations for attaining the aforementioned objectives, the present inventors have found it effective to control a substitution degree of a cellulose acylate, used as a raw material for a cellulose acylate film, and have further found that the aforementioned objectives can be attained by a specified substitution degree, a specified linear thermal expansion rate and a ratio of the linear thermal expansion rates in a casting direction and a perpendicular direction thereto maintained within a specified range, and thus the present invention has been made.

More specifically, the aforementioned objectives of the invention are attained by an optical cellulose acylate film, a polarizing plate and a liquid crystal display of following aspects:

1. A cellulose acylate film comprising a cellulose acylate as a polymer component, wherein the cellulose acylate is a fatty acid ester of cellulose, and a hydroxyl group of the cellulose is substituted with an acetyl group or an acyl group having 3 or more carbon atoms,

wherein the cellulose acylate film is a film stretched substantially by 10% or more in a casting direction or in a transversal direction perpendicular to the casting direction, and the cellulose acylate film satisfies relations (II) to (IV):

30 ppm≦D(MD)≦90 ppm (II)

25 ppm≦D(TD)≦90 ppm (III)

1.0≦D(MD)/D(TD)≦5.0 (IV)

wherein D(MD) represents a linear thermal expansion rate in the casting direction, and D(TD) represents a linear thermal expansion rate D(TD) in the transversal direction.
2. The cellulose acylate film as described in item 1, which satisfies a relation (I):

2.0≦A+B≦3.0 (I)

wherein A represents a substitution degree of the acetyl group, and B represents a substitution degree of the acyl group having 3 or more carbon atoms.
3. The cellulose acylate film as described in item 1 or 2, which has a color difference ΔE*ab before and after a standing for 500 hours at 90° C. of 0.5 or less and a color difference before and after a standing for 24 hours at 140° C. of 1.5 or less.
4. The cellulose acylate film as described in any one of items 1 to 3, wherein the linear thermal expansion rates D(MD) and D(TD) satisfy a relation (V):

50 ppm≦D(MD)≦75 ppm,30 ppm D(TD)≦75 ppm (V).

5. The cellulose acylate film as described in any one of items 1 to 4, which satisfies relations (VI-a), (VI-b) and (VI):

2.0≦DS2+DS3+DS6≦3.0 (VI-a)

DS6/(DS2+DS3+DS6)≧0.315 (VI-b)

1.0≦D(MD)/D(TD)≦3.0 (VI)

wherein DS2 represents a substitution degree of a 2-position hydroxyl group of a glucose unit of the cellulose acylate film by the acetyl group or the acyl group, D3 represents a substitution degree of a 3-position hydroxyl group by the acetyl group or the acyl group, and D6 represents a substitution degree of a 6-position hydroxyl group by the acetyl group or the acyl group.
6. The cellulose acylate film as described in any one of items 1 to 5, wherein the acyl group is a butanoyl group.
7. The cellulose acylate film as described in any one of items 1 to 5, wherein the acyl group is a propionyl group, and the substitution degree B is 0.6 or higher.
8. The cellulose acylate film as described in any one of items 1 to 7, wherein Re(λ) and Rth(λ) defined by relations (IX) and (X), respectively, satisfy relations (IX) to (XII):

Re(λ)=(nx−ny)×d (IX)

Rth(λ)={(nx+ny)/2−nz}×d (X)

30 nm≦Re₍₅₉₀₎≦200 nm (XI)

70 nm≦Rth₍₅₉₀₎≦400 nm (XII)

wherein Re(λ) is a retardation value by nm in a film plane of the cellulose acylate film at a wavelength λ nm, Rth(λ) is a retardation value by nm in a thickness direction of the cellulose acylate film at a wavelength λ nm, nx is a refractive index in a slow axis direction of the film plane, ny is a refractive index in a fast axis direction of the film plane, nz is refractive index in the thickness direction, and d is a thickness of the cellulose acylate film.
9. The cellulose acylate film as described in item 8, wherein Re₍₅₉₀₎ and Rth₍₅₉₀₎ satisfy relations (XIII) and (XIV):

40≦Re₍₅₉₀₎≦100 (XIII)

170 nm≦Rth₍₅₉₀₎≦300 nm (XIV).

10. The cellulose acylate film as described in any one of items 1 to 9, which comprises at least one retardation developing agent of a rod-shaped and discotic compound.
11. The cellulose acylate film as described in any one of items 1 to 10, which comprises at least one of a plasticizer, an ultraviolet absorber and a peeling accelerator.
12. The cellulose acylate film as described in any one of items 1 to 11, which has a thickness of 40 to 180 μm.
13. The cellulose acylate film as described in any one of items 1 to 12, wherein a difference ΔRe between an Re value at 25° C., 10% RH and an Re value at 25° C., 80% RH is 0 to 10 nm, and a difference ΔRth between an Rth value at 25° C., 10% RH and an Rth value at 25° C., 80% RH is 0 to 30 nm.
14. The cellulose acylate film as described in any one of items 1 to 13, wherein the cellulose acylate film is a film stretched by one of a monoaxial stretching method, a simultaneous biaxial stretching method and a successive biaxial stretching method.
15. The cellulose acylate film as described in any one of items 1 to 14, wherein Re₍₆₃₀₎ and Rth₍₆₃₀₎ at 25° C., 60% RH satisfy relations (A) to (C):

46≦Re₍₆₃₀₎≦150 (A)

Rth₍₆₃₀₎=a−5.9Rth₍₆₃₀₎ (B)

580≦a≦670 (C)

wherein Re₍₆₃₀₎ is a retardation value by nm in a film plane of the cellulose acylate film at a wavelength of 630 nm, Rth₍₆₃₀₎ is a retardation value by nm in a thickness direction of the cellulose acylate film at a wavelength of 630 nm, and a is a regulating coefficient by nm of an optical characteristics of the cellulose acylate film.
16. The cellulose acylate film as described in any one of items 1 to 15, which has a thickness distribution R of 0 to 8%, the thickness distribution R being calculated by R(%)=(Rₘₐₓ−Rₘᵢₙ)/Rₐᵥₑ×100, wherein Rₘₐₓ, Rₘᵢₙ, and Rₐᵥₑ represents a maximum value, a minimum value and an average value of a thickness in the transversal direction, respectively.
17. The cellulose acylate film as described in any one of items 1 to 16, which has a Re₍₅₉₀₎ distribution of 5% or less.
18. The cellulose acylate film as described in any one of items 1 to 17, which has a Rth₍₅₉₀₎ distribution of 10% or less.
19. The cellulose acylate film as described in any one of items 1 to 18, wherein the cellulose acylate has a polymerization degree of 250 to 350 and a total substitution degree of 2.65 to 2.95, and
the cellulose acylate film satisfies relations:

6 kgf/mm²≦BS(MD)≦14 kgf/mm²

12 kgf/mm²≦BS(TD)≦20 kgf/mm²

wherein BS(MD) represents a breaking strength of the cellulose acylate film in the casting direction, and BS(TD) represents a breaking strength of the cellulose acylate film in the transversal direction.
20. A polarizing plate comprising: two protective films; and a polarizer between the two protective film, wherein one of the two protective films is a cellulose acylate film as described in any one of items 1 to 19.
21. The polarizing plate as described in item 20, which satisfies at least one of formulae (a) to (d):

40.0≦TT≦45.0 (a)

30.0≦PT≦40.0 (b)

CT≦2.0 (c)

95.0≦P (d)

wherein TT represents a single plate transmittance at 25° C. and 60% RH, PT represents a parallel transmittance at 25° C. and 60% RH, CT represents a cross transmittance at 25° C. and 60% RH, and P represents a polarization degree at 25° C. and 60% RH.
22. The polarizing plate as described in item 20 or 21, which satisfies at least one of formulae (e) to (g):

T(380)≦2.0 (e)

T(410)≦1.0 (f)

T(700)≦0.5 (g)

wherein T(λ) represents a cross transmittance at the wavelength of λ nm.
23. The polarizing plate as described in any one of items 20 to 22, which satisfies at least one of formulae (j) and k):

−6.0≦ΔCT≦6.0 (j)

−10.0≦ΔP≦0.0 (k)

wherein ΔCT and ΔP represents a change in cross transmittance and polarization degree, respectively, in a test that the polarizing plate is allowed to stand at 60° C. and 95% RH for 500 hours; and the change means a value calculated by subtracting a measurement value before the test from a measurement value after the test.
24. The polarizing plate as described in item 23, wherein one of the two protective films comprises at least one of a hard coat layer, an antiglare layer and an antireflective layer.
25. A liquid crystal display comprising a cellulose acylate film as described in any one of items 1 to 19 or a polarizing plate as described in any one of items 20 to 24.
26. A liquid crystal display of an OCB or VA mode comprising two polarizing plate as described in any one of items 20 to 24; and a liquid crystal cell between the two polarizing plate.
27. A liquid crystal display of a VA mode comprising a liquid crystal cell; a backlight; and a polarizing plate as described in any one of items 20 to 24 between the liquid crystal cell and the backlight.

An optical cellulose acylate film of the invention is excellent in developing an in-plane retardation and a retardation in a thickness direction, and is limited in a linear thermal expansion rate and an anisotropy thereof under an environmental change such as temperature.

A polarizing plate of the invention, utilizing such optical cellulose acylate film as a protective film of a polarizer, provides a liquid crystal display showing little change in the viewing angle characteristics even under a change in the environmental conditions (temperature).

A liquid crystal display of the invention, provided with the optical cellulose acylate film or the polarizing plate of the invention, shows little change in the viewing angle characteristics even under a change in the environmental conditions (temperature).

### BRIEF DESCRIPTION OF THE DRAWINGS

FIG. 1 is a schematic view showing an adhering method for a cellulose acylate film in the manufacture of an illustrative, non-limiting embodiment of a polarizing plate of the invention.

FIG. 2 is a schematic cross-sectional view showing a cross-sectional structure of an illustrative, non-limiting embodiment of a polarizing plate of the invention.

FIG. 3 is a schematic cross-sectional view showing a cross-sectional structure of an illustrative, non-limiting embodiment of a polarizing plate of the invention.

### DETAILED DESCRIPTION OF THE INVENTION

An exemplary embodiment of the invention will be described in detail below. In the present specification, in case a physical property or a characteristic property is represented by a numerical value, the description “(numerical value 1)˜(numerical value 2)” or “(numerical value 1) to (numerical value 2)” means the range that falls between the numerical value 1 and the numerical value 2 both inclusive. Also in the present specification, a description “(meth)acryloyl” means “at least either of acryloyl and methacryloyl”, and “(meth)acrylate” or “(meth)acrylic acid” has a similar meaning. Also in case a hydrogen atom is substituted with an atom other than the hydrogen atom, such another atom is considered as a substituent for the purpose of convenience.

At first there will be given an explanation on the optical cellulose acylate film of the invention.

(Cellulose Acylate)

A specified cellulose acylate to be employed in the invention will be explained in detail. In the invention, two or more different cellulose acylates may be employed in mixture.

The specified cellulose acylate is a fatty acid ester of cellulose obtained by substituting a hydroxyl group of cellulose with an acetyl group and an acyl group with 3 or more carbon atoms, preferably with a substitution degree of the acyl group on the hydroxyl group of cellulose satisfying a relation (I):

2.0≦A+B≦3.0 (I)

wherein A and B represent a substitution degree of the acyl group on the hydroxyl group of cellulose, in which A is a substitution degree of the acetyl group and B is a substitution degree of the acyl group with 3 or more carbon atoms.

A glucose unit with a β-1,4 bond, constituting cellulose, has free hydroxyl groups in 2-, 3- and 6-positions. Cellulose acylate is a polymer formed by esterifying all or a part of such hydroxyl groups with acyl groups. An acyl substitution degree means a proportion of esterification of cellulose in each of the 2-, 3- and 6-positions (for each position, a substitution degree 1 corresponds to an esterification of 100%).

In the glucose unit of the cellulose acylate film, a substitution degree DS2 of the 2-position hydroxyl group with an acyl group including acetyl group, a substitution degree DS3 of the 3-position hydroxyl group with an acyl group including acetyl group and a substitution degree DS6 of the 6-position hydroxyl group with an acyl group including acetyl group preferably satisfy following relations (VI-a) and (VI-b), together with a relation (VI) relating to a thermal expansion rate to be explained later:

2.0≦DS2+DS3+DS6≦3.0 (VI-a)

DS6/(DS2+DS3+DS6)≧0.315 (VI-b)

In the invention, a sum of substitution degrees of A and B (A+B) is preferably 2.0-3.0 as indicated by the relation (I), more preferably 2.2-2.95, and particularly preferably 2.40-2.85 or 2.65-2.95. Also a substitution degree B may be 0, and, in case not 0, is preferably 0.9 or higher and particularly preferably 1.3 or higher.

An A+B value equal to or higher than 2.0 provides a weak hydrophilicity, thus being less susceptible to an environmental humidity.

In case B is 0 to constitute a cellulose acetate, it becomes more susceptible to the influence of the environmental humidity but less susceptible to the influence of the environmental temperature as the linear thermal expansion rate becomes smaller in comparison with a case where B is not 0, thereby suppressing an unevenness or the like in a display on the liquid crystal display.

Also it is preferable that 28% or more of B are substitutions on the 6-position hydroxyl groups, more preferably 30% or more are substitutions on the 6-position hydroxyl groups, further preferably 31% or more and particularly preferably 32% or more are substitutions on the 6-position hydroxyl groups.

There is also preferred in the cellulose acylate film that a sum of the substitution degree of A and B in the 6-position of cellulose acylate is 0.75 or higher, further 0.80 or higher and particularly 0.85 or higher. Such cellulose acylate film allows to prepare a solution satisfactory in solubility and filterability, and to prepare a satisfactory solution even with a non-chlorinated organic solvent. Also there can be prepared a solution of a low viscosity with satisfactory filterability.

An acyl group with 3 or more carbon atoms can be an aliphatic group or an aromatic hydrocarbon group and is not particularly restricted. It can for example be an alkylcarbonyl ester, an alkenylcarbonyl ester, an aromatic carbonyl ester, or an aromatic alkylcarbonyl ester of cellulose, each of which may further have a substituent. Preferred examples of B include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexanecarbonyl group, an oleoyl group, a benzoyl group, a naphthylcarbonyl group and a cinnamoyl group. Among these, preferred ones include a propionyl group, a butanoyl group, a dodecanoyl group, an octadecanoyl group, a t-butanoyl group, an oleoyl group, a benzoyl group, a naphthylcarbonyl group and a cinnamoyl group. Particularly preferred ones are a propionyl group and a butanoyl group. In case of a propionyl group, a substitution degree B is preferably 0.6 or higher.

The cellulose acylate can specifically be cellulose acetate, cellulose acetate propionate or cellulose acetate butyrate.

(A Method for Synthesizing Cellulose Acylate)

A basic principle of a method for synthesizing cellulose acylate is described in Migita et al., Mokuzai Kagaku, p. 180-190 (Kyoritsu Shuppan, 1968). A representative synthesizing method is a liquid phase acylation utilizing a carboxylic anhydride-acetic acid-sulfuric acid catalyst.

More specifically, a cellulose raw material such as cotton linter or wood pulp is pre-treated with a suitable amount of acetic acid, and is esterified by charging into a pre-cooled carboxylating liquid mixture to synthesize a complete cellulose acylate (a sum of 2-, 3- and 6-position acyl substitution degrees being almost 3.00). The carboxylating liquid mixture generally contains acetic acid as a solvent, a carboxylic anhydride as an esterifying agent, and sulfuric acid as a catalyst. The carboxylic anhydride is usually employed in excess of a stoichiometric amount with respect to a sum of cellulose reacting therewith and water present in the system. After the esterification reaction, an aqueous solution of a neutralizing agent (such as a carbonate, an acetate or an oxide of calcium, magnesium, iron, aluminum or zinc) for hydrolyzing the excessive carboxylic anhydride and neutralizing a part of the esterification catalyst. Then the obtained complete cellulose acylate is saponified by maintaining at 50-90° C. in the presence of a small amount of an acetylation catalyst (generally remaining sulfuric acid) thereby being modified to a cellulose acylate having an acyl substitution degree and a polymerization degree of a desired level. When a desired cellulose acylate is obtained, the catalyst remaining in the system is completely neutralized with the aforementioned neutralizing agent or the cellulose acylate solution is charged, without neutralization, into water or diluted sulfuric acid (or water or diluted sulfuric acid being charged into the cellulose acylate solution) whereupon the cellulose acylate is separated, rinsed and subjected for example to a stabilizing process to obtain the specified cellulose acylate mentioned above.

In the cellulose acylate film, a polymer component constituting the film is preferably constituted substantially of the aforementioned specified cellulose acylate. “Substantially” means 55 weight % or higher of the polymer component (preferably 70 weight % or higher and more preferably 80 weight % or higher).

Cellulose acylate is preferably used in a particulate state. It is preferable that 90 weight % or more of the particles to be used have a particle size of 0.5-5 mm. It is also preferable that 50 weight % or more of the particles to be used have a particle size of 1-4 mm. The cellulose acylate particles preferably have a shape as close as possible to a spherical shape.

The cellulose acylate employed in the invention preferably has a viscosity-averaged polymerization degree of 200-700, more preferably 250-550, further preferably 250-400 and particularly preferably 250 to 350. An average polymerization degree can be measured by a limit viscosity method of Uda et al. (Kazuo Uda and Hideo Saito, Sen-i Gakkai-shi, Vol. 18, No. 1, pp. 105-120, 1962). It is also described in detail in JP-A No. 9-95538.

An elimination of a low-molecular component elevates an average molecular weight (polymerization degree), but lowers the viscosity than in the ordinary cellulose acylate, so that an elimination of a low-molecular component is favorable for the cellulose acylate. Cellulose acylate with reduced low-molecular component can be obtained by eliminating a low-molecular component from cellulose acylate synthesized in an ordinary method. The elimination of a low-molecular component can be achieved by washing the cellulose acylate with a suitable organic solvent. In case of producing a cellulose acylate of a reduced low-molecular component, it is preferable to regulate an amount of sulfuric acid catalyst in the acetylation reaction to 0.5-25 parts by weight with respect to 100 parts by weight of cellulose acylate. An amount of the sulfuric acid catalyst within the range mentioned above allows to synthesize cellulose acylate with a preferable (uniform) molecular weight distribution. The cellulose acylate, in case used at the manufacture, preferably has a water content of 2 weight % or less, more preferably 1 weight % or less and particularly preferably 0.7 weight % or less. Cellulose acylate generally contains water with a water content of 2.5-5 weight %. For attaining a water content mentioned above, a drying is preferably executed, and a drying method is not particularly restricted as long as a desired water content can be reached.

A raw material cotton and a synthesizing method of cellulose acylate can be those described in detail in the Japan Institute of Invention and Innovation, Laid-open Technical Report (2001-1745, issued Mar. 15, 2001, JIII), pages 7-12.

The cellulose acylate film of the invention can be obtained by forming a film from a solution, formed by dissolving the aforementioned specified cellulose acylate and an additive if necessary in an organic solvent.

(Additives)

In the invention, additives that can be employed in the cellulose acylate solution include a plasticizer, an ultraviolet absorber, an antideterioration agent, a retardation (optical anisotropy) developing agent, fine particles, a peeling accelerator, and an infrared absorber. In the invention, a retardation (optical anisotropy) developing agent is preferably employed. Also there is preferably employed at least one of a plasticizer, an ultraviolet absorber and a peeling accelerator.

Such additive may be a solid or an oily substance. Thus a melting point or a boiling point is not particularly restricted. It is thus possible to employ an ultraviolet absorber having a melting point of 20° C. or lower and an ultraviolet absorber having a melting point of 20° C. or higher in a mixture or to employ plasticizers in a mixture in a similar manner, as described in JP-A No. 2001-151901.

Any ultraviolet absorber may be employed according to the purpose, such as a salicylate ester type, a benzophenone type, a benzotriazole type, a benzoate type, a cyanoacrylate type or a nickel complex type, preferably a benzophenone type, a benzotriazole type, or a salicylate ester type. Examples of the benzophenone ultraviolet absorber include 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone, and 2-hydroxy-4-(2-hydroxy-3-methacryloxy)propoxybenzophenone. Examples of a benzotriazole ultraviolet absorber include 2(2′-hydroxy-3′-tert-butyl-5′-methylphenyl)-5-chlorobenzotriazole, 2(2′-hydroxy-5′-tert-butylphenyl)benzotriazole, 2(2′-hydroxy-3′,5′-di-tert-amylphenyl)benzotriazole, 2(2′-hydroxy-3′,5′-di-tert-butylphenyl)-5-chlorobenzotriazole, and 2(2′-hydroxy-5′-tert-octylphenyl)benzotriazole. Examples of a salicylate ester include phenyl salicylate, p-octylphenyl salicylate, and p-tert-butylphenyl salicylate. Among these, there are particularly preferred 2-hydroxy-4-methoxybenzophenone, 2,2′-dihydroxy-4,4′-methoxybenzophenone, 2(2′-hydroxy-3′-tert-butyl-5′-methylphenyl)-5-chlorobenzotriazole, 2(2′-hydroxy-5′-tert-butylphenyl)benzotriazole, 2(2′-hydroxy-3′,5′-di-tert-amylphenyl)benzotriazole, and 2(2′-hydroxy-3′,5′-di-tert-butylphenyl)-5-chlorobenzotriazole.

The ultraviolet absorber is preferably employed in a combination of plural absorbers of different absorption wavelengths for obtaining a high intercepting effect over a wide wavelength range. The ultraviolet absorber for a liquid crystal preferably has an excellent absorption for an ultraviolet light of a wavelength of 370 nm and less for the purpose of preventing deterioration of the liquid crystal, and has a low absorption for a visible light of a length of 400 nm and longer, in consideration of the property of the liquid crystal display. Particularly preferred ultraviolet absorber is a benzotriazole type, a benzophenone type, or a salicylate ester type mentioned above, and a a benzotriazole type is particularly preferable as it shows little unnecessary coloration on the cellulose ester.

As the ultraviolet absorber, there can also be employed compounds described in JP-A Nos. 60-235852, 3-199201, 5-1907073, 5-194789, 5-271471, 6-107854, 6-118233, 6-148430, 7-11056, 7-11055, 7-11056, 8-29619, 8-239509, and 2000-204173.

An amount of the ultraviolet absorber is preferably 0.001-5 weight % with respect to the cellulose acylate in order to obtain an effect of addition and to suppress a bleeding-out of the ultraviolet absorber, more preferably 0.01-1 weight %.

The ultraviolet absorber may be added simultaneously with the dissolution of cellulose acylate, or may be added to a dope after dissolution. Particularly preferred is a method of adding a solution of the ultraviolet absorber to the dope immediately before a casting operation by a static mixer or the like, as it allows an easy regulation of the spectral absorption characteristics.

The antideterioration agent prevents a deterioration or a decomposition of cellulose triacetate and the like. Examples of the antideterioration agent include a butylamine, a hindered amine compound (JP-A No. 8-325537), a guanidine compound (JP-A No. 5-271471), a benzotriazole UV absorber (JP-A No. 6-235819) and a benzophenone UV absorber (JP-A No. 6-118233).

The plasticizer is preferably a phosphate ester or a carboxylate ester. Preferred specific examples of the plasticizer include triphenyl phosphate (TPP), tricresyl phosphate (TCP), cresyl diphenyl phosphate, octyl diphenyl phosphate, diphenyl biphenyl phosphate, trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethyl hexyl phthalate (DEHP), triethyl o-acetylcitrate (OACTE), tributyl o-acetylcitrate (OACTB), acetyl triethyl citrate, acetyl tributyl citrate, butyl oleate, methyl acetyl licinoate, dibutyl sebacate, triacetylene, tributyrin, butylphthalyl butyl glycolate, ethylphthalyl ethyl glycolate, methylphthalyl ethyl glycolate, and butylphthalyl butyl glycolate. Preferred plasticizers also include a (di)pentaerythritol ester, a glycerol ester and a diglycerol ester.

The peeling accelerator can be an ethyl ester of citric acid. Also the infrared absorber is described for example in JP-A No. 2001-194522.

Such additives may be added in any stage in a dope preparation process, or in an additive adding step which may be added as a final regulating step to the dope preparation process. An amount of use of each material is not particularly limited as long as a function of each material can be exhibited. Also in case the cellulose acylate film has plural layers, a type and an amount of the additives may be different in each layer, for example as described in JP-A No. 2001-151902, but such is an already known technology.

In the cellulose acylate film of the invention, a linear thermal expansion rate D(MD) in a casting direction (i.e., a machine direction) and a linear thermal expansion rate D(TD) in a transversal direction to the casting direction (a perpendicular direction to the casting direction) preferably satisfy relations (II), (III) and (IV), further relations (V) and (VI):

30 ppm≦D(MD)≦90 ppm (II)

25 ppm≦D(TD)≦90 ppm (III)

1.0≦D(MD)/D(TD)≦5.0 (IV)

50 ppm≦D(MD)≦75 ppm,30 ppm D(TD)≦75 ppm (V) and

1.0≦D(MD)/D(TD)≦3.0 (VI).

The cellulose acylate film of the invention can have a linear thermal expansion rate satisfying the aforementioned relations, by a stretching factor, a type and an amount of the plasticizer, and a selection of the cotton.

The linear thermal expansion rate D(MD) in a casting direction (machine direction) and the linear thermal expansion rate D(TD) in a transversal direction to casting (perpendicular direction to casting), satisfying the relations (II)-(VI), have following technical meanings. A change in environmental condition (temperature) induces a contraction or an expansion in the polarizing plate constituting parts such as an adhesive layer, a phase difference film, a polarizer, a protective film and the like thereby generating a stress between the constituents. The aforementioned relations allow such stress to be well balanced between the polarizing plate constituting parts, whereby the polarizing plate provides a liquid crystal display with little change in the viewing angle characteristics, thus providing a favorable result.

The cellulose acylate film of the invention preferably has a glass transition point Tg of 70-180° C., more preferably 100-170° C. and further preferably 120-160° C. The glass transition point Tg can be measured by a dynamic viscoelasticity measuring device (Vibron DVA-225, manufactured by IT Keisoku Seigyo Co.). The glass transition point can also be regulated in the aforementioned range by suitably selecting a type and an amount of the plasticizer. The cellulose acylate film of the invention preferably has a glass transition point Tg within the aforementioned range, in consideration of adaptability to a process of preparing the polarizing plate and a process of assembling the liquid crystal display.

Also there can be suitably employed additives described in the Japan Institute of Invention and Innovation, Laid-open Technical Report (2001-1745, issued Mar. 15, 2001, JIII), page 16 and thereafter.

(Retardation Developing Agent)

In the invention, a retardation developing agent is preferably employed, in order to realize a preferred retardation.

A retardation developing agent employable in the invention can be a rod-shaped compound or a discotic compound.

The rod-shaped or discotic compound can be a compound having at least two aromatic rings.

An amount of the retardation developing agent constituted of a rod-shaped compound is preferably 0.1 to 30 parts by weight with respect to 100 parts by weight of the polymer component containing the cellulose acylate, more preferably 0.5 to 20 parts by weight.

An amount of the retardation developing agent constituted of a discotic compound is preferably 0.05 to 20 parts by weight with respect to 100 parts by weight of the polymer component containing the cellulose acylate, more preferably 0.1 to 10 parts by weight, further preferably 0.2 to 5 parts by weight, and most preferably 0.5 to 2 parts by weight.

A discotic compound is superior in the Rth retardation developing property to the rod-shaped compound, and is preferably employed when a particularly large Rth retardation is required.

Two or more retardation developing agents may be employed in combination.

The retardation developing agent constituted of the rod-shaped or the discotic compound preferably has a maximum absorption within a wavelength region of 250 to 400 nm, and is preferably substantially free from an absorption in the visible region.

There will be given an explanation on the discotic compound. As the discotic compound, there can be employed a compound having at least two aromatic rings.

In the present specification, an “aromatic ring” includes an aromatic hydrocarbon ring and an aromatic heterocycle.

The aromatic hydrocarbon ring is particularly preferably a 6-membered ring (namely a benzene ring).

The aromatic heterocycle is generally an unsaturated heterocycle. The aromatic heterocycle is preferably a 5-, 6- or 7-membered ring, and more preferably a 5- or 6-membered ring. The aromatic heterocycle usually has a possible maximum number of double bonds. A hetero atom is preferably a nitrogen atom, an oxygen atom or a sulfur atom, and particularly preferably a nitrogen atom. Examples of the aromatic heterocycle include a furan ring, a thiophene ring, a pyrrole ring, an oxazole ring, an isooxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, there is preferred a benzene ring, a furan ring, a thiophene ring, a pyrole ring, an oxazole ring, a thiazole ring, an imidazole ring, a triazole ring, a pyridine ring, a pyrimidine ring, a pyrazine ring or a 1,3,5-triazine ring, and a 1,3,5-triazine ring is particularly preferable. More specifically, compounds for example disclosed in JP-A No. 2001-166144 can be advantageously employed.

The discotic compound preferably has 2 to 20 aromatic rings, more preferably 2 to 12 aromatic rings, further preferably 2 to 8 aromatic rings, and most preferably 2 to 8 aromatic rings.

A bonding relationship between the two aromatic rings can be classified into (a) a case of forming a condensed ring, (b) a case of direct bonding with a single bond, and (c) a case of bonding through a connecting group (no spiro bond being possible because of the aromatic rings). The bonding relationship may be any of (a) to (c).

Examples of the case (a) of a condensed ring (condensed ring of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromen ring, a quinoline ring, an isoquinoline ring, a quinolidine ring, a quinazoline ring, a cinnoline ring, a quinoxaline ring, a phthalazine ring, a puteridine ring, a carbazole ring, an acrydine ring, a phenanthridine ring, a xanthene ring, a phanazine ring, a phenothiazine ring, a phenoxathiine ring, a phenoxazine ring and a thiantlirene ring, and a naphthalene ring, an azulene ring, an indole ring, a benzoxazole ring, a benzotliazole ring, a benzimidazole ring, a benzotriazole ring or a quinoline ring is preferable.

The single bond (b) is preferably a bond between carbon atoms of the two aromatic rings. It is possible to connect the two aromatic rings with two or more single bonds thereby forming an aliphatic ring or a non-aromatic heterocycle between the two aromatic rings.

Also the connectin group (c) is preferably connected with carbon atoms of the two aromatic rings. The connecting group is preferably an alkylene group, an alkenylene group, —CO—, —O—, —NH—, —S— or a combination thereof. Examples of the connecting group formed by such combination are shown in the following. The following examples of the connecting group may be inverted in the lateral direction.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the connecting group may have a substituent.

Examples of the substituent include a halogen atom (F, Cl, Br or I), a hydroxyl group, a carboxyl group, a cyano group, an amino group, a nitro group, a sulfo group, a carbamoyl group, a sulfamoyl group, an ureido group, an alkyl group, an alkenyl group, an alkinyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group and a non-aromatic heterocyclic group.

An alkyl group preferably has 1 to 8 carbon atoms. A linear alkyl group is preferable to a cyclic alkyl group, and a straight-chain alkyl group is particularly preferable. The alkyl group may further have a substituent (such as a hydroxyl group, a carboxyl group, an alkoxy group, an alkyl-substituted amino group). Examples of the alkyl group (including substituted alkyl group) include a methyl group, an ethyl group, an n-butyl group, an n-hexyl group, a 2-hydroxyethyl group, a 4-carboxybutyl group, a 2-methoxyethyl group and a 2-diethylaminoethyl group.

An alkenyl group preferably has 2 to 8 carbon atoms. A linear alkenyl group is preferable to a cyclic alkenyl group, and a straight-chain alkenyl group is particularly preferable. The alkenyl group may further have a substituent. Examples of the alkenyl group include a vinyl group, an allyl group and a 1-hexenyl group.

An alkinyl group preferably has 2 to 8 carbon atoms. A linear alkinyl group is preferable to a cyclic alkinyl group, and a straight-chain alkinyl group is particularly preferable. The alkinyl group may further have a substituent. Examples of the alkinyl group include an ethinyl group, a 1-butinyl group and a 1-hexinyl group.

An aliphatic acyl group preferably has 1 to 10 carbon atoms. Examples of the aliphatic acyl group include an acetyl group, a propanoyl group and a butanoyl group.

An aliphatic acyloxy group preferably has 1 to 10 carbon atoms. Examples of the aliphatic acyloxy group include an acetoxy group.

An alkoxy group preferably has 1 to 8 carbon atoms. The alkoxy group may further have a substituent (such as an alkoxy group). Examples of the alkoxy group (including substituted alkoxy group) include a methoxy group, an ethoxy group, a butoxy group and a methoxyethoxy group.

An alkoxycarbonyl group preferably has 2 to 10 carbon atoms. Examples of the alkoxycarbonyl group include a methoxycarbonyl group and an ethoxycarbonyl group.

An alkoxycarbonylamino group preferably has 2 to 10 carbon atoms. Examples of the alkoxycarbonylamino group include a methoxycarbonylamino group and an ethoxycarbonylamino group.

An alkylthio group preferably has 1 to 12 carbon atoms. Examples of the alkylthio group include a methylthio group, an ethylthio group and an octylthio group.

An alkylsulfonyl group preferably has 1 to 8 carbon atoms. Examples of the alkylsulfonyl group include a methanesulfonyl group and an ethanesulfonyl group.

An aliphatic amide group preferably has 1 to 10 carbon atoms. Examples of the aliphatic amide group include an acetamide group.

An aliphatic sulfonamide group preferably has 1 to 8 carbon atoms. Examples of the aliphatic sulfonamide group include a methanesulfonamide group, a butanesulfonamide and an n-octanesulfonamide group.

An aliphatic substituted amino group preferably has 1 to 10 carbon atoms. Examples of the aliphatic substituted amino group include a dimethylamino group, a diethylamino group and a 2-carboxyethylamino group.

An aliphatic substituted carbamoyl group preferably has 2 to 10 carbon atoms. Examples of the aliphatic substituted carbamoyl group include a methylcarbamoyl group, and a diethylcarbamoyl group.

An aliphatic substituted sulfamoyl group preferably has 1 to 8 carbon atoms. Examples of the aliphatic substituted sulfamoyl group include a methylsulfamoyl group, and a diethylsulfamoyl group.

An aliphatic substituted ureido group preferably has 2 to 10 carbon atoms. Examples of the aliphatic substituted ureido group include a methylureido group.

Examples of a non-aromatic heterocyclic group include a piperidino group and a morpholino group.

A retardation developing agent formed by a discotic compound preferably has a molecular weight of 300 to 800.

In the invention, a rod-shaped compound having a linear molecular structure may also be employed advantageously, in addition to the discotic compound mentioned above. A linear molecular structure means that the rod-shaped compound has a linear molecular structure in a thermodynamically most stable structure. A thermodynamically most stable structure can be determined by a crystalline structure analysis or by a molecular orbit calculation. For example, it is possible to execute a molecular orbital calculation with a molecular orbit calculation software (for example WinMOPAC2000, manufactured by Fujitsu Ltd.) thereby determining a molecular structure minimizing a heat of formation of the compound. A linear molecular structure means that, in the thermodynamically most stable structure obtained by a calculation as explained above, a main chain of the molecular structure forms an angle of 140° or larger.

A rod-shaped compound preferably has at least two aromatic rings, and a rod-shaped compound having at least two aromatic rings is preferably represented by the following formula (1):

Ar¹-L¹-Ar²

In the formula (1), Ar¹ and Ar² each independently represents an aromatic group.

In the present specification, an aromatic group includes an aryl group (aromatic hydrocarbon group), a substituted aryl group, an aromatic heterocyclic group and a substituted aromatic heterocyclic group.

An aryl or substituted aryl group is preferable to an aromatic heterocyclic or substituted aromatic heterocyclic group. The heterocycle in the aromatic heterocyclic group is generally unsaturated. The aromatic heterocycle is preferably a 5-, 6- or 7-membered ring, and more preferably a 5- or 6-membered ring. The aromatic heterocycle usually has a possible maximum number of double bonds. A hetero atom is preferably a nitrogen atom, an oxygen atom or a sulfur atom, and more preferably a nitrogen atom or a sulfur atom.

As the aromatic ring or the aromatic group, there is preferred a benzene ring, a furan ring, a thiophene ring, a pyrole ring, an oxazole ring, a thiazole ring, an imidazole ring, a triazole ring, a pyridine ring, a pyrimidine ring, or a pyrazine ring, and a benzene ring is particularly preferable.

Examples of a substituent on the substituted aryl group and the substituted aromatic heterocyclic group include a halogen atom (F, Cl, Br or I), a hydroxyl group, a carboxyl group, a cyano group, an amino group, an alkylamino group (such as a methylamino group, an ethylamino group, a butylamino group or a dimethylamino group), a nitro group, a sulfo group, a carbamoyl group, an alkylcarbamoyl group (such as N-methylcarbamoyl group, an N-ethylcarbamoyl group or an N,N-dimethylcarbamoyl group), a sulfamoyl group, an alkylsulfamoyl group (such as N-methylsulfamoyl group, an N-ethylsulfamoyl group or an N,N-dimethylsulfamoyl group), an ureido group, an alkylureido group (such as an N-methylureido group, an N,N-dimethylureido group or an N,N,N′-trimethylureido group), an alkyl group (such as a methyl group, an ethyl group, a propyl group, a butyl group, a pentyl group, a heptyl group, an octyl group, an isopropyl group, an s-butyl group a t-amyl group, a cyclohexyl group or a cyclopentyl group), an alkenyl group (such as a vinyl group, an allyl group, or a hexenyl group), an alkinyl group (such as an ethinyl group or a butinyl group), acyl group (such as a formyl group, an acetyl group, a butyryl group, a hexanoyl group or a lauryl group), an acyloxy group (such as an acetoxy group, a butyryloxy group, a hexanoyloxy group or a lauryloxy group), an alkoxy group (such as a methoxy group, an ethoxy group, a propoxy group, a butoxy group, a pentyloxy group, a heptyloxy group or an octyloxy group), an aryloxy group (such as a phenoxy group), an alkoxycarbonyl group (such as a methoxycarbonyl group, an ethoxycarbonyl group, a propoxycarbonyl group, a butoxycarbonyl group, a pentyloxycarbonyl group or a heptyloxycarbonyl group), an aryloxycarbonxyl group (such as a phenoxycarbonyl group), an alkoxycarbonylamino group (such as a butoxycarbonylamino group, or a hexyloxycarbonylamino group), an alkylthio group (such as a methylthio group, an ethylthio group, a propylthio group, a butylthio group, a pentylthio group, a heptylthio group or an octylthio group), an arylthio group (such as a phenylthio group), an alkylsulfonyl group (such as a methyl sulfonyl group, an ethylsulfonyl group, a propylsulfonyl group, a butylsulfonyl group, a pentylsulfonyl group, a heptylsulfonyl group or an octylsulfonyl group), an amide group (such as an acetamide group, a butylamide group, a hexylamide group or a laurylamide group), and a non-aromatic heterocyclic group such as a morphoryl group or a pyradinyl group).

A substituent for the substituted aryl group or the substituted aromatic heterocyclic group is preferably a halogen atom, a cyano group, a carboxyl group, a hydroxyl group, an amino group, an alkyl-substituted amino group, an acyl group, an acyloxy group, an amide group, an alkoxycarbonyl group, an alkoxy group, an alkylthio group or an alkyl group.

An alkyl portion of an alkylamino group, an alkoxycarbonyl group, an alkoxy group or an alkylthio group, or the alkyl group may further has a substituent.

Examples of the substituent on the alkyl portion and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, an ureido group, an alkylureido group, an alkenyl group, an alkinyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amide group, and a non-aromatic heterocyclic group. As the substituent on the alkyl portion and the alkyl group, there is preferred a halogen atom, a hydroxyl group, an amino group, an alkylamino group, an acyl group, an acyloxy group, an acylamino group, an alkoxycarbonyl group or an alkoxy group.

In the formula (1), L¹ is a divalent connecting group selected from an alkylene group, an alkenylene group, —O—, —CO—, or a combination thereof.

The alkylene group may have a cyclic structure. A cyclic alkylene group is preferably cyclohexylene, particularly preferably 1,4-cyclohexylene. As a linear alkylene group, a straight-chain alkylene group is preferable to a branched alkylene group.

The alkylene group preferably has 1 to 20 carbon atoms, more preferably 1 to 15 carbon atoms, further preferably 1 to 10 carbon atoms, and particularly preferably 1 to 8 carbon atoms, and most preferably 1 to 6 carbon atoms.

The alkenylene group or the alkinylene group more preferably has a linear structure than a cyclic structure, and more preferably a straight-chain structure than a branched-chain structure.

The alkenylene group or the alkinylene group preferably has 2 to 10 carbon atoms, more preferably 2 to 8 carbon atoms, further preferably 2 to 6 carbon atoms, particularly preferably 2 to 4 carbon atoms, and most preferably 2 carbon atoms (vinylene or ethinylene).

The arylene group preferably has 6 to 20 carbon atoms, more preferably 6 to 16 carbon atoms and further preferably 6 to 12 carbon atoms.

In the molecular structure of the formula (1), an angle formed by Ar¹ and Ar² interleaving L¹ is preferably 140° or larger.

As the rod-shaped compound, a compound represented by a following formula (2) is further preferable.

Ar¹-L²-X-L³-Ar² formula (2)

In the formula (2), Ar¹ and Ar² each independently represents an aromatic group, of which definition and example are same as those for Ar¹ and Ar² in the formula (1).

In the formula (2), L² and L³ each independently represents a divalent connecting group selected from an alkylene group, —O—, —CO—, or a combination thereof.

The alkylene group more preferably has a linear structure than a cyclic structure, and a straight-chain structure than a branched linear structure.

The alkylene group preferably has 1 to 10 carbon atoms, more preferably 1 to 8 carbon atoms, further preferably 1 to 6 carbon atoms, particularly preferably 1 to 4 carbon atoms, and most preferably 1 or 2 carbon atoms (methylene or ethylene).

L² and L³ each is particularly preferably —O—CO— or —CO—O—.

In the formula (2), X represents 1,4-cyclohexylene, vinylene or ethinylene.

In the following, specific examples of the compound represented by the formula (1) or (2) are shown.

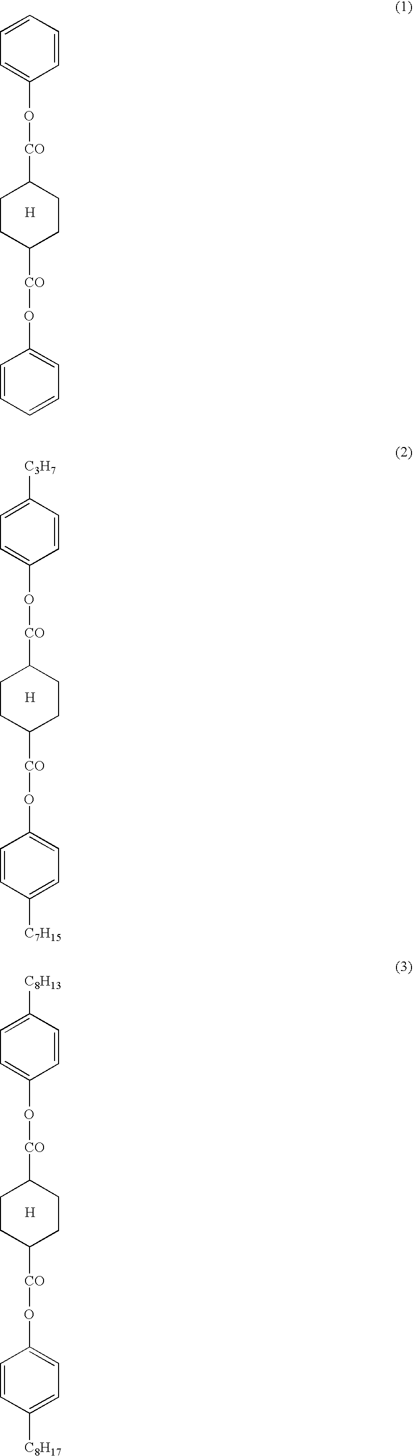

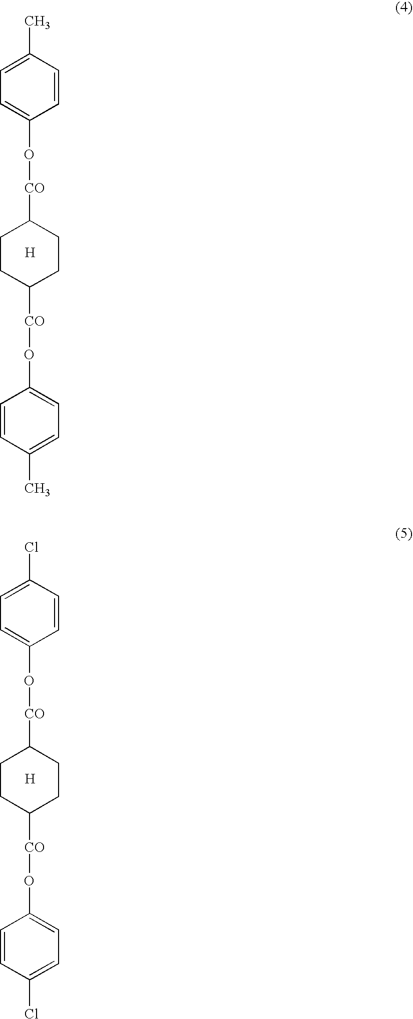

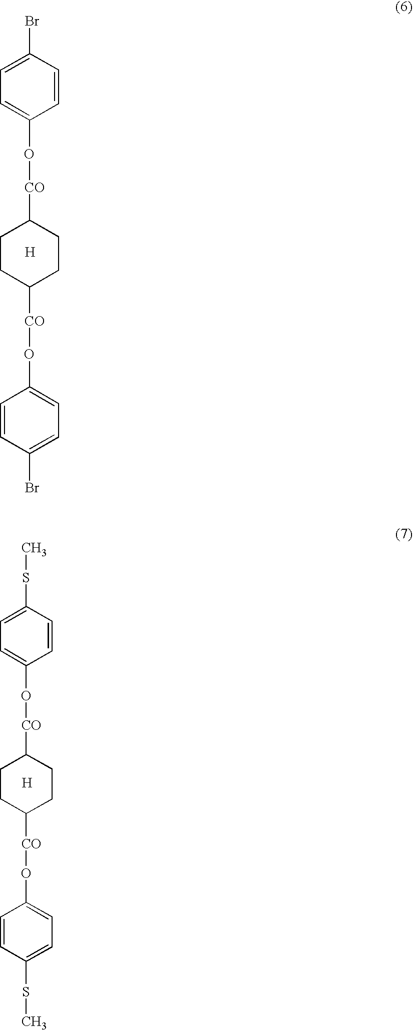

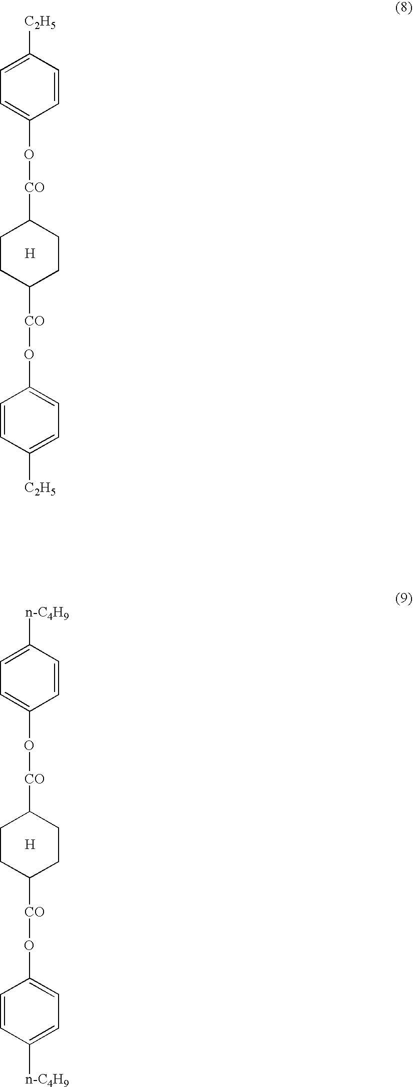

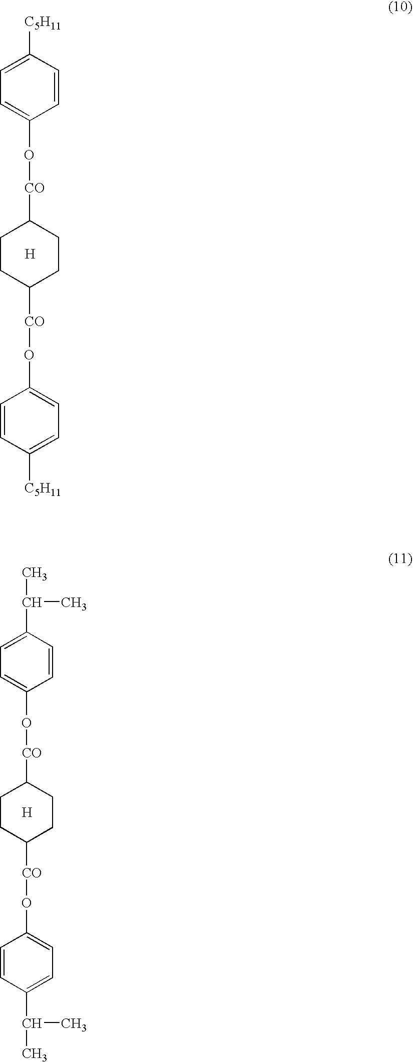

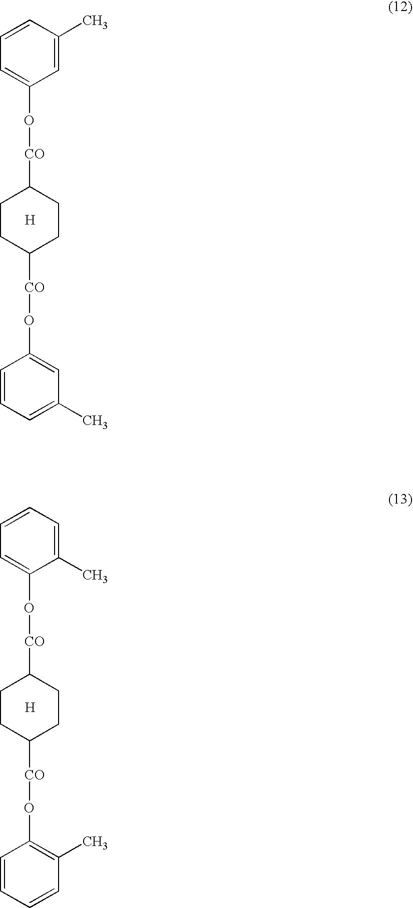

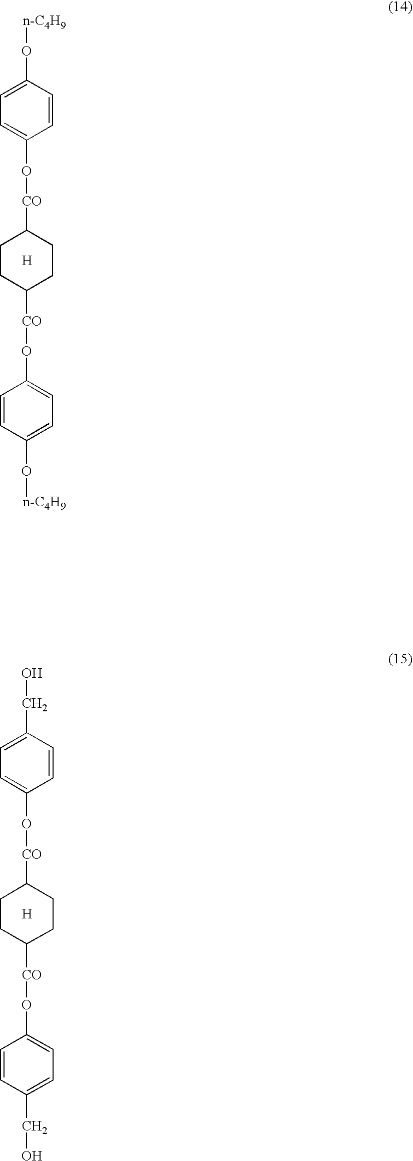

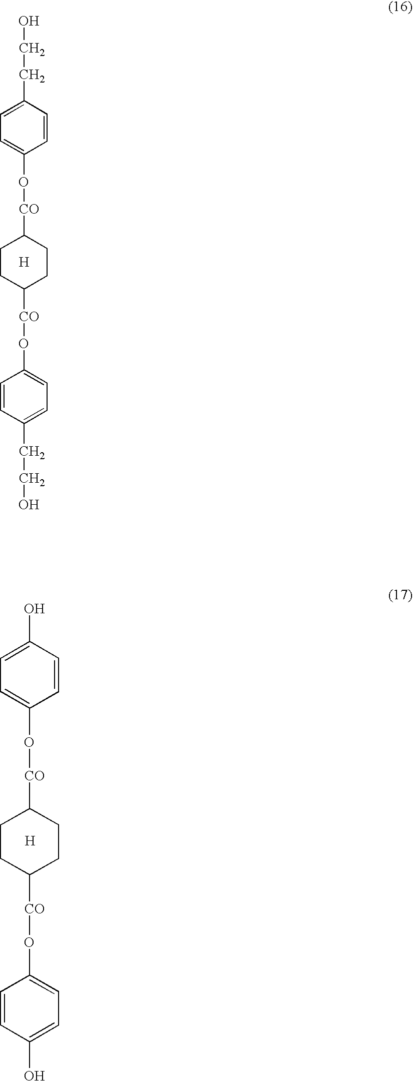

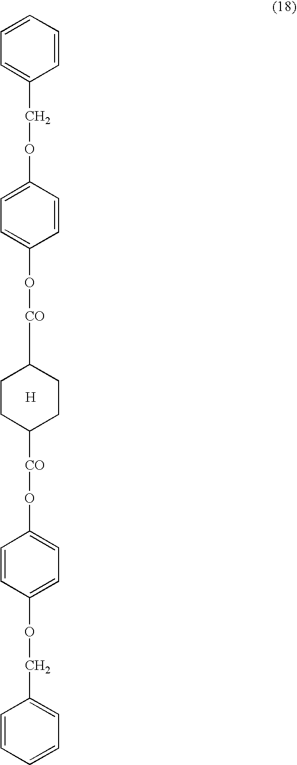

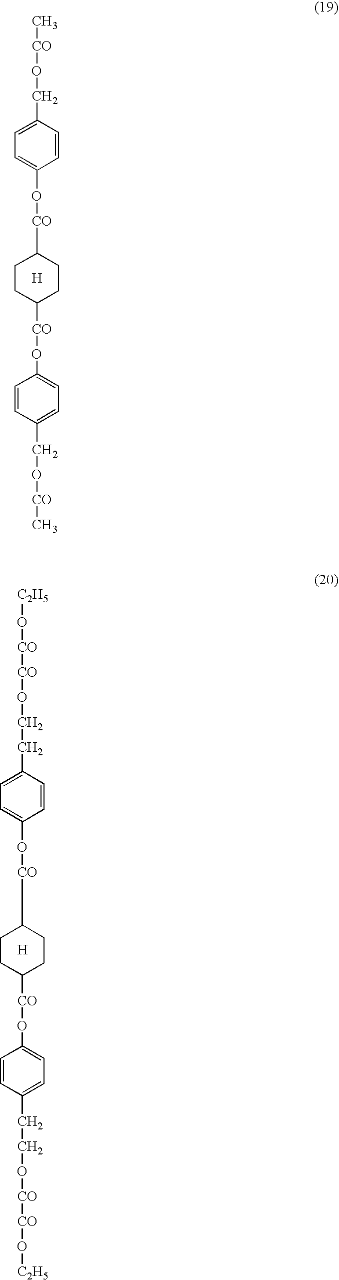

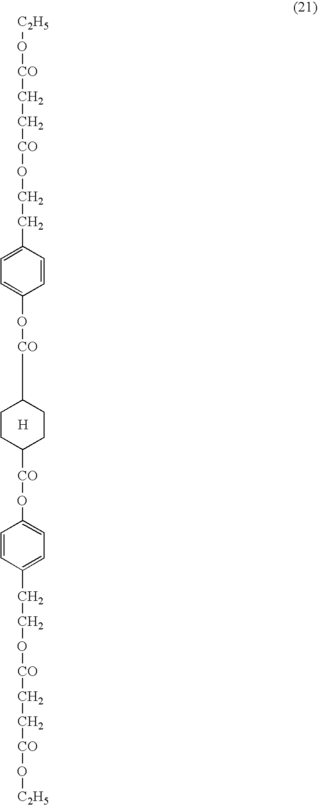

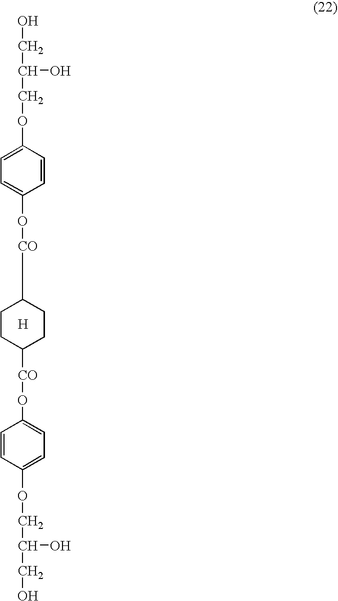

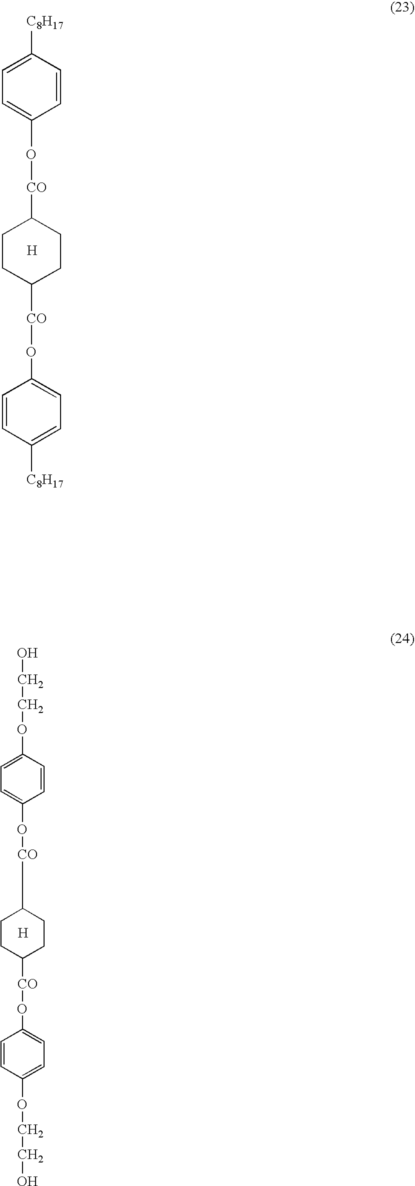

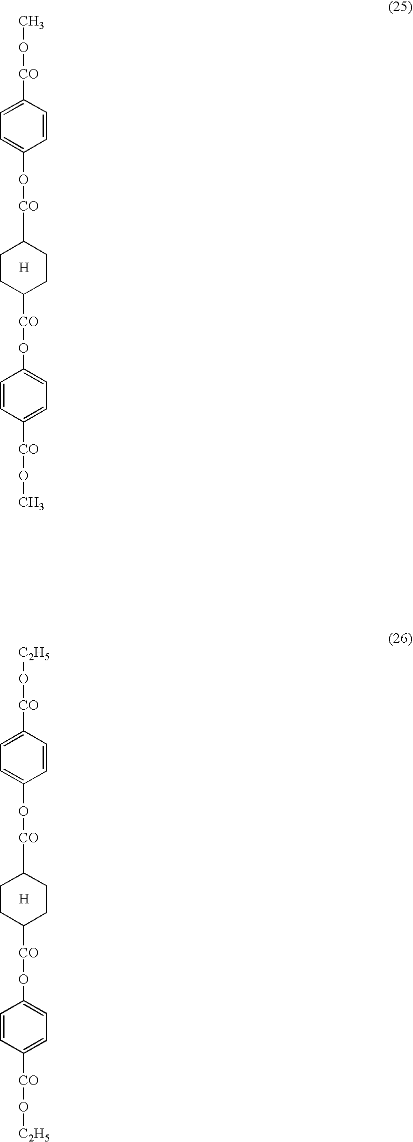

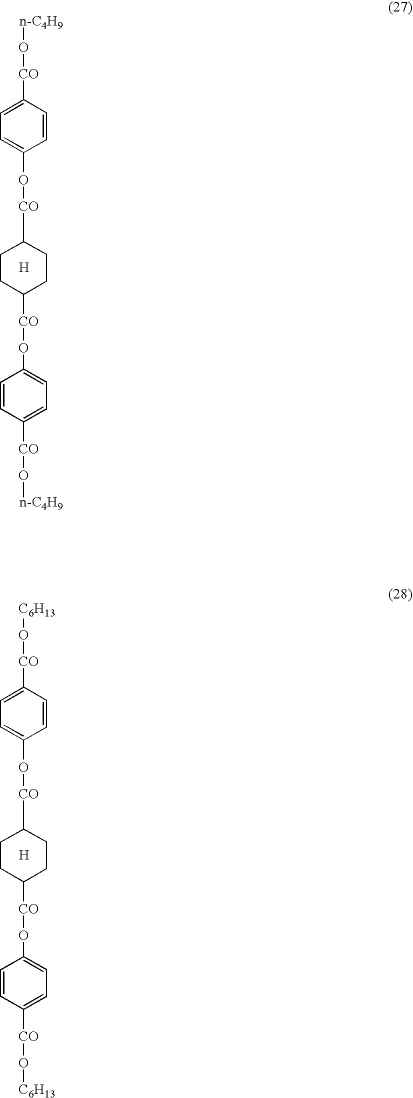

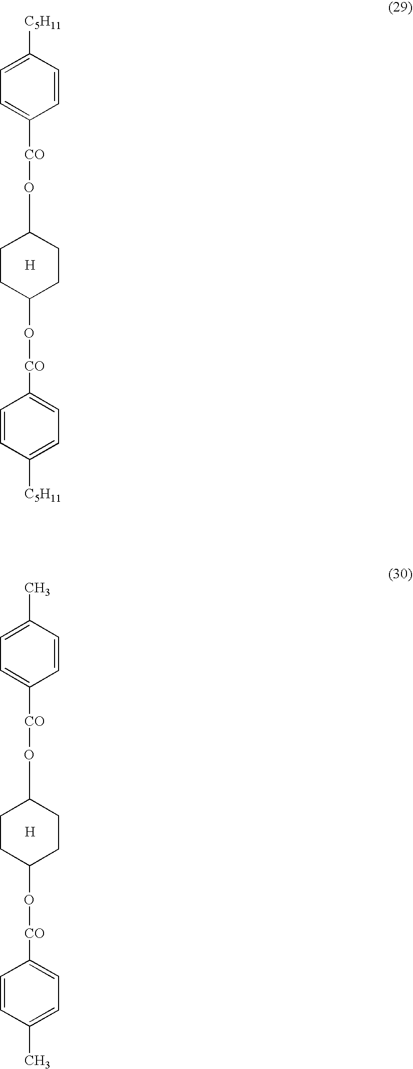

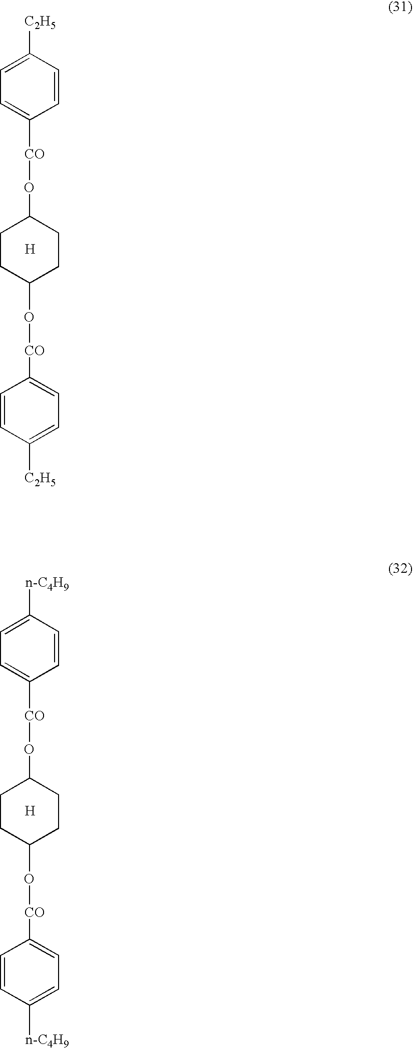

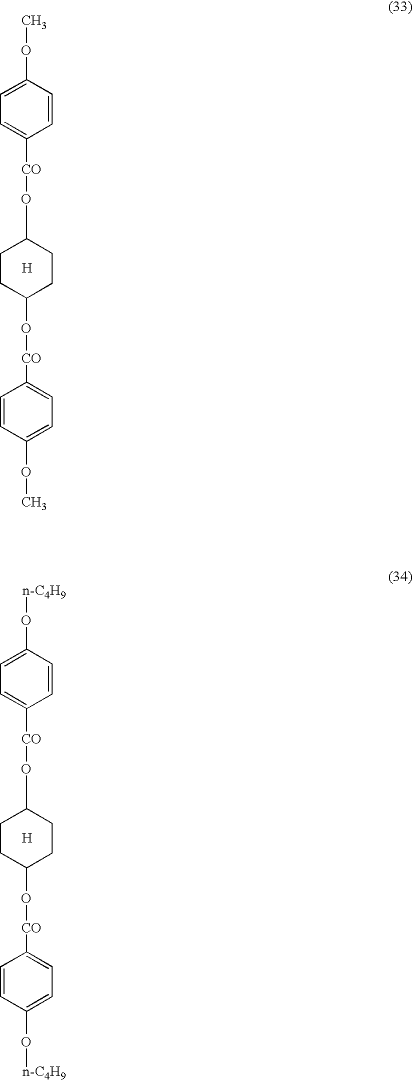

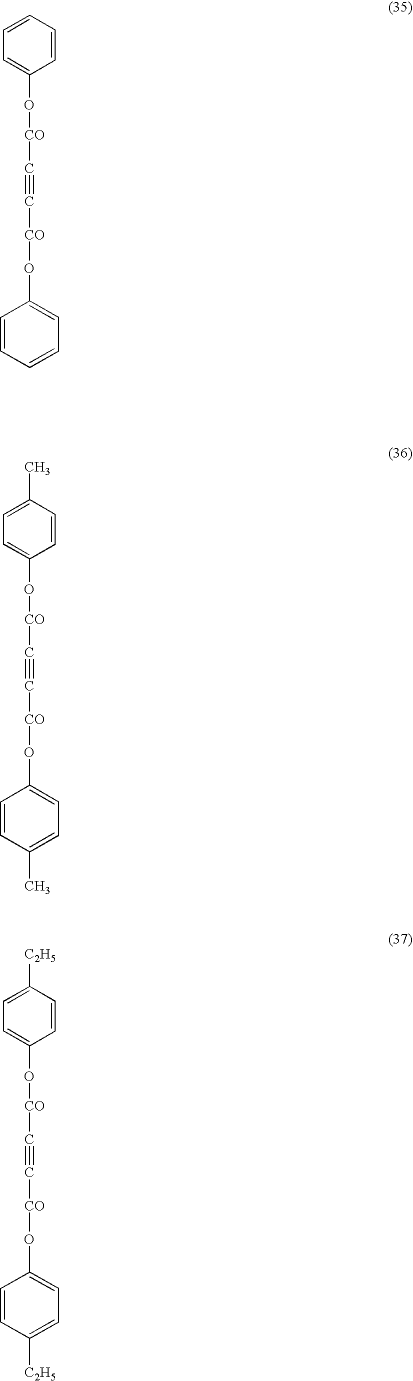

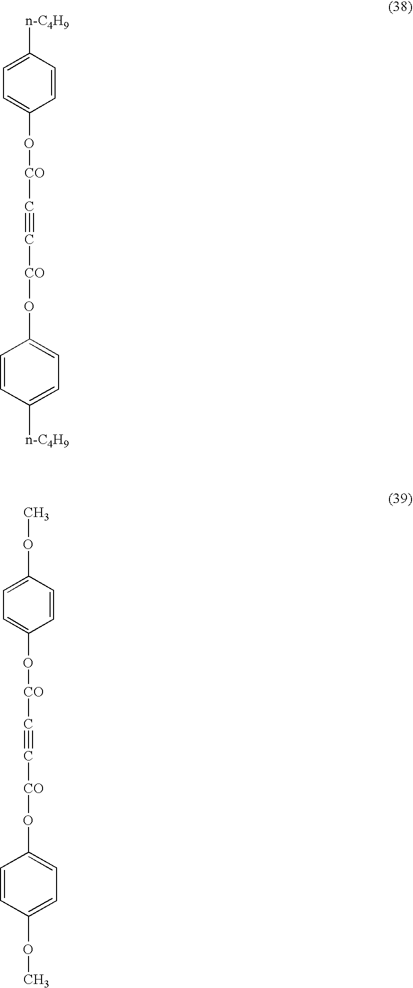

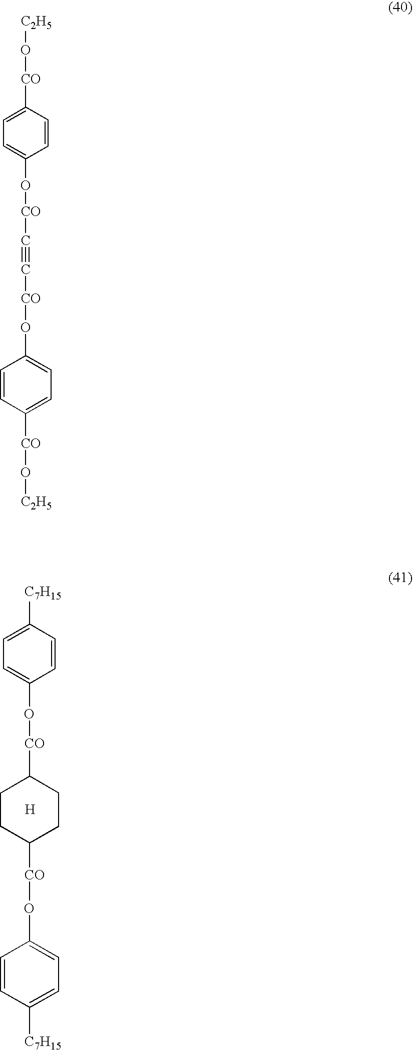

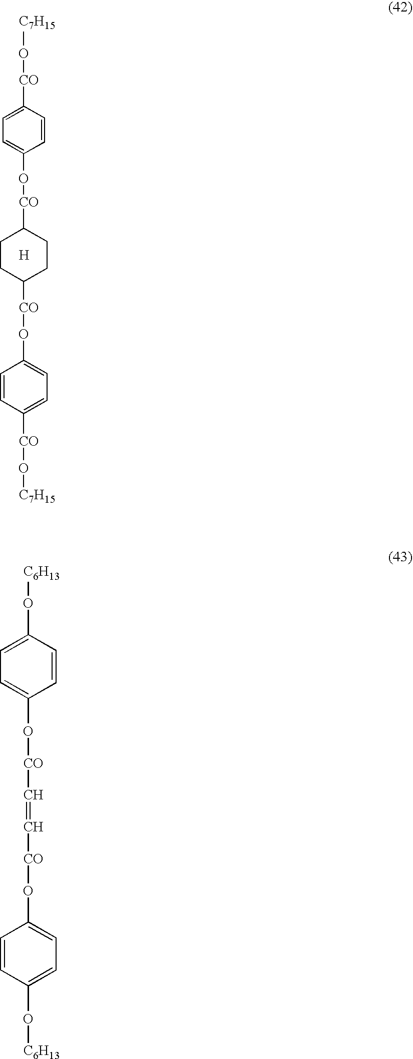

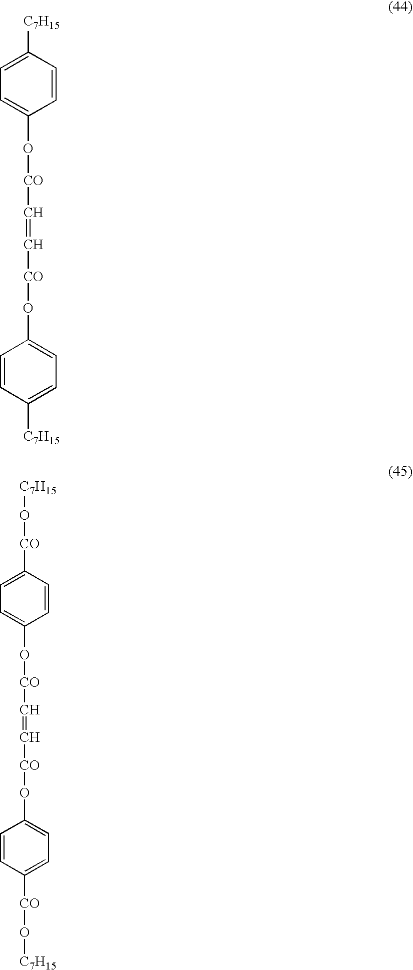

Examples (1) to (34), (41) and (42) have two asymmetric carbon atoms in 1- and 4-positions of a cyclohexane ring. However, since examples (1), (4) to (34), (41) and (42) have a symmetric meso-type molecular structure, there are not optical isomers (optical activity) but geometric isomers (trans and cis) alone are present. A trans (1-trans) type and a cis (1-cis) type of the example 1 are shown in the following.

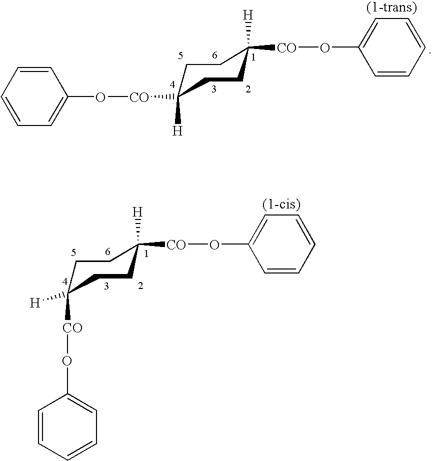

As described above, the rod-shaped compound preferably has a straight molecular structure, and, for this reason, a trans type is preferable to a cis type.

Each of the examples (2) and (3) has optical isomers and geometric isomers (4 isomers in total). Among the geometric isomers, a trans type is preferable to a cis type as described above. No preference exists on the optical isomers, and a D-type, an L-type or a racemi type may be employed.

Examples (43) to (45) have a trans type and a cis type on a central vinylene bond. A trans type is preferred to a cis type, because of the reason described above.

Also a compound represented by the following formula (3) is preferable.

Formula (3)

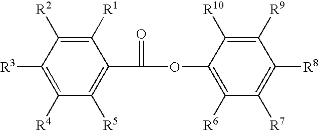

In the formula, R¹, R², R³, R⁴, R⁵, R⁶, R⁷, R⁹ and R¹⁰ each independently represents a hydrogen atom or a substituent, and at least one of R¹, R², R³, R⁴ and R⁵ represents an electron donating group; R⁸ represents a hydrogen atom, an alkyl group with 1 to 4 carbon atom, an alkenyl group with 2 to 6 carbon atoms, an alkinyl group with 2 to 6 carbon atoms, an aryl group with 6 to 12 carbon atoms, an alkoxy group with 1 to 12 carbon atoms, an aryloxy group with 6 to 12 carbon atoms, an alkoxycarbonyl group with 2 to 12 carbon atoms, an acylamino group with 2 to 12 carbon atoms, a cyano group or a halogen atom.

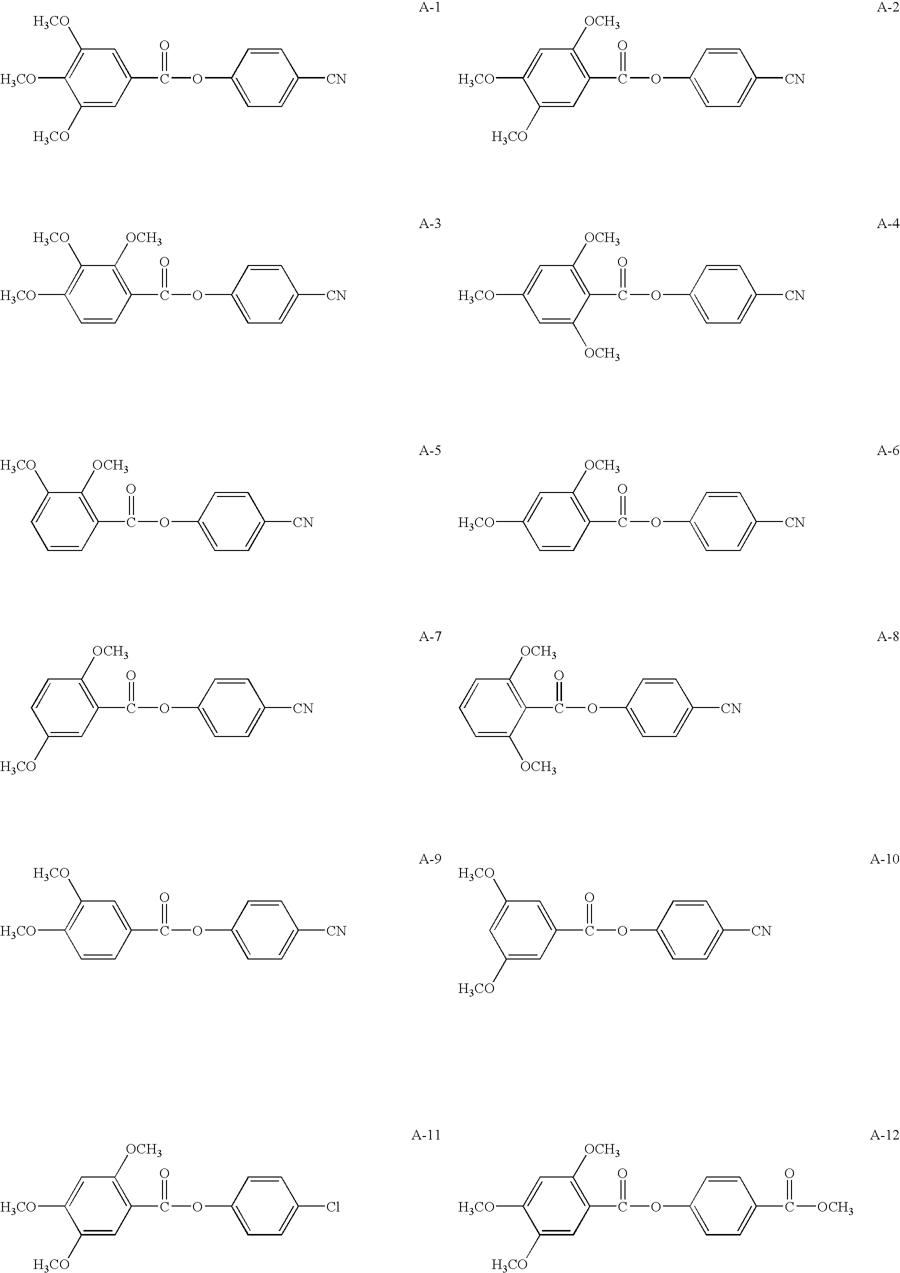

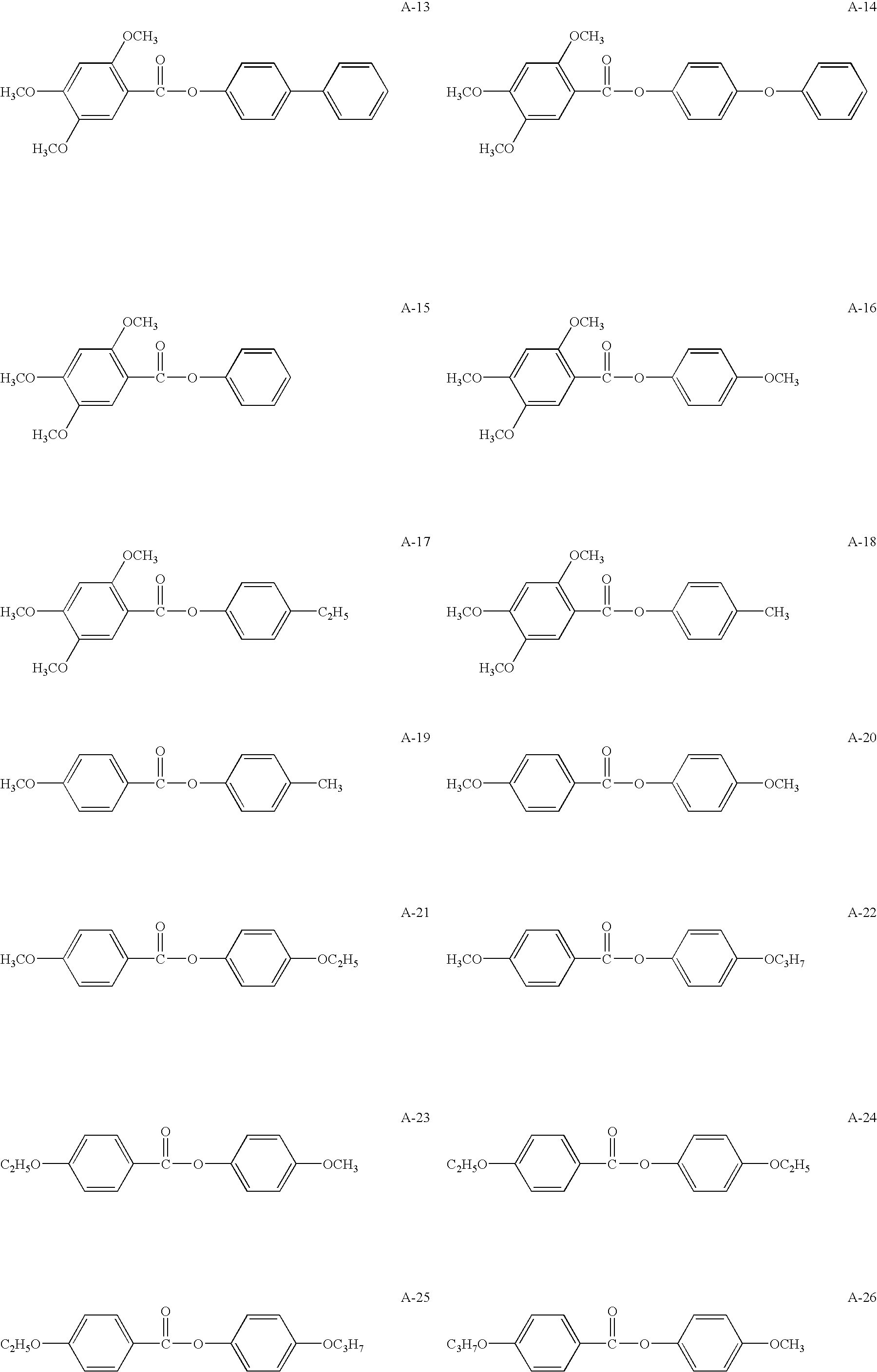

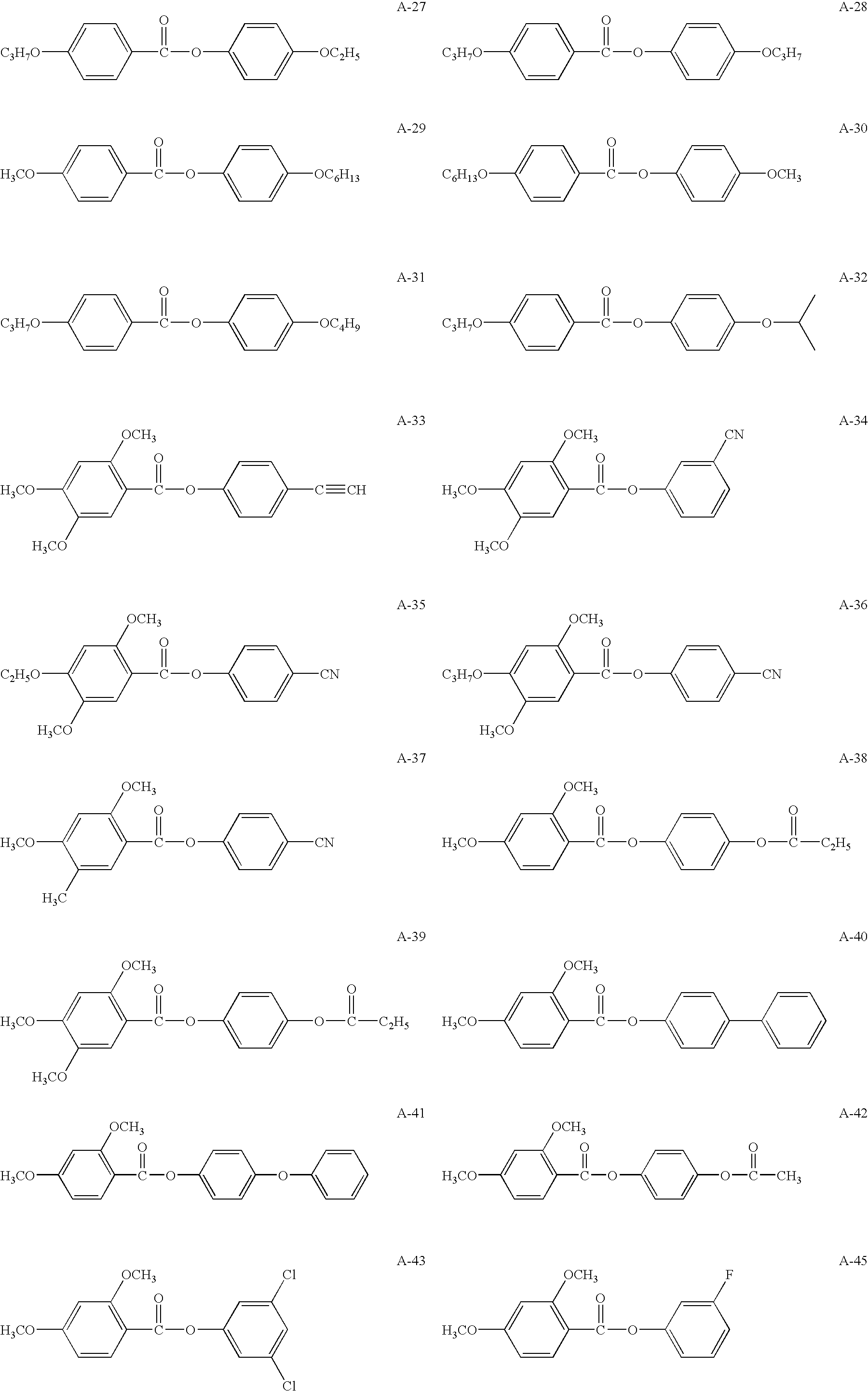

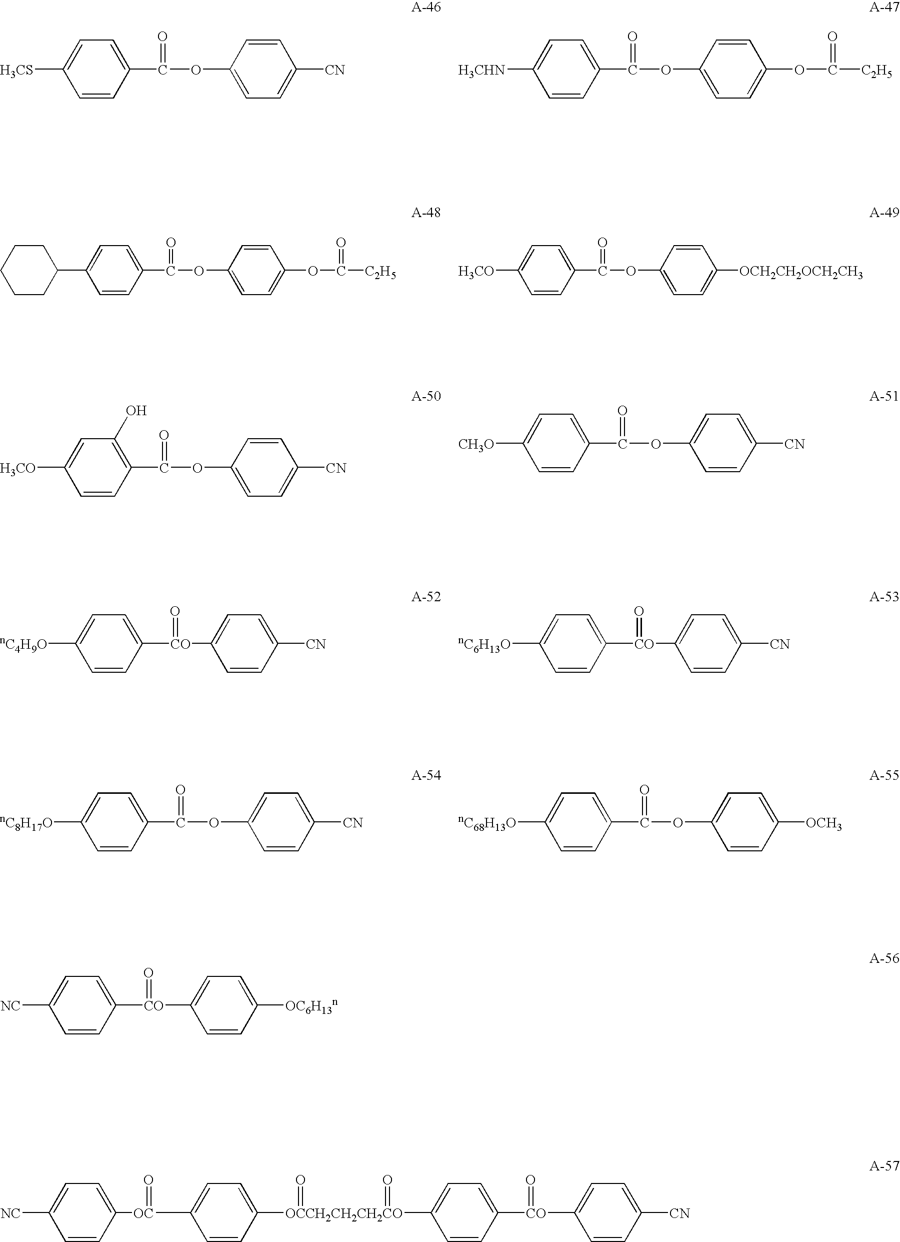

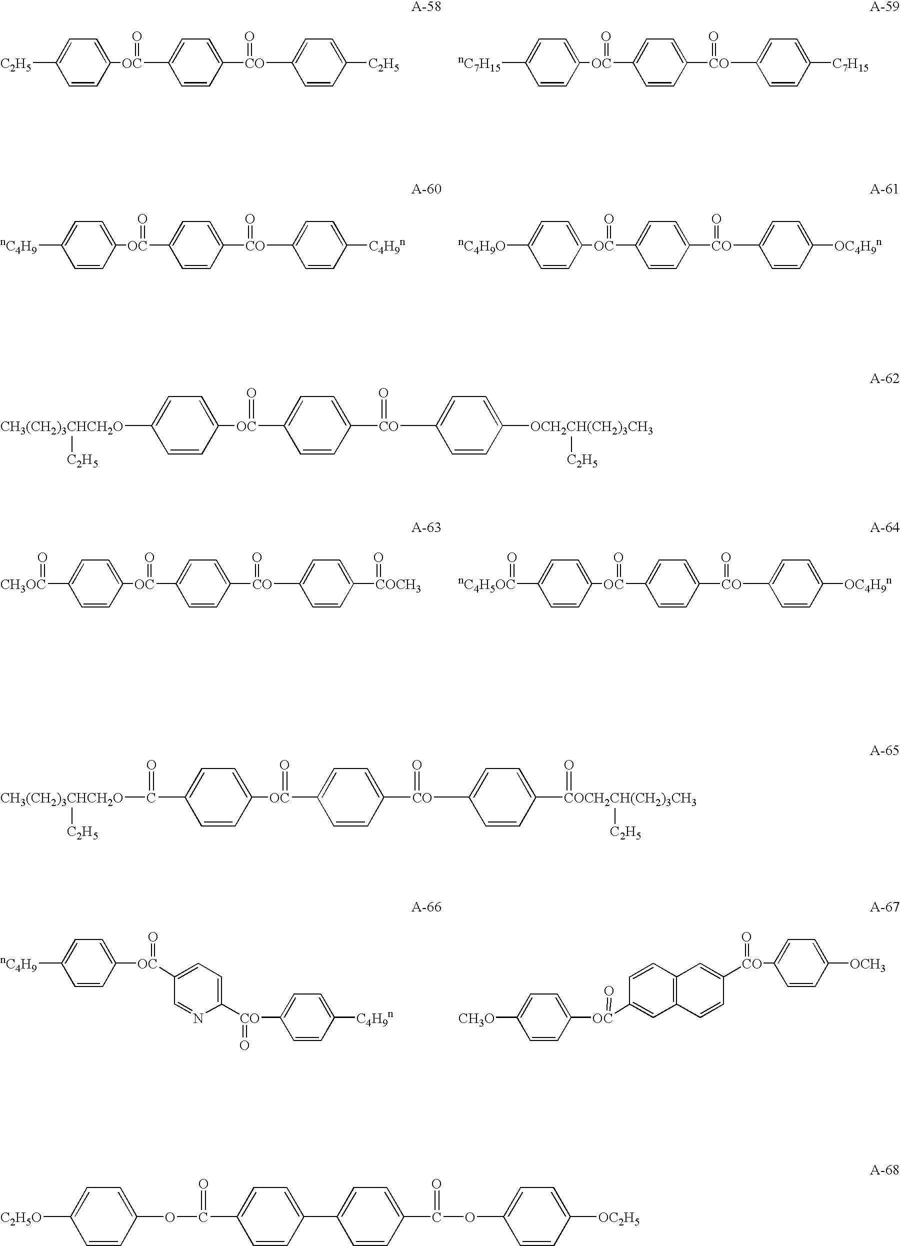

It is also possible to use, in combination, two or more rod-shaped compound having a maximum absorption wavelength (λₘₐₓ) shorter than 250 nm, in an ultraviolet absorption spectrum of a solution.

The rod-shaped compound can be synthesized by methods described in literatures, which include Mol. Cryst. Liq. Cryst., vol. 53, p. 229(1979), ibid., vol. 89, p. 93 (1982), ibid., vol. 145, p. 111(1987), ibid., vol. 170, p. 43(1989), J. Am. Chem. Soc., vol. 113, p. 1349 (1991), ibid., vol. 118, p. 5346(1996), ibid., vol. 92, p. 1582(1970), J. Org. Chem., vol. 40, p. 420 (1975) and Tetrahedron, vol. 48, No. 16, p. 3437 (1992).

(Matting Agent Particles)

In the cellulose acylate film of the invention, fine particles are preferably added as a matting agent. The fine particles employable in the invention can be those of silicon dioxide, titanium dioxide, aluminum oxide, zirconium oxide, calcium carbonate, talc, clay, calcined caolin, calcined calcium silicate, hydrated calcium silicate, aluminum silicate, magnesium silicate or calcium phosphate. The fine particles preferably include silicon for reducing turbidity, and particularly preferably are silicon dioxide. The fine particles of silicon dioxide preferably have a primary particle size of 20 nm or less and an apparent specific gravity of 70 g/liter or higher. An average particle size of the primary particles as small as 5 to 16 nm is more preferable in reducing a haze of the film. An apparent specific gravity is preferably 90-200 g/liter or larger, and more preferably 100-200 g/liter or larger. A larger apparent specific gravity allows to prepare a dispersion of a higher concentration, thereby reducing a haze and agglomerates.

In case of employing fine particles of silicon dioxide, an amount of use is preferably 0.01-0.3 parts by weight with respect to 100 parts by weight of the polymer component including cellulose acylate.

Such fine particles usually form secondary particles of an average particle size of 0.1-3.0 μm, and are present as agglomerates of the primary particles in the film, thereby forming irregularities of 0.1 to 3.0 μm on the film surface. An average secondary particle size is preferably 0.2 to 1.5 μm, more preferably 0.4 to 1.2 μm and most preferably 0.6 to 1.1 μm. An average secondary particle size within such range develops a sufficient anticreaking effect and realizes a low haze.

A primary or secondary particle size is defined by a diameter of a circumscribed circle of a particle in the film, observed under a scanning electron microscope. Also an average particle size is obtained by an average of 200 particles observed in different locations.

Fine particles of silicon dioxide are available as commercial products such as Aerosil R972, R972V, R974, R812, 200, 200V, 300, R202, OX50, or TT600 (foregoing manufactured by Nippon Aerosil Co.). Also fine particles of zirconium oxide are commercially available for example under trade names of Aerosil R976 and R811 (manufactured by Nippon Aerosil Co.).

Among these, Aerosil 200V or Aerosil R972V is particularly preferable as it is fine particles of silicon dioxide having an average primary particle size of 20 nm or less and an apparent specific gravity of 70 g/liter or higher, and showing a large effect for reducing a friction coefficient while maintaining a low turbidity in the optical film.

In the invention, for obtaining a cellulose acylate film including particles of a small average secondary particle size, there can be adopted certain methods in preparing a dispersion of the fine particles. For example, there can be adopted a method of preparing in advance a particle dispersion by mixing a solvent and fine particles under agitation, dissolving such particle dispersion under agitation in a small amount of a separately prepared cellulose acylate solution, and then mixing it with a main cellulose acylate dope. This method is preferred as it shows a satisfactory dispersibility of the silicon dioxide particles and in that the fine particles of silicon dioxide are not easily re-agglomerated. Also there can be utilized a method adding a small amount of a cellulose ester to a solvent for dissolution under agitation, then adding and mixing fine particles therein with a disperser to obtain a particle addition liquid, and sufficiently mixing such particle addition liquid with a dope in an in-line mixer. The present invention is not limited to such methods, but a concentration of silicon dioxide at the dispersion of the fine particles thereof with a solvent is preferably 5-30 weight %, more preferably 10-25 weight % and most preferably 15-20 weight %. A higher dispersion concentration is preferable as it reduces a turbidity of the liquid with respect to the amount of addition, thereby reducing a haze and an agglomeration. An amount of the matting agent in a final cellulose acylate dope is preferably 0.01-1.0 g/m², more preferably 0.03-0.3 g/m² and most preferably 0.08-0.16 g/m².

A solvent to be employed can preferably be, in case of a lower alcohol, methyl alcohol, ethyl alcohol, propyl alcohol, isopropyl alcohol or butyl alcohol. A solvent other than a lower alcohol is not particularly restricted, but is preferably a solvent employed at the film formation of the cellulose ester.

In the following, there will be explained an organic solvent in which the cellulose acylate of the invention is dissolved.

In the invention, the organic solvent can be a chlorinated solvent principally constituted of a chlorinated organic solvent, or a non-chlorine solvent not containing a chlorinated organic solvent.

(Chlorinated Solvent)

In the preparation of a cellulose acylate solution of the invention, a chlorinated organic solvent is preferably employed as a principal solvent. In the invention, a type of the chlorinated organic solvent is not particularly restricted as long as cellulose acylate can be dissolved and cast into a film. Such chlorinated organic solvent is preferably dichloromethane or chloroform, particularly preferably dichloromethane. Also an organic solvent other than the chlorinated organic solvent may be mixed. In such case, dichloromethane has to be employed by at least 50 weight % in the total organic solvents. Other organic solvent to be employed in combination with the chlorinated organic solvent in the invention are as follows. As another organic solvent, there is preferred a solvent selected from an ester, a ketone, an ether, an alcohol, a hydrocarbon and the like with 3 to 12 carbon atoms. The ester, ketone, ether, or alcohol may have a cyclic structure. A compound having two or more of functional groups (—O—, —CO— and —COO—) of ester, ketone and ether can also be employed as a solvent, and another functional group such as an alcoholic hydroxyl group may be present at the same time. In case of a solvent having two or more functional groups, a number of carbon atoms thereof can be within a range defined for a compound having any of such functional groups. Examples of an ester having 3 to 12 carbon atoms include ethyl formate, propyl formate, pentyl formate, methyl acetate, ethyl acetate or pentyl acetate. Examples of a ketone having 3 to 12 carbon atoms include acetone, methyl ethyl ketone, diethyl ketone, diisobutyl ketone, cyclopentanone, cyclohexanone and methylcyclohexanone. Examples of an ether having 3 to 12 carbon atoms include diisopropyl ether, dimethoxymethane, dimethoxyethane, 1,4-dioxane, 1,3-dioxolane, tetrahydrofuran, anisole and phenethol. Also examples of an organic solvent having functional groups of two or more types include 2-ethoxyethyl acetate, 2-methoxyethanol and 2-butoxyethanol.

Also an alcohol to be employed in combination with the chlorinated organic solvent may be linear, branched or cyclic, among which preferred is a saturated aliphatic hydrocarbon. The hydroxyl group of the alcohol can be primary, secondary or tertiary. Examples of alcohol include methanol, ethanol, 1-propanol, 2-propanol, 1-butanol, 2-butanol, t-butanol, 1-pentanol, 2-methyl-2-butanol and cyclohexanol. A fluorinated alcohol may also be employed as an alcohol, such as 2-fluoroethanol, 2,2,2-trifluoroethanol or 2,2,3,3-tetrafluoro-1-propanol. Also the hydrocarbon can be linear, branched or cyclic, and an aromatic hydrocarbon or an aliphatic hydrocarbon may be employed. An aliphatic hydrocarbon can be saturated or unsaturated. Examples of hydrocarbon include cyclohexane, hexane, benzene, toluene and xylene.

In the following, examples of a combination of a chlorinated organic solvent and another organic solvent are shown, but the invention is not limited to such examples.

dichloromethane/methanol/ethanol/butanol (80/10/5/5 in parts by weight);

dichloromethane/acetone/methanol/propanol (80/10/5/5 in parts by weight);

dichloromethane/methanol/butanol/cyclohexane (80/10/5/5 in parts by weight);

dichloromethane/methyl ethyl ketone/methanol/propanol (80/10/5/5 in parts by weight);

dichloromethane/acetone/methyl ethyl ketone/ethanol/isopropanol (75/8/10/5/7 in parts by weight);

dichloromethane/cyclopentanone/methanol/isopropanol (80/7/5/8 in parts by weight);

dichloromethane/methyl acetate/butanol (80/10/10 in parts by weight);

dichloromethane/cyclohexanone/methanol/hexane (70/20/5/5 in parts by weight);

dichloromethane/methyl ethyl ketone/acetone/methanol/ethanol (50/20/20/5/5 in parts by weight);

dichloromethane/1,3-dioxolane/methanol/ethanol (70/20/5/5 in parts by weight);

dichloromethane/dioxane/acetone/methanol/ethanol (60/20/10/5/5 in parts by weight);

dichloromethane/acetone/cyclopentanone/ethanol/isobutanol/cyclohexane (65/10/10/5/5/5 in parts by weight);

dichloromethane/methyl ethyl ketone/acetone/methanol/ethanol (70/10/10/5/5 in parts by weight);

dichloromethane/acetone/ethyl acetate/ethanol/butanol/hexane (65/10/10/5/5/5 in parts by weight);

dichloromethane/methyl acetacetate/methanol/ethanol (65/20/10/5 in parts by weight); and

dichloromethane/cyclopentanone/ethanol/butanol (65/20/10/5 in parts by weight).

(Non-Chlorinated Solvent)

In the following there will be explained a non-chlorinated organic solvent advantageously employed in the preparation of the cellulose acylate solution of the invention. In the invention, a type of the non-chlorinated organic solvent is not particularly restricted as long as cellulose acylate can be dissolved and cast into a film. The non-chlorinated organic solvent employed in the invention is preferably selected from an ester, a ketone, or an ether with 3 to 12 carbon atoms. The ester, ketone or ether may have a cyclic structure. A compound having two or more of functional groups (—O—, —CO— and —COO—) of ester, ketone and ether can also be employed as a principal solvent, and another functional group such as an alcoholic hydroxyl group may be present at the same time. In case of a principal solvent having two or more functional groups, a number of carbon atoms thereof can be within a range defined for a compound having any of such functional groups. Examples of an ester having 3 to 12 carbon atoms include ethyl formate, propyl formate, pentyl formate, methyl acetate, ethyl acetate or pentyl acetate. Examples of a ketone having 3 to 12 carbon atoms include acetone, methyl ethyl ketone, diethyl ketone, diisobutyl ketone, cyclopentanone, cyclohexanone and methylcyclohexanone. Examples of an ether having 3 to 12 carbon atoms include diisopropyl ether, dimethoxymethane, dimethoxyethane, 1,4-dioxane, 1,3-dioxolane, tetrahydrofuran, anisole and phenethol. Also examples of a solvent having functional groups of two or more types include 2-ethoxyethyl acetate, 2-methoxyethanol and 2-butoxyethanol.

The non-chlorinated organic solvent employed for the cellulose acylate is selected based on various points mentioned above, but is preferably selected as follows. The non-chlorinated solvent is preferably a mixed solvent containing an aforementioned non-chlorimated organic solvent as a principal solvent and formed by mixing mutually different three or more solvent, in which a first solvent is at least one selected from methyl acetate, ethyl acetate, methyl formate, ethyl formate, acetone, dioxolane, and dioxane, or a mixture thereof, a second solvent is selected from a ketone or an acetacetate ester with 4 to 7 carbon atoms, and a third solvent is selected from an alcohol or a hydrocarbon with 1 to 10 carbon atoms, preferably from an alcohol with 1 to 8 carbon atoms. The second solvent may be dispensed with in case the first solvent is a mixture of two or more solvents. More preferably the first solvent is methyl acetate, acetone, methyl formate, ethyl formate or a mixture thereof, and the second solvent is preferably methyl ethyl ketone, cyclopentanone, cyclohexanone or methyl acetylacetate or a mixture thereof.

Also an alcohol constituting the third solvent may be linear, branched or cyclic, among which preferred is a saturated aliphatic hydrocarbon. The hydroxyl group of the alcohol can be primary, secondary or tertiary. Examples of alcohol include methanol, ethanol, 1-propanol, 2-propanol, 1-butanol, 2-butanol, t-butanol, 1-pentanol, 2-methyl-2-butanol and cyclohexanol. A fluorinated alcohol may also be employed as an alcohol, such as 2-fluoroethanol, 2,2,2-trifluoroethanol or 2,2,3,3-tetrafluoro-1-propanol. Also the hydrocarbon can be linear, branched or cyclic, and an aromatic hydrocarbon or an aliphatic hydrocarbon may be employed. An aliphatic hydrocarbon can be saturated or unsaturated. Examples of hydrocarbon include cyclohexane, hexane, benzene, toluene and xylene. The alcohol or hydrocarbon used as the third solvent may be employed singly or in a mixture of two or more kinds. Preferred specific examples of the third solvent as an alcohol include methanol, ethanol, 1-propanol, 2-propanol, 1-butanol, 2-butanol, cyclohexanol, cyclohexane and hexane, particularly methanol, ethanol, 1-propanol, 2-propanol and 1-butanol.

A mixing ratio of the three mixed solvents is preferably such that, in the entire mixed solvent, the first solvent is contained by 20-95 weight %, the second solvent by 2-60 weight % and the third solvent by 2-30 weight %, more preferably that the first solvent is contained by 30-90 weight %, the second solvent by 3-50 weight % and the alcohol as the third solvent by 3-25 weight %, and particularly preferably that the first solvent is contained by 30-90 weight %, the second solvent by 3-30 weight % and the alcohol as the third solvent by 3-15 weight %. The non-chlorinated organic solvents employable in the invention are described in more details in the Japan Institute of Invention and Innovation, Laid-open Technical Report (2001-1745, issued Mar. 15, 2001, JIII), pages 12-16. In the following, preferred examples of a combination of non-chlorinated organic solvents are shown, but the invention is not limited to such examples.

methyl acetate/acetone/methanol/ethanol/butanol (75/10/5/5/5 in parts by weight);

methyl acetate/acetone/methanol/ethanol/propanol (75/10/5/5/5 in parts by weight);

methyl acetate/acetone/methanol/butanol/cyclohexane (75/1015/5/5 in parts by weight);

methyl acetate/acetone/ethanol/butanol (81/8/7/4 in parts by weight);

methyl acetate/acetone/ethanol/butanol (82/10/4/4 in parts by weight);

methyl acetate/acetone/ethanol/butanol (80/10/4/6 in parts by weight);

methyl acetate/methyl ethyl ketone/methanol/butanol (80/10/5/5 in parts by weight);

methyl acetate/acetone/methyl ethyl ketone/ethanol/isopropanol (75/8/5/5/7 in parts by weight);

methyl acetate/cyclopentanone/methanol/isopropanol (80/7/5/8 in parts by weight);

methyl acetate/acetone/butanol (85/10/5 in parts by weight);

methyl acetate/cyclopentanone/acetone/methanol/butanol (60/15/14/5/6 in parts by weight);

methyl acetate/cyclohexanone/methanol/hexane (70/20/5/5 in parts by weight);

methyl acetate/methyl ethyl ketone/acetone/methanol/ethanol (50/20/20/5/5 in parts by weight);

methyl acetate/1,3-dioxolane/methanol/ethanol (70/20/5/5 in parts by weight);

methyl acetate/dioxane/acetone/methanol/ethanol (60/20/10/5/5 in parts by weight);

methyl acetate/acetone/cyclopentanone/ethanol/isobutanol/cyclohexane (65/10/10/5/5/5 in parts by weight);

methyl formate/methyl ethyl ketone/acetone/methanol/ethanol (50/20/20/5/5 in parts by weight);

methyl formate/acetone/ethyl acetate/ethanol/butanol/hexane (65/10/10/5/5/5 in parts by weight);

acetone/methyl acetacetate/methanol/ethanol (65/20/10/5 in parts by weight);

acetone/cyclopentanone/ethanol/butanol (65/20/10/5 in parts by weight);

acetone/1,3-dioxolane/ethanol/butanol (65/20/10/5 in parts by weight); and

1,3-dioxolane/cyclohexanone/methyl ethyl ketone/methanol/butanol (55/20/10/5/515 in parts by weight).

It is also possible to employ a cellulose acylate solution prepared in following methods:

a method of preparing a cellulose acylate solution with methyl acetate/acetone/ethanol/butanol (81/8/7/4 in parts by weight), and, after a filtration and a concentration, further adding 2 parts by weight of butanol;

a method of preparing a cellulose acylate solution with methyl acetate/acetone/ethanol/butanol (84/10/4/2 in parts by weight), and, after a filtration and a concentration, further adding 4 parts by weight of butanol; or

a method of preparing a cellulose acylate solution with methyl acetate/acetone/ethanol (84/10/6 in parts by weight), and, after a filtration and a concentration, further adding 5 parts by weight of butanol.

In the dope to be employed in the invention, in addition to the non-chlorinated organic solvent of the invention mentioned above, dichloromethane may be contained by 10 weight % or less of the entire organic solvent of the invention.

(Properties of Cellulose Acylate Solution)

The cellulose acylate solution, in consideration of adaptability to a film formation by casting, is preferably a solution formed by dissolving cellulose acylate in a concentration of 10-30 weight % in the aforementioned organic solvent, more preferably 13-27 weight % and particularly preferably 15-25 weight %. Such concentration of cellulose acylate can be obtained by preparing the solution at a predetermined concentration at the stage of dissolving, or by preparing a solution of a low concentration (for example 9-14 weight %) in advance and then obtaining a solution of a predetermined high concentration by a concentrating step to be explained later. Otherwise it is also possible to prepare a cellulose acylate solution of a high concentration and then to obtain a cellulose acylate solution of a predetermined low concentration by adding various additives, and any of these methods may be adopted as long as a concentration of the cellulose acylate solution defined in the invention can be obtained.

In the invention, in a dilute solution of a concentration of 0.1 to 5 weight % prepared in an organic solvent of a same composition as in the cellulose acylate solution, the cellulose acylate preferably has an association molecular weight of 150,000 to 15,000,000, more preferably 180,000 to 9,000,000. Such association molecular weight can be determined by a static light scattering method. In such case, the dissolution is preferably executed in such a manner that an inertial squared radius, determined at the same time, becomes 10-200 nm, more preferably 20-200 nm. Also the dissolution is preferably executed in such a manner that a second virial coefficient becomes −2×10⁻⁴ to +4×10⁻⁴, more preferably −2×10⁻⁴ to +2×10⁻⁴.

In the following, there will be explained definitions of the association molecular weight, the inertial squared radius and the second virial coefficient. These parameters are measured by a static light scattering method according to a following method. The measurement is executed in a dilute range because of the property of an apparatus, but these measured values reflect a behavior of the dope of the invention in a high concentration range.

At first, cellulose acylate is dissolved in a solvent to be employed in the dope, thereby preparing solutions of 0.1, 0.2, 0.3 and 0.4 weight %. In order to prevent a moisture absorption, a weighing is executed at 25° C., 10% RH, utilizing cellulose acylate dried for 2 hours at 120° C. A dissolving is executed by a method employed for preparing the dope (normal temperature dissolving, cooled dissolving or high temperature dissolving). Then these solutions and the solvent are filtered through a 0.2 μm Teflon filter. The filtered solution is subjected to a measurement of a static light scattering, by a light scattering measuring apparatus (DLS-700, manufactured by Otsuka Denshi Co.), at an interval of 10° from 30° to 140° and at 25° C., and obtained data are analyzed by a Berry plotting method. A refractive index necessary for this analysis utilizes a value of the solvent obtained by an Abbe's refractive system, and a concentration-dependent change of the refractive index (dn/dc) is measured by a differential refractive index meter (DRM-1021 manufacture by Otsuka Denshi Co.), utilizing the solvent and the solutions employed in the measurement of light scattering.

(Preparation of Dope)

In the following, there will be explained preparation of a cellulose acylate solution (dope). In the invention, a dissolving method of cellulose acylate is not particularly restricted and can be a room-temperature dissolving method, a cooled dissolving method, a high-temperature dissolving method or a combination thereof. A method for preparing a cellulose acylate solution is described for example in JP-A Nos. 5-163301, 61-106628, 58-127737, 9-95544, 10-95854, 10-45950, 2000-53784, 11-322946, 11-322947, 2-276830, 2000-273239, 11-71463, 04-259511, 2000-273184, 11-323017 and 11-302388.

These dissolving methods for cellulose acylate in an organic solvent are also suitably applicable in the invention, as long as within the scope of the invention. Details of such methods, particularly on non-chlorinated solvent systems, are described in detail in the Japan Institute of Invention and Innovation, Laid-open Technical Report (2001-1745, issued Mar. 15, 2001, JIII), pages 22-25. Also the dope solution of cellulose acylate of the invention is usually subjected to a concentration and a filtration of the solution, as detailedly described in the Japan Institute of Invention and Innovation, Laid-open Technical Report (2001-1745, issued Mar. 15, 2001, JIII), page 25. In case of dissolution at a high temperature, the organic solvent is mostly employed at a boiling temperature thereof or higher, and is employed in a pressurized state in such case.

For the ease of casting, the cellulose acylate solution preferably has a solution viscosity and a dynamic storage modulus within following ranges. 1 mL of a sample solution is measured utilizing a Rheometer (CLS 500) and a steel cone of a diameter of 4 cm/2° (both manufactured by TA Instruments Inc.). A measurement is executed under an oscillation step/temperature ramp at a rate of 2° C./minute within a range of 40° to −10° C., thereby obtaining a static non-Newton viscosity n*(Pa·s) at 40° C. and a storage modulus G′(Pa) at −5° C. The measurement is initiated after the sample solution is maintained in advance at a measurement starting temperature until a constant liquid temperature is reached. In the invention, the solution preferably has a viscosity at 40° C. of 1-400 Pa·s and a dynamic storage modulus at 15° C. of 500 Pa or higher, and more preferably a viscosity at 40° C. of 10-200 Pa·s and a dynamic storage modulus at 15° C. of 100-1,000,000 Pa. Also the dynamic storage modulus at a low temperature is preferably larger, and, in case a casting support member is −5° C., the dynamic storage modulus at −5° C. is preferably 10,000-1,000,000 Pa and, in case of −50° C., the dynamic storage modulus at −50° C. is preferably 10,000-5,000,000 Pa.

The invention, employing the aforementioned specified cellulose acylate, allows to obtain a dope of a high concentration, thereby obtaining a cellulose acylate solution of a high concentration and a high stability even without relying on a concentration. Also for facilitating dissolving, it is possible to execute dissolution at a low concentration and then to execute a concentrating operation. The concentrating method is not particularly restricted, and can be executed, for example, by a method of guiding a low-concentration solution into a gap between a cylinder and a rotation trajectory of an external periphery of rotary blades rotating circumferentially therein, and forming a temperature difference from the solution to evaporate the solvent thereby obtaining a high-concentration solution (for example JP-A No. 4-259511), or a method of blowing a heated low-concentration solution from a nozzle into a container to cause a flush evaporation of solvent until the solution hits an internal wall of the container, extracting a solvent vapor from the container and extracting a high-concentration solution from the bottom of the container (for example U.S. Pat. Nos. 2,541,012, 2,858,229, 4,414,341 and 4,504,355).

Prior to a casting, the solution is preferably subjected to a removal of extraneous substances such as undissolved substances, dusts and impurities by filtration with a suitable filtering material such as a metal mesh or a filtering cloth. For filtering the cellulose acylate solution, there is preferably employed a filter of an absolute filtering precision of 0.1 to 100 μm, more preferably 0.5 to 25 μm. The filter preferably has a thickness of 0.1 to 10 mm, more preferably 0.2 to 2 mm. In such case, the filtration is preferably executed with a filtering pressure of 1.6 MPa or less, more preferably 1.2 MPa or less, further preferably 1.0 MPa or less, and particularly preferably 0.2 MPa or less. As the filtering material, there can be advantageously employed already known materials, for example glass fibers, cellulose fibers, a filter paper or a fluorinated resin such as tetrafluoroethylene. In particularly, a ceramic material or a metal is preferably employed. A viscosity of the cellulose acylate solution immediately before the film forming operation may be within a castable range at the film forming operation, and is preferably regulated within a range of 10-2,000 Pa·s, more preferably 30-1,000 Pa·s and further preferably 40-500 Pa·s. A temperature is not particularly restricted as long as it is same as that at the casting operation, but is preferably −5 to +70° C. and more preferably −5 to +55° C.

(Film Formation)

A cellulose acylate film of the invention can be obtained by forming a film from the aforementioned cellulose acylate solution. For producing a cellulose acylate film, there can be employed a known solution cast film forming method and a solution cast film forming apparatus, which have been employed for producing a cellulose triacetate film. A dope (cellulose acylate solution) prepared in a dissolving equipment (pot) is once stored in a storing pot and is subjected to an elimination of bubbles contained in the dope and to a final adjustment. The dope is fed from a dope outlet, for example through a pressurized constant-rate gear pump capable of feeding a highly precise constant amount determined by a revolution, to a pressurized die, and is uniformly cast from lips (slit) of the pressurized die onto a running endless metal support member in a cast unit, and, in a peeling point on the metal support member after a substantially one turn thereof, a semi-dried dope film (also called a web) is peeled from the metal support member. The obtained web is conveyed in a tenter, with both ends being supported by clips to maintain a width, further conveyed by rolls in a drying apparatus, and, after a drying, is wound in a predetermined length by a winder. A combination of the tenter and the rolls of the drying apparatus is variable depending on the purpose. In a solution cast film forming method to be used for a functional protective film for an electronic display, a coating apparatus is often added to the solution cast film forming apparatus for a film surface processing such as an under coat layer, an antistatic layer, an antihalation layer or a protective layer. In the following each manufacturing step will be explained briefly but such explanation is not restrictive.

For forming a cellulose acylate film by a solvent cast method, at first a prepared cellulose acylate solution (dope) is cast on a drum or a band and a solvent is evaporated to form a film. The dope before casting is preferably subjected to a concentration adjustment so as to obtain a solid content of 5-40 weight %. The drum or the band preferably has a mirror-finished surface. The dope is preferably cast on a drum or a band of a surface temperature of 30° C. or lower, and a metal support member of a temperature of −10 to 20° C. is particularly preferable. In the invention, there can also be employed methods described in JP-A Nos. 2000-301555, 2000-301558, 07-032391, 03-193316, 05-086212, 62-037113, 02-276607, 55-014201, 02-111511 and 02-208650.

(Multi-Layer Casting)

The cellulose acylate solution may be cast as a single-layer liquid on a smooth band or drum as a metal support member, or plural cellulose acylate solutions may be cast in two or more layers. In case of casting plural cellulose acylate solutions, a film can be prepared by a method of casting solutions containing cellulose acylate respectively from plural casting apertures, spaced along an advancing direction of the metal support member, as described in JP-A Nos. 61-158414, 1-122419 and 11-198285. Also a film can be prepared by a method of casting cellulose acylate solutions from two casting apertures, as described in JP-B No. 60-27562, JP-A Nos. 61-94724, 61-947245, 61-104813, 61-158413 and 6-134933. There can also be adopted a method of casting a cellulose acylate film by enclosing a flow or a high-viscosity cellulose acylate solution in low-viscosity cellulose acylate solutions and simultaneously extruding such high- and low-viscosity cellulose acylate solutions, as described in JP-A No. 56-162617. It is also preferable, as described in JP-A Nos. 61-94724 and 61-74925, to include an alcohol component, which is a poor solvent, in a larger amount in outside solutions than in an inside solution. It is also possible, as described in JP-B No. 44-20235, to employ two casting apertures, to peel a film formed by a first casting aperture from a metal support member and to execute a second casting on a surface of the film, that has been in contact with the metal support member. The cellulose acylate solutions to be cast may be same solutions or different solutions, without any restriction. In order to provide the plural cellulose acylate layers with functions, a cellulose acylate solution matching such function may be extruded from each casting aperture. The cellulose acylate solution may also be cast simultaneously with another functional layer (for example an adhesive layer, a dye layer, an antistatic layer, an antihalation layer, a UV absorption layer or a polarizing layer).

In a prior single-layered liquid, it is necessary to extrude a cellulose acylate solution of a high concentration and a high viscosity, which is insufficient in stability to generate solid substances, leading to a particulate failure or an insufficient planarity. As a countermeasure against such situation, a casting of plural cellulose acylate solutions from casting apertures enables to extrude high-viscosity solutions simultaneously onto the metal support member thereby improving planarity and obtaining a film of a satisfactory surface property. Also the use of a dense cellulose acylate solution reduces a drying burden, thus increasing a production speed of the film. In case of a co-casting, an inside thickness and an outside thickness are not particularly restricted, but the outside thickness preferably represents 1-50% of a total film thickness, more preferably 2-30%. In case of a co-casting of three or more layers, a total film thickness of a layer in contact with the metal support member and a layer in contact with the air is defined as an outside thickness. In case of a co-casting, it is also possible to obtain a cellulose acylate film of a laminate structure by co-casting cellulose acylate solutions different in concentrations of the additives such as a plasticizer, an ultraviolet absorber, a matting agent and the like. For example, there can be obtained a cellulose acylate film having a configuration of skin layer/core layer/skin layer. For example, the matting agent may be added in a larger amount in the skin layer, or only in the skin layer. The plasticizer or the ultraviolet absorber can be added in a larger amount in the core layer than in the skin layer, or only in the core layer. Also a type of the plasticizer or the ultraviolet absorber may be made different between the core layer and the skin layer, and it is possible, for example, to include at least either of a plasticizer and an ultraviolet absorber of a low volatility in the skin layer, and to include a plasticizer excellent in plasticizing property or an ultraviolet absorber excellent in UV absorbing property, in the core layer. It is also preferable to include a peeling accelerator only a skin layer at the side of the metal support member. It is also preferable, in a cooled drum method, for gelling the solution by cooling the metal support member, to add an alcohol as a poor solvent in a larger amount in the skin layer than in the core layer. The skin layer and the core layer may be different in Tg, and Tg of the skin layer is preferably lower than Tg of the core layer. Also a viscosity of the cellulose acylate solution at the casting may be different between the skin layer and the core layer, and the skin layer preferably has a viscosity lower than that of the core layer, but the core layer may have a viscosity lower than that of the skin layer.

(Casting)

A solution casting may be executed by a method of uniformly extruding a prepared dope from a pressurized die onto a metal support member, a doctor blade method of regulating a thickness of the dope, once cast on a metal support member, with a blade, or a reverse roll coater method of regulating a thickness with a roller rotating in a reverse direction, but a method utilizing a pressurized die is preferable. The pressurized die is known in various types such as a coat hander type and a T-die type, each of which can be employed advantageously. Also in addition to the aforementioned methods, there can be utilized various known method for forming a cellulose triacetate film by casting, and effects as described in literatures can be obtained by suitably selecting conditions in consideration for example of a difference in the boiling point of the employed solvent. An endlessly running metal support member to be employed in the preparation of the cellulose acylate film of the invention can be a drum having a mirror-finish surface by a chromium plating or a stainless steel belt (band) mirror-finished by a surface polishing. A pressurized die to be employed in the preparation of the cellulose acylate film of the invention may be provided in one unit or in two or more units above the metal support member, and preferably in one or two units. In case of employing two or more units, the dope to be cast may be divided into such dies in various proportions, or dopes may be supplied to the dies in respective proportions by plural precision constant-rate gear pumps. The cellulose acylate solution to be employed in the casting preferably has a temperature of −10 to 55° C., more preferably 25 to 50° C. The temperature may be same throughout the process, or may be different in different positions of the process. In case the temperature is different, it should assume a desired value immediately before the casting.

(Drying)

In the preparation of the cellulose acylate film, the dope on the metal support member can be dried by a method of blowing a hot air from a top side of the metal support member (drum or belt), namely from a top side of a web thereon, a method of blowing a hot air from a rear side of the drum or the belt, or a liquid heat conduction method of contacting a temperature-controlled liquid with a rear side of the belt or drum, which is opposite to the dope casting side thereby heating the drum or belt by a thermal conduction thereby controlling a surface temperature, but the liquid heat conduction method from the rear side is preferable. The metal support member before casting may have any temperature lower than a boiling temperature of a solvent employed in the dope. However, in order to accelerate drying and to lose fluidity on the metal support member, the temperature is preferably selected at 1-10° C. lower than the boiling temperature of a solvent having a lowest boiling temperature among the solvent employed. However such condition is not applicable in case the cast dope is cooled and peeled off without drying.

(Stretching Process)

In the cellulose acylate film of the invention, a retardation can be regulated by a stretching process. There is also known a method of positively stretching in the transversal direction, as described in JP-A Nos. 62-115035, 4-152125, 4-284211, 4-298310, and 11-48271. In such method, a produced cellulose acylate film is stretched in order to obtain a high in-plane retardation.

A film stretching is executed at a normal temperature or under heating. A heating temperature is preferably within ±20° C. of a glass transition temperature of the film. A stretching at a temperature excessively lower than the glass transition temperature tends to cause a breakage and is incapable of realizing desired optical characteristics. On the other hand, a stretching at a temperature excessively higher than the glass transition temperature cannot fix a molecular orientation, realized by stretching, because of a relaxation by the heat at the stretching before thermal fixation of the molecular orientation by the stretching, thereby hindering realization of the desired optical characteristics.

The film stretching may be executed in a monoaxial stretching (fixed width or free width) in a longitudinal or transversal direction only, or in a simultaneous or successive biaxial stretching. The stretching is executed at a rate of 10% or more, preferably 10-200%, still more preferably 12-100% and particularly preferably 15-80%. For a birefringence of an optical film, a refractive index in the transversal direction is preferably larger than that in the longitudinal direction, and it is therefore preferable to stretch more in the transversal direction. Also the stretching process may be executed in the course of a film forming process, or executed on a web after film formation and winding. In the former, the stretching may be executed in a state containing a residual solvent, preferably in a state of a residual solvent amount (residual solvent/(residual solvent+solids)) of 2 to 50%.

A thickness of the cellulose acylate film of the invention, obtained after drying, is variable depending upon the purpose of use, and is usually within a range preferably of 5 to 500 μm, more preferably 20 to 300 μm, further preferably 30-180 μm, particularly preferably 40-180 μm and most preferably 40-150 μm. Also for an optical use, particularly for a liquid crystal display of VA type, there is preferred a thickness of 40-110 μm.

A film thickness of 110-180 μm increases a drying burden at the film formation by casting, but desired optical characteristics can be realized by a large film thickness as the magnitude of the optical characteristics is proportional to the film thickness. Also as a moisture permeability decreases in an inverse proportion to the film thickness, a larger film thickness reduces the moisture permeability, thereby becoming more impermeable to water. Such state is advantageous for example in a polarizing plate durability test for 500 hrs. under 60° C. and 90% RH.

A film thickness can be regulated by regulating a solid concentration in the dope, a slit gap of the aperture of the die, an extruding pressure from the die and a speed of the metal support member so as to obtain a desired thickness. A cellulose acylate film thus obtained preferably has a width of 0.5 to 3 m, more preferably 0.6 to 2.5 m and further preferably 0.8 to 2.2 m. The film is preferably wound with a length of 100-10,000 m per roll, more preferably 500-7,000 m, and further preferably 1,000-6,000 m. At the winding, a knurling is preferably provided at least on one edge, preferably with a width of 3-50 mm, more preferably 5-30 mm and a height of 0.5-500 μm, more preferably 1-200 μm. Such knurling may be formed by a pressing from one side or from both sides.

(Optical Characteristics of Cellulose Acylate Film)

In the optical characteristics of the cellulose acylate film of the invention, it is preferred that a Re retardation value and a Rth retardation value respectively defined by following relations (IX) and (X):

Re(λ)=(nx−ny)×d (IX)

Rth(λ)={(nx+ny)/2−nz}×d (X)

respectively satisfy following relations (XI) and (XII) in order to expand a viewing angle of a liquid crystal display, particularly a VA-mode liquid crystal display:

30 nm≦Re₍₅₉₀₎≦200 nm (XI)

70 nm≦Rth₍₅₉₀₎≦400 nm (XII)

wherein Re(λ) is a retardation value (unit in nm) in a film plane (i.e., an in-plane retardation value) at a wavelength λ nm, Rth(λ) is a retardation value in a thickness direction (unit in nm) at a wavelength λ nm, nx is a refractive index in a slow axis direction in the film plane, ny is a refractive index in a fast axis direction in the film plane, nz is a refractive index in a thickness direction in the film and d is a thickness of the film.

It is further preferable that the Re retardation satisfies a following relation:

40 nm≦Re₍₅₉₀₎≦100 nm (XIII).

Furthermore, the cellulose acylate film of the invention is preferably an optical biaxial film and satisfies a following relation (XIV) particularly in widening a viewing angle of a VA-mode liquid crystal display:

170 nm≦Rth₍₅₉₀₎≦300 nm (XIV).

Furthermore, in the cellulose acylate film of the invention, Re₍₆₃₀₎ and Rth₍₆₃₀₎ at 25° C., 60% RH preferably satisfy relations (A) to (C):

46≦Re₍₆₃₀₎≦150 nm (A)

Rth₍₆₃₀₎=a−5.9Re₍₆₃₀₎ (B)

580≦a≦670 (C)

wherein Re₍₆₃₀₎ is an in-plane retardation (unit in nm) at a wavelength of 630 nm, Rth₍₆₃₀₎ is a retardation in a thickness direction (unit in nm) at a wavelength of 630 nm, and a is a coefficient (unit in nm) of an optical characteristics.

The regulating coefficient a is for regulating Re and Rth, and more preferably satisfies a relation 590≦a≦660 and further preferably 600≦a≦650. The coefficient a falling within the range is preferred in view of expanding a viewing angle of a vertical alignment liquid crystal display device.

Also in the cellulose acylate film of the invention, it is preferable that a difference ΔRe(=Re10% RH−Re80% RH) between an Re value at 25° C., 10% RH and an Re value at 25° C., 80% RH is 0 to 10 nm, and a difference ΔRth(=Rth10% RH−Rth80% RH) between an Rth value at 25° C., 10% RH and an Rth value at 25° C., 80% RH is 0 to 30 nm, in order to reduce a change in hue in the lapse of time of the liquid crystal display.

A thickness distribution in the transversal direction was measured by collecting 10 test pieces of a size of 2 cm (transversal direction)×3 cm (perpendicular to transversal direction) at equal distance in the transversal direction of the film, starting from a position of 5 cm from a film edge, and by measuring a thickness in 3 positions in the longitudinal direction and in the transversal direction, thus 9 points in total, in the plane of each test piece (2×3 cm) as thicknesses thereof.

A thickness distribution R defined as R(%)=(Rₘₐₓ−Rₘᵢₙ)/Rₐᵥₑ×100, wherein Rₘₐₓ, Rₘᵢₙ and Rₐᵥₑ respectively represent a maximum value, a minimum value and an average value of the thickness in the transversal direction, is preferably regulated at 0-8%, more preferably 0-7.8% and further preferably 0-7.6%. As Re and Rth are proportional to the thickness, a smaller thickness distribution in the transversal direction is favorable in reducing the fluctuation in Re₍₅₉₀₎ and Rth₍₅₉₀₎.

A distribution in Re₍₅₉₀₎ and Rth₍₅₉₀₎ is generated from the aforementioned thickness distribution or from an unevenness in a stretching or a drying, and it is preferable that such distribution (fluctuation) in Re is regulated at 5% or less and such distribution in Rth is regulated at 10% or less. More preferably the distribution in Re is 4.8% or less and the distribution in Rth is 9.8% or less, and further preferably the distribution in Re is 4.6% or less and the distribution in Rth is 9.6% or less.

Such thickness distribution R, distribution of Re and that of Rth as described above are preferable in reducing an unevenness in the display when such film is employed in a liquid crystal display (particularly VA-mode liquid crystal display).

In the invention, optical characteristics were measured in the following manner.

Re(λ) was measured in KOBRA 21ADH (manufactured by Oji Measuring Instruments Co.) under an entry of a light of a wavelength of λ nm in a normal direction to the film. Also Rth(λ) was calculated by entering an assumed average refractive index of 1.48 and a thickness of the film, based on retardation values measured in three directions, namely Re(λ), a retardation value measured by entering a light of a wavelength λ nm from a direction inclined by +40° from the normal direction to the film, taking a slow axis in the film plane as an inclination axis, and a retardation value measured by entering a light of a wavelength λ nm from a direction inclined by −40° from the normal direction to the film, taking a slow axis in the film plane as an inclination axis.

Also in the cellulose acylate film of the invention, a color difference ΔE*ab before and after a standing for 500 hours at 90° C. is preferably 0.8 or less, more preferably 0.7 or less and further preferably 0.5 or less. Also a color difference before and after a standing for 24 hours at 140° C. is 1.5 or less, more preferably 1.0 or less and further preferably 0.5 or less. A coloration of the film under a forced environmental condition such as 500-hr standing at 90° C. or 24-hr standing at 140° C. results in an undesirable deterioration of an optical compensation ability and is also undesirable in appearance. The color difference was measured with UV3100 (manufactured by Shimadzu Ltd.). A film before standing in a thermal condition was subjected to a color measurement, after a moisture conditioning for at least 2 hours at 25° C. and 60% RH, to obtain an initial value (L0*, a0*, b0*). Then the film was let to stand singly in a thermostat air tank. After the lapse of a predetermined time, the film was taken out and, after a moisture conditioning for 2 hours at 25° C. and 60% RH, subjected to a color measurement to obtain a value (L1*, a1*, b1*) after standing. From these values, the color difference was determined as ΔE*ab=((L0*−L1*)²+(a0*−a1*)²+(b0*−b1*)²)^{1/2}.

Also the cellulose acylate film of the invention preferably has an equilibrium water content at 25° C., 80% RH of 5.0% or less, more preferably 4.0% or less and further preferably 3.2% or less, in order to reduce a change in the color of the liquid crystal display after standing in time.

A water content is measured by Karl Fischer method on a sample of a size of 7×35 mm of the cellulose acylate film of the invention, utilizing a moisture measuring instrument and a sample drying instrument (CA-03 and VA-05, both manufactured by Mitsubishi Chemical Corp.), and is calculated by dividing a water amount (g) with a sample weight (g).

Also the cellulose acylate film of the invention preferably has a moisture permeability (converted to a thickness of 80 μm) at 60° C., 95% RH and 24 hours of 400 to 1800 g/m²·24 hr, for reducing a change in color of the liquid crystal display after standing in time.

The moisture permeability becomes smaller for a larger thickness of the cellulose acylate film and larger for a smaller thickness. The measured moisture permeability is converted for a reference film thickness of 80 μm. A converted value of the moisture permeability is calculated by “moisture permeability converted to 80 μm=measured moisture permeability×measured thickness (μm)/80 μm”.

For measuring the moisture permeability, there can be employed a method described in “Physical properties of polymer II” (Polymer Experimental Lecture 4, Kyoritsu Shuppan), pages 285-294, measurement of vapor permeability (weight method, thermometer method, vapor pressure method, adsorption method).

A glass transition temperature is measured by subjecting a sample (unstretched) of a size of 5×30 mm of the cellulose acylate film of the invention, after a moisture conditioning for at least 2 hours at 25° C., 60% RH, to a measurement by a dynamic viscoelasticity measuring apparatus (Vibron DVA-225, manufactured by IT Keisoku Seigyo Co.) under conditions of a grip distance of 20 mm, a temperature elevating speed of 2° C./min, a measurement temperature range of 30-200° C. and a frequency of 1 Hz, then, on a chart indicating a storage modulus in a logarithmic scale on the ordinate and a temperature (° C.) in a linear scale on the abscissa, indicating a rapid decrease in the storage modulus observed at a transition from a solid area to a glass transition area by a straight line 1 in the solid area and a straight line 2 in the glass transition area. A crossing point of the lines 1 and 2 is taken as a glass transition temperature Tg (dynamic viscoelasticity), since such is a temperature where the storage modulus decreases rapidly at a temperature elevation and the film starts to soften and to enter a glass transition area.

A modulus and a breaking strength were measured, on a sample of 10×150 mm of the dry cellulose acylate film of the invention after a moisture control for at least 2 hours at 25° C., 60% RH, by a tentile tester (Strograph R2, manufactured by Toyo Seiki Co.) under conditions of a chuck distance of 100 mm, a temperature of 25° C. and a stretching speed of 10 mm/min.

Also the cellulose acylate film of the invention preferably has a haze of 0.01-2%. The haze is measured as follows.

A sample of 40×80 mm of the cellulose acylate film of the invention is measured by a haze meter (HGM-2DP, manufactured by Suga Shiken-ki Co.) at 25° C., 60% RH according to JIS K-6714.

Also the cellulose acylate film of the invention preferably has a weight change of 0-5% when let to stand for 48 hours under conditions of 80° C., 90% RH.

Also the cellulose acylate film of the invention preferably has a dimensional change of 0-5% when let to stand for 24 hours under conditions of 60° C., 95% RH and when let to stand for 24 hours under conditions of 90° C., 5% RH.

The cellulose acylate film of the invention preferably has an optoelastic coefficient of 50×10⁻¹³ cm²/dyne or less, for reducing a change in the color of the liquid crystal display in lapse of time.

More specifically, a tensile stress is applied to a sample of 10×100 mm of the cellulose acylate film in a longitudinal direction thereof, then a retardation is measured with an ellipsometer (for example M-150, manufactured by Jasco Corp.) and the optoelastic coefficient is calculated from a change in retardation as a function of stress.

(Polarizing Plate)

In the following, An exemplary embodiment of a polarizing plate of the invention will be explained.

A polarizing plate includes a polarizer and two transparent protective films provided on both sides thereof. In the present invention, a cellulose acylate film of the invention is employed as at least one protective film. The other protective film may be a cellulose acylate film of the invention or an ordinary cellulose acetate film. The polarizer includes an iodine-based polarizer, a dye-based polarizer employing a dichroic dye, and a polyene-based polarizer. The iodine-based polarizer and the dye-based polarizer are prepared with a polyvinyl alcohol film. In case of employing a cellulose acylate film of the invention as a protective film of a polarizing plate, the polarizing plate is not particularly restricted in a producing method and can be prepared by an ordinary producing method. For example there can be adopted a method of alkali treating an obtained cellulose acylate film and adhering such cellulose acylate film, with an aqueous solution of a completely saponified polyvinyl alcohol, on both sides of a polarizer prepared by dipping and stretching a polyvinyl alcohol film in an iodine solution. Instead of alkali treatment, there may be employed an adhesion promoting treatment as described in JP-A Nos. 6-94915 and 6-118232. An adhesive to be employed for adhering a treated surface of the protective film and the polarizer can be a polyvinyl alcohol-type adhesive such as polyvinyl alcohol or polyvinyl butyral, or a vinylic latex such as butyl acrylate. The polarizing plate is constituted of a polarizer and protective films for protecting both sides thereof, and a protecting film and a separation film may be adhered respectively on one side and the other side of such polarizing plate. The protecting film and the separation film are employed for the purpose of protecting the polarizing plate at a shipping or a product inspection of the polarizing plate. In such case, the protecting film is adhered for the purpose of protecting a surface of the polarizing plate, opposite to the side of the polarizing plate adhered to a liquid crystal panel, while the separation film is employed for the purpose of covering an adhesive layer for adhesion to the liquid crystal panel, on a side of the polarizing plate to be adhered to the liquid crystal panel.

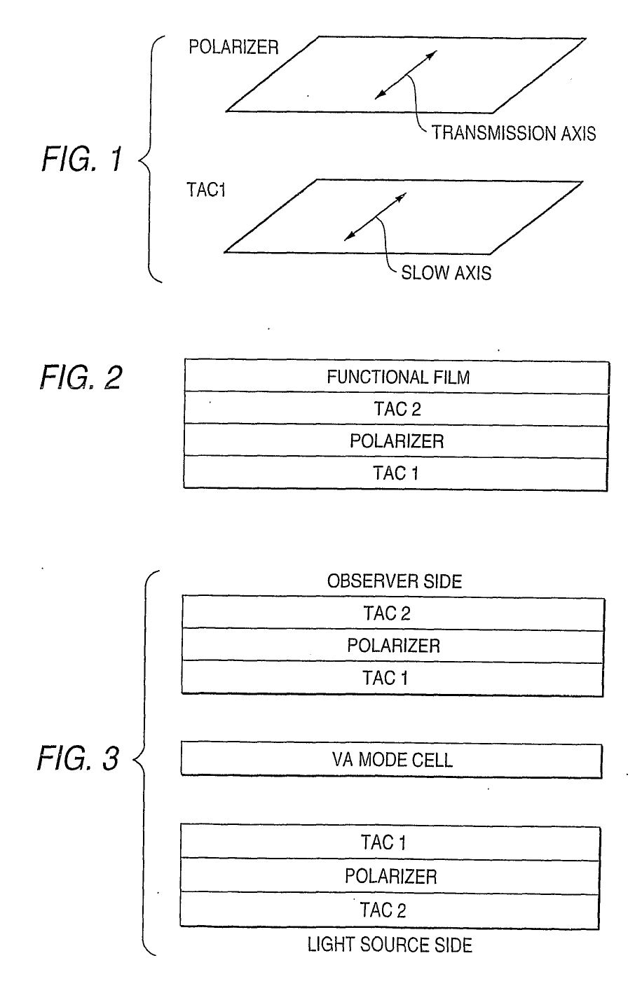

The cellulose acylate film of the invention is preferably adhered to the polarizer in such a manner, as shown in FIG. 1, that a transmission axis of the polarizer coincides with a slow axis of the cellulose acylate film (TAC1 in FIG. 1) of the invention.

In the prepared polarizing plate under a cross Nicol arrangement, in case a precision of perpendicularity between a slow axis of the cellulose acylate film of the invention and an absorption axis of the polarizer (perpendicular to the transmission axis) is larger than 1°, a polarizing ability under a cross Nicol arrangement is deteriorated to generate a light leak, thereby being unable to provide a sufficient black level or a sufficient contrast when combined with a liquid crystal cell. Therefore, an aberration between a main refractive index direction nx of the cellulose acylate film of the invention and a transmission axis of the polarizing plate is 1° or less, preferably 0.5° or less.

In the invention, a single plate transmittance, a parallel transmittance and a cross transmittance of the polarizing plate were measured with UV3100PC (manufactured by Shimadzu Ltd.). The measurement was conducted within a range of 380-780 nm under conditions of 25° C., 60% RH, and each of the single transmittance, the parallel transmittance and the cross transmittance was represented by an average value of 10 measurements. A durability test of the polarizing plate was conducted in two forms, namely (1) a polarizing plate alone, and (2) a polarizing plate adhered with an adhesive to a glass plate. A measurement on the polarizing plate alone was conducted by preparing a combination of an optical compensation film sandwiched between two polarizers in a cross arrangement, in two sets. Also a sample (5 cm×5 cm) adhered on a glass plate was prepared by adhering a polarizing plate on a glass plate in such a manner that an optical compensation film is positioned at the side of the glass plate, in two sets. The measurement of the single plate transmittance was conducted by setting the film side of the sample at a light source. Measurements were made respectively on the samples, and an average value was taken as a single plate transmittance. A range of the polarizing ability represented by a single-plate transmittance TT, a parallel transmittance PT, and a cross transmittance CT, is preferably 40.0≦TT≦45.0, 30.0≦PT≦40.0 and CT≦2.0, more preferably 40.2≦TT≦44.8, 32.2≦PT≦39.5 and CT≦1.6 and further preferably 41.0≦TT≦44.6, 34≦PT≦39.1 and CT≦1.3.

A polarization degree P is calculated from these transmittances, and a larger polarization indicates a higher performance of the polarizing plate with a less leaking light in a cross arrangement. The polarization degree P is preferably 95.0% or higher, more preferably 96.0% or higher and further preferably 97.0% or higher.

In the polarizing plate of the invention, with respect to a cross transmittance T(λ) at a wavelength λ, it is preferred that T₍₃₈₀₎, T₍₄₁₀₎ and T₍₇₀₀₎ satisfy at least one of relations (e)-(g):

T₍₃₈₀₎≦2.0 (e)

T₍₄₁₀₎≦1.0 (f)

T₍₇₀₀₎≦0.5 (g).

More preferably T₍₃₈₀₎≦1.95, T₍₄₁₀₎≦0.9, and T₍₇₀₀₎≦0.49, and further preferably T₍₃₈₀₎≦1.90, T₍₄₁₀₎≦0.8 and T₍₇₀₀₎≦0.48.

In the polarizing plate of the invention, it is preferred that a change ΔCT in a cross transmittance and a change ΔP in a polarization, after a standing for 500 hours under conditions of 60° C., 95% RH satisfy at least either of relations (j) and (k):

−6.0≦ΔCT≦6.0 (j)

−10.0≦ΔP≦0.0 (k)

wherein a change means a value obtained by subtracting a value measured before standing from a value measured after standing.

More preferably −5.8≦ΔCT≦5.8 and −9.5≦ΔP≦0.0 and further preferably −5.6≦ΔCT≦5.6 and −9.0≦ΔP≦0.0.

In the polarizing plate of the invention, it is preferred that a change ΔCT in a cross transmittance and a change ΔP in a polarization, after a standing for 500 hours under conditions of 60° C., 90% RH satisfy at least either of relations (h) and (i):

−3.0≦ΔCT≦3.0 (h)

−5.0≦ΔP≦0.0 (i).

In the polarizing plate of the invention, it is preferred that a change ΔCT in a cross transmittance and a change ΔP in a polarization, after a standing for 500 hours at 80° C. satisfy at least either of relations (l) and (m):

−3.0≦ΔCT≦3.0 (l)

−2.0≦ΔP≦0.0 (m).

Also such changes are preferably smaller in a polarizing plate durability test.

(Surface Treatment)

The cellulose acylate film of the invention may be subjected to a surface treatment for improving an adhesion between the cellulose acylate film and functional layers (such as an undercoat layer and a back layer). The surface treatment can be executed for example by a glow discharge treatment, an ultraviolet irradiation treatment, a corona treatment, a flame treatment, or an acid or alkali treatment. The glow discharge treatment can be executed with a low-temperature plasma generated in a low-pressure gas of 10⁻³-20 Torr, or can also be advantageously executed by a plasma treatment under an atmospheric pressure. A plasma exciting gas means a gas capable of exciting a plasma under the aforementioned condition, and can be argon, helium, neon, krypton, xenon, nitrogen, carbon dioxide, a fluorinated gas such as tetrafluoromethane or a mixture thereof. Details of such materials are detailedly described in Japan Institute of Invention and Innovation, Laid-open Technical Report (2001-1745, issued Mar. 15, 2001, JIII), pages 30-32. Also a recently investigated plasma treatment under the atmospheric pressure employs an irradiation energy for example of 20-500 Kgy under 10-1000 Kev, preferably 20-300 Kgy under 30-500 Kev. Among these, an alkali saponification treatment is particularly preferable and extremely useful as a surface treatment of the cellulose acylate film.

The alkali saponification treatment is preferably executed by a method of immersing a cellulose acylate film directly into a tank of a saponification liquid, or a method of coating a saponification liquid on a cellulose acylate film. The coating can be executed for example by a dip coating, a curtain coating, an extrusion coating, a bar coating or an E-type coating. For the coating liquid for the alkali saponification treatment, there is preferably selected a solvent having a satisfactory wetting property for coating the saponification liquid on the cellulose acylate film, and capable of maintaining a satisfactory surface state thereof without forming irregularities on the surface by the solvent of the saponification liquid. Specifically an alcohol solvent is preferably, and isopropyl alcohol is particularly preferable. Also an aqueous solution of a surfactant may be employed as a solvent. An alkali of the alkali saponification coating liquid is preferably an alkali soluble in such solvent, and KOH or NaOH is more preferable. The saponification coating liquid preferably has a pH value of 10 or higher, more preferably 12 or higher. The alkali saponification reaction is preferably executed under conditions of 1 second to 5 minutes at room temperature, more preferably 5 seconds to 5 minutes, and particularly preferably 20 seconds to 3 minutes. After the alkali saponification reaction, the surface coated with the saponification liquid is preferably rinsed with water, or washed with an acid and rinsed with water.

Also the polarizing plate of the invention is preferably provided with at least one of a hard coat layer, an antiglare layer and an antireflection layer, on a surface of a protective film at a side opposite to the polarizer. As shown in FIG. 2, a functional film such as an antireflection layer is preferably provided on a protective film (TAC2) positioned opposite to a liquid crystal cell at the use of the polarizing plate in a liquid crystal display, and such functional film is preferably at least one of a hard coat layer, an antiglare layer and an antireflection layer. These layers need not necessarily be provided as separate layers, and, for example by providing an antireflection layer with a function as an antiglare layer, the antireflection layer may be employed as a layer functioning as an antireflection layer and an antiglare layer.

(Antireflection Layer)

In the invention, there is advantageously employed an antireflection layer formed by laminating, on a protective film, at least a light scattering layer and a lower refractive index layer in this order, or a medium refractive index layer, a higher refractive index layer and a lower refractive index layer in this order. In the following preferred examples thereof will be shown.

A preferred example of an antireflection layer formed by forming, on a protective film, a light scattering layer and a lower refractive index layer will be explained.

In the light scattering layer, matting particles are preferably dispersed therein, and, a material of the light scattering layer other than the matting particles preferably has a refractive index within a range of 1.50-2.00. Also the lower refractive index layer preferably has a refractive index within a range of 1.20-1.49. In the invention, the light scattering layer has an antiglare property and a hard coating property, may be formed by a single layer or plural layers such as 2 to 4 layers.

The antireflective layer is preferably designed with surface irregularity characteristics of a center line-average roughness Ra of 0.08-0.40 μm, a 10 point-average roughness Rz of 10 times or less of Ra, an average peak-bottom distance Sm of 1-100 μm, a standard deviation of a protrusion peak from a deepest bottom of irregularities of 0.5 μm or less, a standard deviation of the average peak-bottom distance Sm of 20 μm or less with respect to a center line, and a plane of an inclination angle of 0-5° representing 10% or more, thereby achieving a sufficient antiglare property and a visually uniform matting. Also a hue in a reflected light under a light source C becomes neutral preferably by selecting an a* value of −2 to 2, a b* value of −3 to 3 and a ratio of a minimum value and a maximum value of a reflectance of 380-780 nm within a range of 0.5-0.99. Also by selecting a b* value within a range of 0-3 for a transmitted light under the light source C advantageously reduces a yellowish hue in a white display state in an application to a display apparatus. Also a luminance distribution, measured by inserting a grating pattern of 120×40 μm between a planar light source and an antireflection film of the invention, preferably shows a standard deviation of 20 or less, in order to reduce a glare when the film of the invention is applied to a high definition panel.

An antireflection layer employable in the invention preferably has optical characteristics of a mirror reflectance of 2.5% or less, a transmittance of 90% or higher, and a 60° luster of 70% or less. Such characteristics can suppress a reflection of an external light, thereby improving the visibility. In particularly a mirror reflectance is more preferably 1% or less and most preferably 0.5% or less. Also a prevention of a glare on a high definition LCD panel and a reduction of a blur in a character or the like can be advantageously attained by selecting conditions of a haze of 20-50%, an internal haze/total haze ratio of 0.3-1, a difference of 15% or less between a haze value up to the light scattering layer and that after formation of the lower refractive index layer, a transmission image sharpness of 20-50% at a combtooth width of 0.5 mm, and a transmittance ratio between a perpendicular direction and a direction inclined by 2° from the perpendicular direction of 1.5-5.0.

(Lower Refractive Index Layer)

In the following, there will be explained a lower refractive index layer to be employed in an antireflective layer formed by laminating, on a protective film, at least a light scattering layer and a lower refractive index layer.

The lower refractive index layer has a refractive index preferably within a range of 1.20-1.49, more preferably 1.30-1.44. Also the lower refractive index layer preferably satisfies a following relation (XV) for achieving a lower reflectance:

(m/4)×0.7<n₁d₁<(m/4)×1.3 (XV)

wherein m is a positive odd number; n₁ is a refractive index of the lower refractive index layer; and d₁ is a thickness (nm) of the lower refractive index layer. λ indicates a wavelength within a range of 500-550 nm.

A material for forming the lower refractive index layer will be explained in the following.

The lower refractive index layer preferably contains a fluorinated polymer as a lower refractive index binder. The fluorinated polymer is preferably a fluorine-containing polymer having a dynamic friction coefficient of 0.03-0.20, a contact angle with water of 90-120°, and a purified water gliding angle of 70° or less and capable of crosslinking by heat or an ionizing radiation. When the polarizing plate of the invention is mounted on an image display apparatus, a lower peeling force to a commercially available adhesive tape is preferable since a seal or a memorandum eventually adhered thereon can be easily peeled off, and is preferably 500 gf or less in a measurement with a tensile tester, more preferably 300 gf or less and most preferably 100 gf or less. Also a higher surface hardness measured with a micro hardness meter is preferable for a higher scratch resistance, and is preferably 0.3 GPa or higher and more preferably 0.5 GPa or higher.

The fluorine-containing polymer to be employed in the lower refractive index layer can be a hydrolysis product or a dehydration condensate of a silane compound containing a perfluoroalkyl group (such as heptadecafluoro-1,1,2,2-tetrahydrodecyl)triethoxysilane, or a fluorine-containing copolymer constituted of a fluorine-containing monomer unit and a constituent unit providing a crosslinking property.

Specific examples of a monomer constituting the fluorine-containing monomer unit as a constituent of the fluorine-containing copolymer include a fluoroolefin (such as fluoroethylene, vinylidene fluoride, tetrafluoroethylene, perfluorooctylethylene, hexafluoropropylene, or perfluoro-2,2-dimethyl-1,3-dioxol), a partially or completely fluorinated alkyl ester derivative of (meth)acrylic acid (such as Viscote 6FM (manufactured by Osaka Organic Chemical Industry Ltd.) or M-2020 (manufactured by Daikin Co.) and a completely or partially fluorinated vinyl ether, and preferably a perfluoroolefin, and, particularly preferably hexafluoropropylene in consideration of refractive index, solubility and availability.

The constituent unit providing the crosslinking property can be, for example, a constituent unit obtained by a polymerization of a monomer having a self-crosslinkable functional group within the molecule such as glycidyl (meth)acrylate or glycidyl vinyl ether, a constituent unit obtained by a polymerization of a monomer having a carboxyl group, a hydroxyl group, an amino group or a sulfo group (such as (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid), or a constituent unit formed by introducing, into the aforementioned constituent unit, a crosslinking reactive group such as a (meth)acryloyl group by a polymer reaction (for example an introduction by reacting acryl chloride with a hydroxyl group).

It is also possible to copolymerize, in addition to the fluorine-containing monomer unit and the constituting unit for providing the crosslinking property, a suitable monomer not containing a fluorine atom in consideration of a solubility in solvent and a transparency of film. The usable monomer is not particularly restricted and can be, for example, an olefin (such as ethylene, propylene, isopropylene, vinyl chloride or vinylidene chloride), an acrylate ester (such as methyl acrylate, ethyl acrylate, or 2-ethylhexyl acrylate), a methacrylate ester (such as methyl methacrylate, ethyl methacrylate, butyl methacrylate or ethylene glycol dimethacrylate), a styrene derivative (such as styrene, divinylbenzene, vinyltoluene, or o-methylstyrene), a vinyl ether (such as methyl vinyl ether, ethyl vinyl ether or cyclohexyl vinyl ether), a vinyl ester (such as vinyl acetate, vinyl propionate, or vinyl cinnamate), an acrylamide (such as N-tert-butyl acrylamide or N-cyclohexyl acrylamide), a methacrylamide or an acrylonitrile derivative.

With such polymer, a hardening agent may be suitably employed in combination as described in JP-A Nos. 10-25388 and 10-147739.

(Light Scattering Layer)

A light scattering layer is formed for providing the film with a light scattering property by at least either of a surface scattering and an internal scattering, and a hard coat property for improving the scratch resistance of the film. It therefore contains a binder for providing the hard coat property, matting particles for providing the light diffusing property, and, if necessary, an inorganic filler for realizing a higher refractive index, a prevention of shrinkage by crosslinking and a high strength. Also such light scattering layer, when present, functions also as an antiglare layer whereby the polarizing plate has an antiglare layer.

The light scattering layer preferably has a thickness of 1-10 μm for providing the hard coat property, more preferably 1.2-6 μm. An excessively small thickness results in an insufficient hard coat property, while an excessively large thickness aggravates a curl or a brittleness thereby resulting in an insufficient working property.

A binder for the light scattering layer is preferably a polymer having a saturated hydrocarbon chain or a polyether chain as a main chain, and more preferably a polymer having a saturated hydrocarbon chain as a main chain. Also the binder polymer preferably has a crosslinked structure. As the binder polymer having a saturated hydrocarbon chain as a main chain, there is preferred a polymer of an ethylenic unsaturated monomer. Also as the binder polymer having a saturated hydrocarbon chain as a main chain and having a crosslinked structure, there is preferred a (co)polymer of a monomer having two or more ethylenic unsaturated groups. For obtaining a binder polymer of a higher refractive index, there can be selected a monomer structure containing an aromatic ring or at least an atom selected from a non-fluorine halogen atom, a sulfur atom, a phosphor atom and a nitrogen atom.

Examples of a monomer having two or more ethylenic unsaturated groups include an ester of a polyhydric alcohol and (meth)acrylic acid (such as ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyactylate, or polyester polyacrylate), an ethylene oxide-denatured substance thereof, vinylbenzene and a derivative thereof (such as 1,4-divinylbenzene, 4-vinylbenzoic acid 2-acryloylethyl ester, or 1,4-divinylcyclohexanone), a vinylsulfone (such as divinylsulfone), an acrylamide (such as methylenebisacrylamide) and a methacrylamide. Such monomer may be employed in a combination of two or more kinds.

Specific examples of the higher refractive index monomer include bis(4-methacryloylthiophenyl)sulfide, vinylnaphthalene, vinylphenyl sulfide and 4-methacryloxyphenyl-4′-methoxyphenyl thioether. Such monomer can also be employed in a combination of two or more kinds.

Polymerization of such monomer having ethylenic unsaturated groups can be executed by an irradiation with an ionizing radiation or by heating, in the presence of a photoradical initiator or a thermal radical initiator.

It is therefore possible to form an antireflection film by preparing a coating liquid containing a monomer having ethylenic unsaturated groups, a photoradical initiator or a thermal radical initiator, matting particles and an inorganic filler, then coating such coating liquid on a protective film and executing a polymerization reaction by an ionizing radiation or a heat. Such photoradical initiator and the like can be those commercially available.

A polymer having a polyether as a main chain is preferably a ring-opening polymer of a polyfunctional epoxy compound. A ring-opening polymerization of the polyfunctional epoxy compound can be executed by an irradiation with an ionizing radiation or by heating, in the presence of a photoacid generating agent or a thermal acid generating agent.

It is therefore possible to form an antireflection film by preparing a coating liquid containing a polyfunctional epoxy compound, a photoacid generating agent or a thermal acid generating agent, matting particles and an inorganic filler, then coating such coating liquid on a protective film and executing a polymerization reaction by an ionizing radiation or a heat.

It is also possible to employ a monomer having a crosslinking functional group, instead of or in addition to a monomer having two or more ethylenic unsaturated groups, thereby introducing a crosslinkable functional group in the polymer, and, utilizing a function of such crosslinkable functional group, to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also vinylsulfonic acid, an acid anhydride, a cyanoactylate derivative, melamine, etherified methylol, an ester, an urethane or a metal alkoxide such as tetramethoxysilane can be utilized as a monomer for introducing a crosslinked structure. There can also be employed a functional group capable of showing a crosslinking property as a result of a decomposition reaction, such as block isocyanate group. Thus, in the invention, the crosslinking functional group need not necessarily be a group immediately capable of a reaction but showing a reactivity after a decomposition reaction.

The binder polymer having such crosslinking functional group can form a crosslinked structure by heating after coating.

The light scattering layer contains, for the purpose of providing an antiglare property, matting particles such as particles of an inorganic compound or a resin, larger than the filler particles and having an average particle size of 1-10 μm, preferably 1.5-7.0 μm.

Specific examples of the matting particles preferably include particles of an inorganic compound such as silica particles, or TiO₂ particles; and resin particles such as acryl particles, crosslinked acryl particles, polystyrene particles, crosslinked styrene particles, melamine resin particles, or benzoguanamine resin particles. Among these there are preferred crosslinked styrene particles, crosslinked acryl particles, crosslinked acryl-styrene particles and silica particles. The matting particles may have spherical or amorphous shape.

Also there may be employed matting particles of two or more kinds of different particle sizes. It is possible to provide an antiglare property with the matting particles of a larger particle size and to provide another optical property with the matting particles of a smaller particle size.

A particle size distribution of the matting particles is most preferably a single dispersion, and sizes of the particles are preferably as close as possible. By defining a particle having a size larger by 20% or more than an average particle size as a coarse particle, a proportion of such coarse particles is preferably 1% or less of a number of all the particles, more preferably 0.1% or less and further preferably 0.01% or less. Matting particles having such particle size distribution can be obtained by executing a classification after an ordinary synthesizing reaction, and matting particles of a more preferable distribution can be obtained for example by increasing the number of classifications or by increasing a level thereof.

Such matting particles are contained in the light scattering layer in such a manner that an amount of the matting particles therein is preferably 10-1000 mg/m², more preferably 100-700 mg/m².

A particle size distribution of the matting particles is measured by a Coulter counter and is converted into a number distribution of the particles.

In the light scattering layer, in order to increase the refractive index of the layer, there is preferably contained, in addition to the matting particles, an inorganic filler constituted of at least an oxide of a metal selected from titanium, zirconium, aluminum, indium, zinc, tin and antimony and having an average particle size of 0.2 μm or less, preferably 0.1 μm or less and further preferably 0.06 μm or less.

Inversely, in a light scattering layer utilizing higher refractive index matting particles, in order to maintain a large difference in the refractive index from the matting particles, it is preferably to employ a silicon oxide in order to maintain a refractive index of the layer at a low level. A preferred particle size is same as that of the inorganic filler.

Specific examples of the inorganic filler to be employed in the light scattering layer include TiO₂, ZrO₂, Al₂O₃, In₂O₃, ZnO, SnO₂, Sb₂O₃, ITO and SiO₂. TiO₂ and ZrO₂ are particularly preferable in obtaining a higher refractive index. The inorganic filler may also be preferably subjected, on the surface thereof, to a silane coupling treatment or a titanium coupling treatment, and a surface treating agent having a functional group capable of reacting with the binder is preferably employed on the filler surface.

An amount of such inorganic filler is preferably 10-90% of the entire weight of the light scattering layer, more preferably 20-80% and particularly preferably 30-75%.

Such filler does not cause a light scattering as its particle size is sufficiently smaller than a wavelength of the light, and a dispersion formed by dispersing such filler in the binder polymer behaves as an optically uniform medium.

A bulk refractive index of the mixture of the binder and the inorganic filler of the light scattering layer is preferably 1.50-2.00, more preferably 1.51-1.80. A refractive index within such range can be realized by suitably selecting types and proportions of the binder and the inorganic filler. Such selection can be easily made by executing an experiment in advance.

The light scattering layer contains a surfactant of fluorine type and/or silicone type in a coating composition for forming the light scattering layer, in order to secure a surface uniformity, for example against a coating unevenness, a drying unevenness or a point defect. Particularly a fluorinated surfactant is employed preferably as it can be effective, with a smaller amount of addition, in improving a surface failure such as a coating unevenness, a drying unevenness or a point defect in the antireflection film. It is employed for providing an adaptability to a high-speed coating, while improving the uniformity of the surface property, thereby improving the productivity.

In the following there will be explained an antireflection layer formed by laminating, on a protective film, a medium refractive index layer, a higher refractive index layer and a lower refractive index layer in this order.

An antireflection layer having a layered structure of a medium refractive index layer, a higher refractive index layer and a lower refractive index layer (outermost layer) in this order on a protective film is designed with refractive indexes satisfying a following relation:

refractive index of higher refractive index layer>refractive index of medium refractive index layer>refractive index of protective film>refractive index of lower refractive index layer.

Also a hard coat layer may be provided between the protective film and the medium refractive index layer. Furthermore, the antireflection layer may be constituted of a medium refractive index hard coat layer, a higher refractive index layer and a lower refractive index layer.

Examples of such antireflective layer are described for example in JP-A Nos. 8-122504, 8-110401, 10-300902, 2002-243906 and 2000-111706.

Also another function may be provided to each layer, such as a lower refractive index layer with an antistain property or a higher refractive index layer with an antistatic property, as described in JP-A Nos. 10-206603 and 2002-243906.

The antireflective layer preferably has a haze of 5% or less, more preferably 3% or less. Also it preferably has a film strength of H or higher in a pencil hardness test according to JIS K5400, more preferably 2H or higher and most preferably 3H or higher.

(Higher Refractive Index Layer and Medium Refractive Index Layer)

A layer having a higher refractive index in the antireflection layer is formed by a cured film containing at least fine particles of an inorganic compound of an average particle size of 100 nm or less having a higher refractive index, and a matrix binder.

The fine particles of the inorganic compound of a higher refractive index can be fine particles of an inorganic compound of a refractive index of 1.65 or higher, preferably 1.9 or higher. Examples include particles of an oxide of Ti, Zn, Sb, Sn, Zr, Ce, Ta, La or In, or a complex oxide containing such metal atom.

Fine particles of an average particle size of 100 nm or less can be formed for example by a processing of particle surface with a surface treating agent (for example a silane coupling agent as described in JP-A Nos. 11-295503, 11-153703 or 2000-9908; an anionic compound or an organometallic coupling agent as described in JP-A No. 2001-310432), a core-shell structure having a higher refractive index particle as a core (as described in JP-A No. 2001-166104), or a combined use of a specified dispersant (as described in JP-A No. 11-153703, U.S. Pat. No. 6,210,858B1 and JP-A No. 2002-2776069).

A material constituting a matrix can be a known thermoplastic resin or a curable resin film.

There is further preferred at least a composition selected from a composition containing a polyfunctional compound having two or more of at least either of a radical polymerizable group and a cationic polymerizable group, and a composition containing an organometallic compound having a hydrolysable group and a partial condensate thereof, such as compositions described in JP-A Nos. 2000-47004, 2001-315242, 2001-31871 and 2001-296401.

There is also preferred a curable film obtained from a composition of a colloidal metal oxide formed from a hydrolysis condensate of a metal alkoxide and a metal alkoxide, as described for example in JP-A No. 2001-293818.

The higher refractive index layer preferably has a refractive index of 1.70-2.20, preferably a thickness of 5 nm-10 μm and further preferably 10 nm-1 μm.

A refractive index of the medium refractive index layer is so regulated as to assume a value between the refractive indexes of the lower refractive index layer and the higher refractive index layer. The medium refractive index layer preferably has a refractive index of 1.50-1.70. Also it has a thickness preferably of 5 nm-10 μm, more preferably 10 nm-1 μm.

(Lower Refractive Index Layer)

In the following there will be explained a lower refractive index layer, in an antireflection layer formed by laminating, on a protective film, a medium refractive index layer, a higher refractive index layer and a lower refractive index layer in this order.

The lower refractive index layer is formed in succession to the higher refractive index layer, and preferably has a refractive index of 1.20-1.55, more preferably 1.30-1.50.

It is preferably constructed as an outermost layer having a scratch resistant property and a stain resistant property. For significantly improving the scratch resistance, it is effective to provide a lubricating property to the surface, and there can be utilized a known method such as introducing silicone or fluorine.

Also a fluorine-containing compound is preferably a compound having a crosslinking or polymerizable functional group, containing fluorine atoms within a range of 35-80 weight %.

For example, there can be utilized compounds described in JP-A No. 9-222503, paragraphs (0018)-(0026), JP-A No. 11-38202, paragraphs (0019)-(0030), JP-A No. 2001-40284, paragraphs (0027)-(0028), and JP-A No. 2000-284102.

The fluorine-containing compound preferably has a refractive index of 1.35-1.50, more preferably 1.36-1.47.

A silicone compound is preferably a compound having a polysiloxane structure, containing a curable functional group or a polymerizable functional group in a polymer chain and having a crosslinked structure in the film. It can be, for example, a reactive silicone (such as Silaplane manufactured by Chisso Corp.) or a polysiloxane having silanol groups on both terminal ends (as described in JP-A No. 11-258403).

A crosslinking or polymerization reaction of at least either of the fluorine-containing polymer having a crosslinking or polymerizable group or the siloxane polymer can be executed by a light irradiation or by a heating simultaneous with or after a coating of a coating composition containing a polymerization initiator, a sensitizer and the like for forming an outermost layer.

There is also preferred a sol-gel cured film, cured by a condensation reaction of an organometallic compound such as a silane coupling agent and a silane coupling agent containing a specified fluorine-containing hydrocarbon group in the presence of a catalyst.

For example there can be employed a silane compound containing a polyfluoroalkyl group or a partially hydrolyzed condensate thereof (such as compounds described in JP-A Nos. 58-142958, 58-147483, 58-147484, 9-157582 and 11-106704), or a silyl compound containing a poly(perfluoroalkyl ether) group which is a fluorine-containing long-chain group (such as compounds described in JP-A Nos. 2000-117902, 2001-48590 and 2002-53804).

The lower refractive index layer may contain, as additives other than those mentioned above, a filler (such as silicon dioxide (silica), a lower refractive index inorganic compound with an average primary particle size of 1-150 nm such as fluorine-containing particles (such as of magnesium fluoride, calcium fluoride or barium fluoride), or organic particles described in JP-A No. 11-3820, paragraphs (0020)-(0038)), a silane coupling agent, a lubricant, or a surfactant.

In case the lower refractive index layer is positioned under the outermost layer, the lower refractive index layer may be formed by a gaseous process (vacuum evaporation, sputtering, ion plating or plasma CVD). However, a coating method is preferable because it allows an inexpensive preparation.

The lower refractive index layer preferably has a film thickness of 30-200 nm, more preferably 50-150 nm and most preferably 60-120 nm.

(Hard Coat Layer)

A hard coat layer is provided on the surface of the protective film, in order to given a physical strength to the protective film having the antireflection layer. It is particularly preferably provided between a transparent substrate and a higher refractive index layer described above. The hard coat layer is preferably formed, at least utilizing either of light and heat, by a crosslinking reaction or a polymerization reaction of a curable compound. A curable functional group in the curable compound is preferably a photopolymerizable functional group. There can also be advantageously employed an organometallic compound or an organic alkoxysilyl compound containing a hydrolysable functional group.

Specific examples of such compound can be similar to those cited for the higher refractive index layer. Specific configuration and composition of the hard coat layer are described for example in JP-A Nos. 2002-144913 and 2000-9908 and WO No. 00/46617.

The higher refractive index layer can serve also as a hard coat layer. Such layer is preferably formed by finely dispersing fine particles in the hard coat layer by a method described for the higher refractive index layer.

The hard coat layer may also contain particles of an average particle size of 0.2-10 μm to obtain an antiglare function, thereby serving also as an antiglare layer.

The hard coat layer may have a film thickness suitably designed according to the application, and preferably has a thickness of 0.2-10 μm and more preferably 0.5-7 μm.

The hard coat layer preferably has a strength of H or higher in a pencil hardness test according to JIS K5400, more preferably 2H or higher and most preferably 3H or higher. It also preferably has an abrasion, in a Taber test according to JIS K5400, as small as possible between before and after the test.

(Other Layers in Antireflective Layer)

There may also be provided a front scattering layer, a primer layer, an antistatic layer, an undercoating layer, a protective layer and the like.

(Antistatic Layer)

In case of forming an antistatic layer, there is preferably provided a conductivity of a volumic resistivity of 10⁻⁸ (Ω·cm⁻³) or less. A volumic resistivity of 10⁻³ (Ω·cm⁻³) or less can be realized by employing a hygroscopic substance, a water-soluble inorganic salt, a certain surfactant, a cationic polymer, an anionic polymer or colloidal silica, but there are involved a drawback of a large dependence on temperature and humidity and a drawback that a sufficient conductivity cannot be secured at a low humidity. Therefore a metal oxide is preferable as the material for the conductive layer. Certain metal oxide that is colored is unfavorable since it colors the entire film, in case it is employed as the material of the conductive layer. A metal that forms a colorless metal oxide can be Zn, Ti, Al, In, Si, Mg, Ba, Mo, W or V, and a metal oxide employing such metal as a principal component is preferably employed. Specific examples include ZnO, TiO₂, SnO₂, Al₂O₃, In₂O₃, SiO₂, MgO, BaO, MoO₃, V₂O₅ or a composite oxide thereof, particularly preferably ZnO, TiO₂, or SnO₂. As a composition including another atom, there can be effectively utilized, for example, an addition Al or In to ZnO, an addition of Sb, Nb or a halogen element to SnO₂, or an addition of Nb or Ta to TiO₂. Also as described in JP-B No. 59-6235, there may be employed a material in which the aforementioned metal oxide is attached to other crystalline metal particles or a fibrous substance (such as titanium oxide). A volumic resistivity and a surface resistance are different physical properties and cannot be compared in a simple manner, but, in order to secure a conductivity of a volumic resistivity of 10⁻⁸ (Ω·cm⁻³) or less, the antistatic layer is generally required to have a surface resistance of 10⁻¹⁰Ω/□ or less, more preferably 10⁻⁸Ω/□ or less. A surface resistance of the antistatic layer is a value when the antistatic layer is formed as an outermost layer, and can be measured in the course of formation of the antistatic layer.

(Liquid Crystal Display)

A liquid crystal display of the invention is a liquid crystal display employing either a cellulose acylate film of the invention or a polarizing plate of the invention (first embodiment), a liquid crystal display of VA or OCB mode utilizing two polarizing plates of the invention on and under a liquid crystal cell (second embodiment), or a liquid crystal display of VA mode employing a polarizing plate of the invention at a backlight side (third embodiment).

Thus the cellulose acylate film of the invention can be advantageously employed as an optical compensation film. Also the polarizing plate, utilizing the cellulose acylate film of the invention, can be advantageously employed in a liquid crystal display. The cellulose acylate film of the invention can be employed in liquid crystal cells of various display modes. Various display modes have been proposed, such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic). The cellulose acylate film of the invention can be preferably employed in the VA mode or the OCB mode.

In a liquid crystal cell of VA mode, rod-shaped liquid crystal molecules are aligned substantially vertically in the absence of a voltage application.

The liquid crystal cell of VA mode includes (1) a liquid crystal cell of VA mode of narrow sense in which the rod-shaped liquid crystal molecules are aligned substantially vertically in the absence of a voltage application and aligned substantially horizontally under a voltage application (described in JP-A No. 2-176625), (2) a liquid crystal cell (of MVA mode) in which the VA mode is formed in multi domains for expanding the viewing angle (SID97, Digest of tech. papers (preprints) 28 (1997), 845), (3) a liquid crystal cell of an n-ASM mode in which the rod-shaped liquid crystal molecules are aligned substantially vertically in the absence of a voltage application and are aligned in twisted multi domains under a voltage application (described in Japan Liquid Crystal Seminar, preprints 58-59 (1998)), and (4) a liquid crystal cell of a SURVIVAL mode (reported at LCD International 98).

A liquid crystal display of VA mode includes, as shown in FIG. 3, a liquid crystal cell (VA mode cell) and two polarizing plates (each formed by TAC1, a polarizer and TAC2) positioned on both sides thereof. Though not illustrated, the liquid crystal cell includes a liquid crystal between two electrode substrates.

In an embodiment of the transmission liquid crystal display of the invention, the cellulose acylate film of the invention is employed as an optical compensation sheet, and is either positioned by one unit between the liquid crystal cell and one of the polarizing plates, or by two units between the liquid crystal cell and both polarizing plates.

In another embodiment of the transmission liquid crystal display of the invention, the cellulose acylate film of the invention is employed as a protective film of the polarizing plate provided between the liquid crystal cell and the polarizer. The cellulose acylate film may be employed only in the protective film (between the liquid crystal cell and the polarizer) on a polarizing plate, or may be employed in two protective films (between the liquid crystal cell and the polarizers) on both polarizing plates. In the adhesion to the liquid crystal cell, the cellulose acylate film (TAC1) of the invention is preferably positioned at the side of the VA cell. In case the cellulose acylate film is employed only in the protective film (between the liquid crystal cell and the polarizer) on a polarizing plate, it may be employed in an upper polarizing plate (at the observing side) or in a lower polarizing plate (at the backlight side), without any functional difference. However, in case of employing in the upper polarizing plate, a functional film has to be provided in the observing side (upper side) and a production yield may be deteriorated. Consequently the use in the lower polarizing plate is considered probable and is considered as a more preferable embodiment.

In the liquid crystal display of the second embodiment, the polarizing plate of the invention is employed both in the light source side and the observing side in FIG. 3, and, in the liquid crystal display of the third embodiment, the polarizing plate of the invention is employed only in the light source side.

In FIG. 3, a protective film (TAC2) may be formed by an ordinary cellose acylate film, and is preferably thinner than the cellulose acylate film of the invention. It preferably has a thickness of 40-80 μm, and can be a commercial product such as KC4UX2M (40 μm manufactured by Konica Opto Co.), KC5UX (60 μm manufactured by Konica Opto Co.) or TD80 (80 μm manufactured by Fuji Photo Film Co.), but is not limited to such examples.

### EXAMPLES

In the following, the present invention will be further clarified by examples, but the present invention is not limited to such examples.

### Example 1

### Preparation of Cellulose Acylate Film

### Cellulose Acylate

Cellulose acylates different in the type and the substitution degree of acyl group as shown in Table 1 were prepared, by executing an acylation reaction at 40° C. by adding sulfuric acid as a catalyst (7.8 parts by weight with respect to 100 parts by weight of cellulose) and also adding a carboxylic acid constituting a raw material of the acyl group. In this operation, a type and an amount of the carboxylic acid were regulated to adjust the type and the substitution degree of the acyl group. After the acylation, a ripening was executed at 40° C. Then a low molecular component of the cellulose acylate was eliminated by washing with acetone. In the table, CAP indicates cellulose acetate propionate (a cellulose ester derivative in which acyl groups are an acetate group and a propionyl group), and CTA means cellulose triacetate (a cellulose ester derivative in which actyl groups are constituted solely of acetate groups).

(1) Cellulose Acylate

Cellulose acylates different in the acyl substitution degree as shown in Table 1 were prepared, by executing an acylation reaction at 40° C. by adding sulfuric acid as a catalyst (7.8 parts by weight with respect to 100 parts by weight of cellulose) and also adding a carboxylic acid. An amount of the sulfuric acid catalyst, an amount of water and a ripening time were regulated to adjust a total substitution degree and a 6-position substitution degree. A ripening was executed at 40° C. Then a low molecular component of the cellulose acylate was eliminated by washing with acetone.

(2) Dope Preparation

<1-1> Cellulose Acylate Solution

A following composition was charged in a mixing tank, agitated to dissolve components, then heated for about 10 minutes at 90° C. and filtered with a filter paper of an average pore size of 34 μm and a sintered metal filter of an average pore size of 10 μm.

Cellulose acylate solution

| | | |
|---|---|---|
| cellulose acylate in Table 1 | 100.0 | parts by weight |
| triphenyl phosphate (plasticizer) | 8.0 | parts by weight |
| biphenyldiphenyl phosphate | 4.0 | parts by weight |
| methylene chloride (first solvent) | 403.0 | parts by weight |
| methanol (second solvent) | 60.2 | parts by weight |

<102> Matting Agent Dispersion

A following composition, including the cellulose acylate solution prepared by the aforementioned process was charged in a disperser to obtain a matting agent dispersion.

Matting agent solution

| | |
|---|---|
| silica particles of average particle | 2.0 parts by weight |
| size 16 nm (AEROSIL R972, manufactured | |
| by Nippon Aerosil Co.) | |
| methylene chloride | 72.4 parts by weight |
| methanol | 10.8 parts by weight |
| cellulose acylate solution | 10.3 parts by weight |

<1-3> Retardation Developing Solution A

Then a following composition, containing the cellulose acylate solution prepared in the aforementioned process, was charged in a mixing tank, and components were dissolved by heating under agitation to obtain a retardation developing agent solution A.

Retardation developing agent solution A

| | |
|---|---|
| retardation developing agent | 20.0 parts by weight |
| methylene chloride | 58.3 parts by weight |
| methanol | 8.7 parts by weight |
| cellulose acylate solution | 12.8 parts by weight |

A film forming dope was prepared by mixing 100 parts by weight of the aforementioned cellulose acylate solution, 1.35 parts by weight of the matting agent dispersion and the retardation developing agent solution A in a proportion shown in Tables 1-3. An amount of addition of the retardation developing agent is shown in Tables 1 and 2, in parts in weight with respect to 100 parts by weight of cellulose acylate.

Retardation Developing Agent A

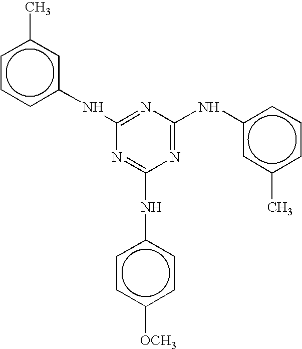

<1-4> Retardation Developing Solution B

A following composition, containing the cellulose acylate solution prepared in the aforementioned process, was charged in a mixing tank, and components were dissolved by heating under agitation to obtain a retardation developing agent solution B.

Retardation developing agent solution B

| | | |
|---|---|---|
| retardation developing agent A | 8.0 | parts by weight |
| retardation developing agent B | 12.0 | parts by weight |
| methylene chloride | 58.3 | parts by weight |
| methanol | 8.7 | parts by weight |
| cellulose acylate solution | 12.8 | parts by weight |

A film forming dope was prepared by mixing 100 parts by weight of the aforementioned cellulose acylate solution, 1.35 parts by weight of the matting agent dispersion and the retardation developing agent solution B in a proportion shown in Table 3. An amount of addition of the retardation developing agent is shown in Table 3, in parts in weight with respect to 100 parts by weight of cellulose acylate.

Retardation Developing Agent B

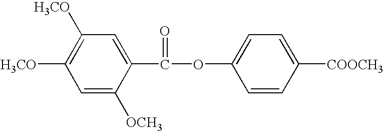

(Dissolution (Dope Preparation))

A cellulose acylate, a plasticizer and a following retardation regulating agent, shown in Table 1, were charged under agitation in a mixed solvent of dichloromethane/methanol (87/13 in parts by weight) so as to obtain a cotton weight concentration of 15 weight % and dissolved under heating and agitation. In this operation, a fine particle matting agent (silicon dioxide (primary particle size: 20 nm) of a Morse hardness of about 7) by 0.05 parts by weight with respect to 100 parts by weight of cellulose acylate was charged and agitated under agitation to obtain a dope.

(Casting)

The aforementioned dope was cast with a band casting machine. The film peeled off from the band at a remaining solvent amount of 25-35 weight % was stretched, in a tenter zone with an air feeding temperature of 140° C. (with an air exhaust temperature within a range of 90-125° C.), in a transversal direction with a stretching factor of 0-30% (cf. Table 1) to obtain a cellulose acylate film (thickness: 92 μm). The stretching factor of the tenter is shown in Table 1. The cast film thickness was so regulated as to obtain a thickness of 92 μm after the stretching. The prepared cellulose acylate film (optical compensation film) was subjected to measurements of Re retardation and Rth retardation at 25° C., 60% RH by an automatic birefringence meter (KOBRA 21ADH, manufactured by Oji Measuring Instruments Co.) and obtained results are shown in Table 1. The measurements were also conducted, after a moisture control of the film for at least 2 hours under 25° C., 10% RH and 25° C., 80% RH, under such conditions. As to changes ΔRe and ΔRth in the retardations of the cellulose acylate film corresponding to a change from 80% RH to 10% RH (ΔRe=Re(10% RH)−Re(80% RH), ΔRth=Rth(10% RH)−Rth(80% RH)), a stretch CTA showed ΔRe of 5-13 nm and ΔRth of 25-30, and a stretched CAP showed ΔRe of 10 nm and ΔRth of 20 nm or less.

TABLE 1

| | | | | | | total | | | | |
|---|---|---|---|---|---|---|---|---|---|---|
| | | Ac group | | Bu/Pr group | | sub | | retard. | | |
| Ex. | cotton | | sub | | sub. | deg. | Plasticizer *1 | dev. | stretching factor | |
| No. | type | type | deg. A | type | deg. B | A + B | TPP/BDP | agent | MD | TD |
| 1c | CTA | Ac | 2.87 | — | 0.00 | 2.87 | 11.7 | 5.1 | no str | no str |
| 1 | ″ | ″ | ″ | ″ | ″ | ″ | ″ | ″ | fixed | 25% |
| 2 | ″ | ″ | ″ | ″ | ″ | ″ | ″ | ″ | fixed | 30% |
| 2c | CTA | Ac | 2.82 | — | 0.00 | 2.82 | 11.7 | 5.1 | no str | no str |
| 3 | ″ | ″ | ″ | ″ | ″ | ″ | ″ | ″ | fixed | 25% |
| 4 | ″ | ″ | ″ | ″ | ″ | ″ | ″ | ″ | fixed | 30% |
| 5 | ″ | ″ | ″ | ″ | ″ | ″ | ″ | ″ | fixed | 34% |
| 14 | ″ | ″ | ″ | ″ | ″ | ″ | ″ | 4.3 | fixed | 38% |
| 15 | ″ | ″ | ″ | ″ | ″ | ″ | ″ | ″ | fixed | 41% |
| 16 | ″ | ″ | ″ | ″ | ″ | ″ | ″ | 4 | fixed | 30% |
| 17 | ″ | ″ | ″ | ″ | ″ | ″ | ″ | ″ | fixed | 35% |
| 18 | ″ | ″ | ″ | ″ | ″ | ″ | ″ | ″ | fixed | 40% |
| 19 | ″ | ″ | ″ | ″ | ″ | ″ | ″ | ″ | fixed | 44% |
| 3c | CTA | Ac | 2.81 | — | 0.00 | 2.81 | 11.7 | 5.1 | no str | no str |
| 20 | ″ | ″ | ″ | ″ | ″ | ″ | ″ | ″ | fixed | 22% |
| 6 | ″ | ″ | ″ | ″ | ″ | ″ | ″ | ″ | fixed | 25% |
| 7 | ″ | ″ | ″ | ″ | ″ | ″ | ″ | ″ | fixed | 30% |
| 21 | ″ | ″ | ″ | ″ | ″ | ″ | ″ | 5.9 | fixed | 20% |
| 22 | ″ | ″ | ″ | ″ | ″ | ″ | ″ | ″ | fixed | 25% |
| 23 | ″ | ″ | ″ | ″ | ″ | ″ | ″ | 6.4 | fixed | 25% |
| 24 | ″ | ″ | ″ | ″ | ″ | ″ | ″ | 7 | fixed | 16% |
| 4c | CTA | Ac | 2.80 | — | 0.00 | 2.80 | 11.7 | 5.1 | no str | no str |
| 8 | ″ | ″ | ″ | ″ | ″ | ″ | ″ | ″ | fixed | 25% |
| 9 | ″ | ″ | ″ | ″ | ″ | ″ | ″ | ″ | fixed | 30% |
| 5c | CTA | Ac | 2.79 | ″ | 0.00 | 2.79 | 11.7 | 5.1 | no str | no str |
| 10 | ″ | ″ | ″ | ″ | ″ | ″ | ″ | ″ | fixed | 25% |
| 11 | ″ | ″ | ″ | ″ | ″ | ″ | ″ | ″ | fixed | 30% |
| 6c | CAP | Ac | 1.90 | Pr | 0.80 | 2.79 | 11.7 | — | no str | no str |
| 12 | ″ | ″ | ″ | ″ | ″ | ″ | ″ | ″ | fixed | 25% |
| 13 | ″ | ″ | ″ | ″ | ″ | ″ | ″ | 5.1 | fixed | 30% |

| | | | | | | | | | |
|---|---|---|---|---|---|---|---|---|---|
| 7c | CTA | Ac | 2.87 | — | 0.00 | 2.87 | 11.7 | — | no stretch |

| | | | |
|---|---|---|---|
| | | linear thermal expansion | film color *2 |
| dry film | optical charac. | rate | ΔE*ab |

| Ex. | thickness | Re | Rth | MD | TD | | 90° C. | 140° C. | |
|---|---|---|---|---|---|---|---|---|---|
| No. | (μm) | (nm) | (nm) | (ppm) | (ppm) | MD/TD | 500 hr | 24 hr | remarks |
| 1c | 92 | 3 | 152 | 58 | 64 | 0.91 | + | ± | comp. ex. |
| 1 | 92 | 34 | 166 | 64 | 47 | 1.36 | + | + | invention |
| 2 | 92 | 41 | 171 | 66 | 42 | 1.57 | + | + | invention |
| 2c | 92 | 5 | 182 | 58 | 62 | 0.94 | + | ± | comp. ex. |
| 3 | 92 | 61 | 215 | 63 | 50 | 1.26 | + | + | invention |
| 4 | 92 | 65 | 220 | 65 | 47 | 1.38 | + | + | invention |
| 5 | 87 | 70 | 220 | 66 | 46 | 1.43 | + | + | invention |
| 14 | 85 | 70 | 200 | 66 | 46 | 1.43 | + | + | invention |
| 15 | 85 | 75 | 210 | 67 | 45 | 1.49 | + | + | invention |
| 16 | 84 | 70 | 185 | 64 | 47 | 1.36 | + | + | invention |
| 17 | 84 | 75 | 190 | 65 | 46 | 1.41 | + | + | invention |
| 18 | 84 | 80 | 192 | 66 | 45 | 1.47 | + | + | invention |
| 19 | 82 | 85 | 195 | 66 | 44 | 1.50 | + | + | invention |
| 3c | 92 | 7 | 188 | 59 | 61 | 0.97 | + | ± | comp. ex. |
| 20 | 58 | 40 | 200 | 62 | 51 | 1.22 | + | + | invention |
| 6 | 92 | 63 | 222 | 63 | 49 | 1.29 | + | + | invention |
| 7 | 92 | 67 | 228 | 65 | 47 | 1.38 | + | + | invention |
| 21 | 92 | 60 | 216 | 62 | 50 | 1.24 | + | + | invention |
| 22 | 92 | 70 | 210 | 63 | 49 | 1.29 | + | + | invention |
| 23 | 92 | 70 | 220 | 64 | 49 | 1.31 | + | + | invention |
| 24 | 92 | 43 | 208 | 61 | 50 | 1.22 | + | + | invention |
| 4c | 92 | 6 | 193 | 58 | 61 | 0.95 | + | ± | comp. ex. |
| 8 | 92 | 65 | 230 | 63 | 51 | 1.24 | + | + | invention |
| 9 | 92 | 70 | 232 | 65 | 49 | 1.33 | + | + | invention |
| 5c | 92 | 8 | 200 | 58 | 61 | 0.95 | + | ± | comp. ex. |
| 10 | 92 | 68 | 234 | 62 | 50 | 1.24 | + | + | invention |
| 11 | 92 | 72 | 236 | 64 | 48 | 1.33 | + | + | invention |
| 6c | 92 | 3 | 33 | 80 | 82 | 0.98 | + | + | comp. ex. |
| 12 | 92 | 22 | 92 | 83 | 47 | 1.77 | + | + | invention |
| 13 | 92 | 62 | 200 | 90 | 55 | 1.64 | + | ± | invention |
| 7c | 92 | 2 | 38 | 58 | 65 | 0.89 | + | + | comp. ex. |

*1: a 2/1 mixture (in weight) of TPP (triphenyl phosphate) and BDP (biphenyl diphenyl phosphate)
*2: “+” represents ΔE*ab of 0.5 or less, and “±” represents ΔE*ab of not less than 0.5 and less than 0.7.

In Table 1, 1c, 2c, 3c, 4c, 5c, 6c and 7c are unstretched comparative film samples.

Results shown in Table 1 indicate, in a comparison, at a same stretching factor, on a total substitution degree (A+B) of 2.87 (examples Nos. 1 and 2), 2.82 (Nos. 3-5), 2.81 (Nos. 6 and 7), 2.80 (Nos. 8 and 9) and 2.79 (Nos. 10 and 11), that the optical characteristics in Re and Rth increase with a decrease in the total substitution degree. Also in a comparison at a same substitution degree, Re and Rth increase with an increase in the stretching factor.

The linear thermal expansion rates D(MD) and D(TD) do not show a clear difference to the total substitution degree, in a comparison at a same stretching factor. On the other hand, in a comparison at a same substitution degree, an increase in the stretching factor reduces the thermal expansion rate in the stretching direction (TD) but increases the thermal expansion rate in the perpendicular direction (MD) (comparisons between Nos. 1 and 2, Nos. 3, 4 and 5, Nos. 6 and 7, Nos. 8 and 9, and Nos. 10 and 11). In the unstretched samples, the thermal expansion rate is approximately same in TD and MD because they are isotropic in planar direction. A comparison of TAC and CAP at a same stretching factor (for example Nos. 11 and 30) indicates that the linear expansion rate in TD is approximately same, but the linear expansion rate in MD is larger in CAP and a ratio D(MD)/D(TD) is therefore larger in CAP. As will be explained later, an optical compensation ability in a liquid crystal display is lowered when the linear expansion rates in MD and TD are in certain ranges.

The coloration of the film is rated as (±) only in the unstretched samples. A reason for this result is not clarified but is estimated as follows. As a stretching process reduces a free volume of the film, a path (free volume) in which the retardation developing agent can be move in the film is reduced under a forced environmental condition of 140° C., and the retardation developing agent becomes difficult to diffuse in the film. Such restricted movement is considered to reduce the opportunity of interaction with the microdomain of the plasticizer, thereby suppressing the deterioration of the plasticizer or the retardation developing agent. Thus, a restricted movement (diffusion) of the retardation developing agent in the film prevents coloration. Based on this fact, in the absence of the retardation developing agent in CAP having a larger free volume (Nos. 6c and 12), the coloration is not observed both in the unstretched sample (No. 6c) and in the stretched sample (No. 12).

Also the use of the retardation developing agent is found to further improve the optical characteristics (Nos. 12 and 13).

Also in the films obtained in the present examples had an Re distribution and an Rth distribution respectively of 1.2-5% and 3-10%. Also a film thickness distribution R in the transversal direction was 1-7%.

Also in the films obtained in the present examples, the modulus at 25° C. was within a range of 1500-5000 MPa in the samples cut longitudinally in MD and TD, and the breaking strength BS in these samples was 7-12 kgf/mm² in BS(MD) and 13-18 kgf/mm² in BS(TD). Also samples stretched in MD or TD showed an excellent dimensional stability of 5% or less even under an environmental change. Also examples containing a plasticizer showed a water content at 25° C., 80% RH of 2.3 or less, showing an excellent dimensional stability in humidity.

Also in a comparison at a same total substitution degree, the humidity dependence is found to become lower at a larger propyl (butylyl) substitution degree. Also in the films 1-16 and 1-23, the sum of the substitution degree of 6-position hydroxyl group was respectively 0.87 and 0.88.

In all the cases, the haze was 0.1-0.9, the matting agent had a secondary average particle size of 1.0 μm or less, and the weight change after standing for 48 hours under 80° C., 90% RH was 0-3%. Also the dimensional change after standing for 24 hours under 60° C., 95% RH and 90° C., 5% RH was 0-4.5%. Also in any sample, the optoelastic coefficient was 50×10⁻¹³ cm²/dyne or less.

When films were prepared with thicknesses of 100, 110, 120, 130, 150 and 160 μm after the drying shown in Table 1, Re and Rth increased approximately in proportion to the film thickness and the moisture permeability was approximately in inverse proportion to the film thickness. Also moisture dependences ΔRe, ΔRth of Re and Rth, a glass transition temperature and a water content remained same regardless of the film thickness. Results are shown in Table 2. The optical characteristics regulating coefficient a was within a range of 594-661 in the samples 4-11 shown in Table 1 and 623 and 633 in the samples 22 and 23.

TABLE 2

| | | | | Bu/Pr group | | | | | | | | | | |
|---|---|---|---|---|---|---|---|---|---|---|---|---|---|---|
| | | Ac group | | | | total | | retard. | | | dry | | | |
| Ex. | cotton | | subst. | | subst. | subst. | Plasticizer *1 | develop. | stretch factor | | thickness | Re | Rth | |
| No. | type | type | deg. A | type | deg. B | deg A + B | TPP/BDP | agent | MD | TD | (μm) | (nm) | (nm) | remarks |
| 2-1 | CAP | Ac | 1.90 | Pr | 0.80 | 2.70 | 11.7 | — | fixed | 25% | 110 | 27 | 112 | invention |
| 2-2 | ″ | ″ | ″ | ″ | ″ | ″ | ″ | ″ | fixed | 39% | 110 | 50 | 135 | invention |
| 2-3 | ″ | ″ | ″ | ″ | ″ | ″ | ″ | ″ | fixed | 39% | 120 | 57 | 149 | invention |
| 2-4 | ″ | ″ | ″ | ″ | ″ | ″ | ″ | ″ | fixed | 39% | 130 | 62 | 162 | invention |
| 2-5 | ″ | ″ | ″ | ″ | ″ | ″ | ″ | ″ | fixed | 39% | 140 | 66 | 175 | invention |
| 2-6 | ″ | ″ | ″ | ″ | ″ | ″ | ″ | ″ | fixed | 39% | 150 | 72 | 188 | invention |
| 2-7 | ″ | ″ | ″ | ″ | ″ | ″ | ″ | ″ | fixed | 39% | 160 | 75 | 192 | invention |

*1: a 2/1 (weight ratio) mixture of TPP (triphenyl phosphate and BDP (biphenyl diphenyl phosphate)

When films of Table 3 were prepared by changing the retardation developing agent solution A in Table 1 to the solution B, Re was approximately same as in Table 1 but Rth was somewhat lowered. Also moisture dependences ΔRe, ΔRth of Re and Rth, a glass transition temperature and a water content remained almost same. The optical characteristics regulating coefficient a was 353 and 403 in the samples 3-1 and 3-2 in Table 3, also within a range of 587-650 in the samples 3-3 to 3-11, and 618 and 625 in the samples 3-22 and 3-23.

TABLE 3

| | | | | | | total | | | | |
|---|---|---|---|---|---|---|---|---|---|---|
| | | Ac group | | Bu/Pr group | | sub | Plasticizer | retard. | | |
| Ex. | cotton | | sub | | sub. | deg. | *1 | dev. | stretching factor | |
| No. | type | type | deg. A | type | deg. B | A + B | TPP/BDP | agent | MD | TD |
| 3-1 | CTA | Ac | 2.87 | — | 0 | 2.87 | 11.7 | 5.1 | fixed | 25% |
| 3-2 | ″ | ″ | ″ | ″ | ″ | ″ | ″ | ″ | fixed | 30% |
| 3-3 | CTA | Ac | 2.82 | — | 0 | 2.82 | 11.7 | 5.1 | fixed | 27% |
| 3-4 | ″ | ″ | ″ | ″ | ″ | ″ | ″ | ″ | fixed | 34% |
| 3-5 | ″ | ″ | ″ | ″ | ″ | ″ | ″ | ″ | fixed | 37% |
| 3-6 | CTA | Ac | 2.81 | — | 0 | 2.81 | 11.7 | 5.1 | fixed | 25% |
| 3-7 | ″ | ″ | ″ | ″ | ″ | ″ | ″ | ″ | fixed | 30% |
| 3-22 | ″ | ″ | ″ | ″ | ″ | ″ | ″ | 5.9 | fixed | 25% |
| 3-23 | ″ | ″ | ″ | ″ | ″ | ″ | ″ | 6.4 | fixed | 25% |
| 3-8 | CTA | Ac | 2.80 | — | 0.00 | 2.80 | 11.7 | 5.1 | fixed | 25% |
| 3-9 | ″ | ″ | ″ | ″ | ″ | ″ | ″ | ″ | fixed | 30% |
| 3-10 | CTA | Ac | 2.79 | — | 0 | 2.79 | 11.7 | 5.1 | fixed | 25% |
| 3-11 | ″ | ″ | ″ | ″ | ″ | ″ | ″ | ″ | fixed | 30% |

| | | | | linear thermal expansion | | | film color *2 | | |
|---|---|---|---|---|---|---|---|---|---|
| | dry film | optical charac. | | rate | | | Δ*ab | | |
| Ex. | thickness | Re | Rth | MD | TD | MD/ | 90° C. | 140° C. | |
| No. | (μm) | (nm) | (nm) | (ppm) | (ppm) | TD | 500 hr | 24 hr | remarks |
| 3-1 | 92 | 33 | 158 | 64 | 47 | 1.36 | + | + | invention |
| 3-2 | 92 | 40 | 167 | 66 | 42 | 1.57 | + | + | invention |
| 3-3 | 92 | 64 | 210 | 63 | 50 | 1.26 | + | + | invention |
| 3-4 | 92 | 72 | 210 | 65 | 48 | 1.35 | + | + | invention |
| 3-5 | 92 | 74 | 213 | 66 | 47 | 1.40 | + | + | invention |
| 3-6 | 92 | 63 | 222 | 63 | 49 | 1.29 | + | + | invention |
| 3-7 | 92 | 67 | 228 | 65 | 48 | 1.35 | + | + | invention |
| 3-22 | 92 | 70 | 205 | 63 | 49 | 1.29 | + | + | invention |
| 3-23 | 92 | 70 | 212 | 64 | 49 | 1.31 | + | + | invention |
| 3-8 | 92 | 65 | 220 | 63 | 51 | 1.24 | + | + | invention |
| 3-9 | 92 | 70 | 223 | 65 | 49 | 1.33 | + | + | invention |
| 3-10 | 92 | 68 | 228 | 62 | 50 | 1.24 | + | + | invention |
| 3-11 | 92 | 72 | 225 | 64 | 48 | 1.33 | + | + | invention |

*1: a 2/1 (weight ratio) mixture of TPP (triphenyl phosphate and BDP (biphenyl diphenyl phosphate)
*2: “+” represents ΔE*ab of 0.5 or less, and “±” represents ΔE*ab of not less than 0.5 and less than 0.7.

### Example 2

### Polarizing Plate

<2-1-1>

(Preparation of Polarizing Plate 1)

A polarizer was prepared by adsorbing iodine on a stretched polyvinyl alcohol film.

A cellulose acylate film prepared in Example 1 (Nos. 1-13, Nos. 1c-7c, corresponding to TAC1 in FIG. 1) was adhered with a polyvinyl alcohol adhesive onto a side of the polarizer. A saponification treatment was conducted under following conditions.

A 1.5N aqueous solution of sodium hydroxide was prepared and maintained at 55° C. Also a 0.01N aqueous solution of sulfuric acid was prepared and maintained at 35° C. The prepared cellulose acylate film was immersed in the sodium hydroxide aqueous solution for 2 minutes, and then immersed in water to sufficiently wash off the sodium hydroxide aqueous solution. Then it was immersed in the aforementioned dilute sulfuric acid aqueous solution for 1 minute, and then immersed in water to sufficiently wash off the sulfuric acid aqueous solution. Finally the sample was sufficiently dried at 120° C.

A commercial cellulose triacetate film (Fujitac TD80UF, manufactured by Fuji Photo Film Co., corresponding to the functional film TAC2 in FIG. 2 or 3) was subjected to a saponification treatment, then adhered with a polyvinyl alcohol adhesive to the other side of the polarizer and dried for 10 minutes or longer at 70° C.

A transmission axis of the polarizer and a slow axis of the cellulose acylate film prepared in Example 1 were positioned parallel (FIG. 1). The transmission axis of the polarizer and a slow axis of the commercially cellulose triacetate film were positioned perpendicularly.

Polarizing plates A1-A13 and A1c-A7c thus prepared (optical compensation film-integrated polarizing plate without the functional film in FIG. 2) were immediately stored, in a part, in a moisture impermeable bag, and, in another part, stored in a moisture impermeable bag after a humidity control for 2 hours at 25° C., 60% RH. The moisture impermeable bag was a packaging material having a laminate structure of polyethylene terephthalate/aluminum/polyethylene, having a moisture permeability of 0.01 mg/m²/24 hr or less.

<2-2-1>

(Preparation of Light Scattering Layer Coating Liquid)

50 g of a mixture of pentaerythritol triacrylate and pentaerythritol tetraacrylate (PETA, manufactured by Nippon Kayaku Co.) were diluted with 38.5 g of toluene. Also 2 g of a polymerization initiator (Irgacure 184, manufactured by Ciba Specialty Chemicals Co.) were added and mixed under agitation. A film obtained by coating and ultraviolet curing of this solution showed a refractive index of 1.51.

To this solution, there were added 1.7 g of a 30% toluene dispersion obtained by dispersing crosslinked polystyrene particles of an average particle size of 3.5 μm (refractive index: 1.60, SX-350, manufactured by Soken Chemical & Engineering Co.) for 20 minutes at 10,000 rpm in a Polytron disperser, and 13.3 g of a 30% toluene dispersion of crosslinked acryl-styrene particles of an average particle size of 3.5 μm (refractive index: 1.55, manufactured by Soken Chemical & Engineering Co.), and finally 0.75 g of a fluorinated surface modifying agent (FP-1), and 10 g of a silane coupling agent (KBM-5103, manufactured by Shin-Etsu Chemical Co.) to obtain a completed liquid.

The mixed liquid was filtered with a polypropylene filter of a pore size of 30 μm to obtain a coating liquid for the light scattering layer.

<2-2-2>

(Preparation of Lower Refractive Index Coating Liquid)

At first a sol liquid a was prepared in the following manner. In a reactor equipped with an agitator and a reflux condenser, 120 parts of methyl ethyl ketone, 100 parts of acryloyloxypropyl trimethoxysilane (KBM-5103, manufactured by Shin-Etsu Chemical Co.) and 3 parts of diisopropylaluminum ethyl acetate were mixed, then 30 parts of ion-exchanged water were added and the mixture was reacted for 4 hours at 60° C. and cooled to the room temperature to obtain a sol liquid a. It had a weight-averaged molecular weight of 1,600, and, among components equal to or larger than oligomers, components with a molecular weight of 1,000 to 20,000 represented 100%. Also a gas chromatography analysis indicated that the acryloyloxypropyl trimethoxysilane employed as the raw material did not remain at all.

13 g of a thermally crosslinkable fluorine-containing polymer of a refractive index 1.42 (JN-7228, solid concentration: 6%, manufactured by JSR Corp.), 1.3 g of silica sol (a different grade in size of silica MEK-ST, average particle size: 45 nm, solid content: 30%, manufactured by Nissan Chemical Industries Ltd.), 0.6 g of the aforementioned sol liquid a, 5 g of methyl ethyl ketone and 0.6 g of cyclohexanone were added and mixed, and filtered by a polypropylene filter of a pore size of 1 μm to obtain a coating liquid for a lower refractive index layer.

<2-2-3>

(Preparation of Transparent Protective Film 01 with Light Scattering Layer)

A triacetyl cellulose film of a thickness of 80 μm (TAC-TD80U, manufactured by Fuji Photo Film Co., Ltd.) in a roll form was unwound and coated with the aforementioned coating liquid for the functional layer (light scattering layer), utilizing a microgravure roll of a diameter of 50 mm having a gravure pattern of lines of 180 line/inch and a depth of 40 μm and a doctor blade, under conditions of a gravure roll revolution of 30 rpm and a transporting speed of 30 m/min, then dried for 150 seconds at 60° C., and irradiated with an ultraviolet light of an illumination intensity of 400 mW/cm² and an illumination amount of 250 mJ/cm² utilizing an air-cooled metal halide lamp of 160 W/cm (manufactured by Eyegraphics Co.) under nitrogen purging to cure the coated layer, thereby obtaining a functional layer of a thickness of 6 μm. The film was thereafter wound again.

The triacetyl cellulose film coated with the functional layer (light scattering layer) was unwound again and coated with the prepared coating liquid for the lower refractive index layer, utilizing a microgravure roll of a diameter of 50 mm having a gravure pattern of lines of 180 line/inch and a depth of 40 μm and a doctor blade, under conditions of a gravure roll revolution of 30 rpm and a transporting speed of 15 m/min, then dried for 150 seconds at 120° C., further dried to 8 minutes at 140° C., and irradiated with an ultraviolet light of an illumination intensity of 400 mW/cm² and an illumination amount of 900 mJ/cm² utilizing an air-cooled metal halide lamp of 240 W/cm (manufactured by Eyegraphics Co.) under nitrogen purging to obtain a lower refractive index layer of a thickness of 100 nm (corresponding to functional film TAC2 in FIG. 2 or TAC2-1 in FIG. 3). The film was thereafter wound again.

<2-3-1>

(Preparation of Polarizing Plate 2)

A polarizer was prepared by adsorbing iodine on a stretched polyvinyl alcohol film.

The prepared transparent protective film 01 with light scattering layer was subjected to a saponification treatment as in <2-1-1>, and a side thereof without the functional film and a side of the polarizer were adhered with a polyvinyl alcohol adhesive.

A cellulose acylate film prepared in Example 1 (Nos. 1-13, Nos. 1c-7c, corresponding to TAC1 in FIG. 1) was subjected to a similar saponification treatment and adhered with a polyvinyl alcohol adhesive onto an opposite side of the polarizer and dried for 10 minutes or more at 70° C. (thereby completing the structure shown in FIG. 2).

A transmission axis of the polarizer and a slow axis of the cellulose acylate film prepared in Example 1 were positioned parallel (FIG. 1). The transmission axis of the polarizer and a slow axis of the transparent protective film 01 with light scattering layer were positioned perpendicularly. Polarizing plates (B1-B13; polarizing plate integrated with a functional film and an optical compensation film (FIG. 2)) were thus prepared. As described in the preparation of polarizing plate <2-1-1>, there were prepared samples stored in a moisture impermeable bag after a humidity control for 2 hours at 25° C., 60% RH, and those stored in a moisture impermeable bag without a humidity control.

Also a polarizer was prepared by adsorbing iodine on a stretched polyvinyl alcohol film. A transparent protective film 01 with light scattering layer prepared in <2-2-3> and a triacetyl cellulose film of a thickness of 80 μm (TAC-TD80U, manufactured by Fuji Photo Film Co., Ltd.) without coating of a functional layer were subjected to a saponification treatment as described above, and were adhered with a polyvinyl alcohol adhesive on the polarizer as described above. In this manner a polarizing plate (B0: polarizing plate integral with a functional film and an optical compensation film (FIG. 2)) was prepared. As described in the preparation of polarizing plate <2-1-1>, there were prepared samples stored in a moisture impermeable bag after a humidity control, and those stored in a moisture impermeable bag without a humidity control.

A spectral reflectance at an incident angle of 5° within a wavelength range of 380-780 nm was measured from the side of the functional film, with a spectrophotometer (manufactured by Jasco Corp.), to obtain an integrating sphere average reflectance in a wavelength range of 450-650 nm of 2.3%.

A measurement, with a spectrophotometer (UV3100PC), of a single-plate transmittance TT, a parallel transmittance PT, and a cross transmittance CT in such a combination that the optical compensation film was positioned at the inner side of the polarizer and in a range of 380-780 nm provided, in an average of 400-700 nm, TT of 40.8-44.7, PT of 34-38.8 and CT of 1.0 or less. Also in a polarizing plate durability test for 500 hours at 60° C., 95% RH, there were obtained results within ranges of −0.1≦ΔCT≦0.2, and −2.0≦ΔP≦0. Also under conditions of 60° C., 90% RH there were obtained results of −0.05≦ΔCT≦0.15 and −1.5≦ΔP≦0.

<2-4-1>

(Preparation of Coating Liquid for Hard Coat Layer)

750.0 parts by weight of trimethylolpropane triacrylate (TMPTA, manufactured by Nippon Kayaku Co.), 270.0 parts by weight of poly(glycidyl methacrylate) of a weight-averaged molecular weight of 3,000, 730.0 parts by weight of methyl ethyl ketone, 500.0 parts by weight of cyclohexanone and 50.0 parts by weight of a photopolymerization initiator (Irgacure 184, manufactured by Nippon Ciba-Geigy Ltd.) were added, agitated and filtered by a polypropylene filter of a pore size of 0.4 μm to obtain a coating liquid for a hard coat layer.

<2-4-2>

(Preparation of Titanium Dioxide Particle Dispersion)

As the titanium dioxide particles, there were employed titanium dioxide particles containing cobalt and subjected to a surface treatment with aluminum hydroxide and zirconium hydroxide (MPT-129, manufactured by Ishihara Sangyo Co.).

To 257.1 g of these particles, 38.6 g of a following dispersant, and 704.3 g of cyclohexanone were added and dispersed in a Dyno mill to obtain a titanium dioxide dispersion with a weight-averaged particle size of 70 nm.

Dispersant

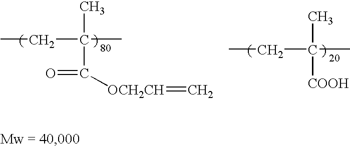

<2-4-3>

(Preparation of Coating Liquid for Medium Refractive Index Layer)

To 88.9 g of the titanium dioxide dispersion, 58.4 g of a mixture of dipentaerythritol pentaacrylate and dipentaerythritol hexaacrylate (DPHA), 3.1 g of a photopolymerization initiator (Irgacure 907, manufactured by Chiba Specialty Chemicals Co.), 1.1 g of a photosensitizer (Kayacure DETX, manufactured by Nippon Kayaku Co.), 482.4 g of methyl ethyl ketone and 1869.8 g of cyclohexanone were added and agitated. After a sufficient agitation, the mixture was filtered with a polypropylene filter of a pore size of 0.4 μm to obtain a coating liquid for a medium refractive index layer.

<2-4-4>

(Preparation of Coating Liquid for Higher Refractive Index Layer)

To 586.8 g of the titanium dioxide dispersion, 47.9 g of a mixture of dipentaerythritol pentaacrylate and dipentaerythritol hexaacrylate (DPHA, manufactured by Nippon Kayaku Co.), 4.0 g of a photopolymerization initiator (Irgacure 907, manufactured by Nippon Chiba-Geigy Ltd.), 1.3 g of a photosensitizer (Kayacure DETX, manufactured by Nippon Kayaku Co.), 455.8 g of methyl ethyl ketone and 1427.8 g of cyclohexanone were added, agitated and filtered with a polypropylene filter of a pore size of 0.4 μm to obtain a coating liquid for a higher refractive index layer.

<2-4-5>

(Preparation of Coating Liquid for Lower Refractive Index Layer)

A following copolymer was dissolved at a concentration of 7 weight % in methyl isobutyl ketone, and a terminal methacrylate group-containing silicone resin X-22-164C (manufactured by Shin-Etsu Chemical Co.) in an amount of 3 weight % with respect to the solid, and a photoradical generating agent Irgacure 907 (trade name) in an amount of 5 weight % with respect to the solid were added to obtain a coating liquid for a lower refractive index layer.

Copolymer

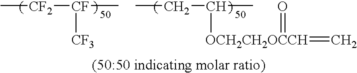

<2-4-6>

(Preparation of Transparent Protective Film 02 with Antireflection Film)

On a cellulose triacetate film of a thickness of 80 μm (TD80UF, manufactured by Fuji Photo Film Co., Ltd.), the coating liquid for the hard coat layer was coated with a gravure coater. After a drying at 100° C., it was irradiated with an ultraviolet light of an illumination intensity of 400 mW/cm² and an illumination amount of 300 mJ/cm² utilizing an air-cooled metal halide lamp of 160 W/cm (manufactured by Eyegraphics Co.) under nitrogen purging so as to obtain an atmosphere with an oxygen concentration of 1.0 vol. % or less to cure the coated layer, thereby obtaining a hard coat layer of a thickness of 8 μm.

On the obtained hard coat layer, the coating liquid for the medium refractive index layer, the coating liquid for the higher refractive index layer and the coating liquid for the lower refractive index layer were coated in continuation with a gravure coater having three coating stations.

The drying conditions for the medium refractive index layer were 2 minutes at 100° C., and the ultraviolet curing conditions were an illumination intensity of 400 mW/cm² and an illumination amount of 400 mJ/cm² utilizing an air-cooled metal halide lamp of 180 W/cm (manufactured by Eyegraphics Co.) under nitrogen purging to obtain an oxygen concentration of 1.0 vol. % or less. The medium refractive index layer after curing had a refractive index of 1.630 and a thickness of 67 nm.

The drying conditions for the higher refractive index layer and the lower refractive index layer were 1 minute at 90° C. and then 1 minute at 100° C., and the ultraviolet curing conditions were an illumination intensity of 600 mW/cm² and an illumination amount of 600 mJ/cm² utilizing an air-cooled metal halide lamp of 240 W/cm (manufactured by Eyegraphics Co.) under nitrogen purging to obtain an oxygen concentration of 1.0 vol. % or less.

The higher refractive index layer after curing had a refractive index of 1.905 and a thickness of 107 nm, and the lower refractive index layer after curing had a refractive index of 1.440 and a thickness of 85 nm. In this manner a transparent protective film 02 with an antireflection layer (corresponding to functional film TAC2 in FIG. 2 or 3) was prepared.

<2-5-1>

(Preparation of Polarizing Plate 3)

Polarizing plates (C1 to C19: polarizing plate integral with functional film and optical compensation film (FIG. 2)) were prepared in a similar manner as in <2-3-1> except that the transparent protective film 01 with light scattering layer was replaced by the transparent protective film 02 with light scattering layer. Also in a similar process, there was prepared a polarizing plate (C0) utilizing a transparent protective film 02 with antireflection layer and a triacetyl cellulose film of a thickness of 80 μm (TAC-TD80U, manufactured by Fuji Photo Film Co., Ltd.).

A spectral reflectance at an incident angle of 5° within a wavelength range of 380-780 nm was measured from the side of the functional film, with a spectrophotometer (manufactured by Jasco Corp.), to obtain an integrating sphere average reflectance in a wavelength range of 450-650 nm of 0.4%.

### Example 3

### Mounting on Panel

### Example 3-1

### Mounting on VA-Mode Panel

### Single Plate Type

A liquid crystal display shown in FIG. 3 was prepared. More specifically, in an order from an observing side (upper side), there were laminated an upper side polarizing plate (TAC2, with/without functional film, a polarizer, and TAC1), a VA-mode liquid crystal cell, and a lower side polarizing plate (TAC1, polarizer, and TAC2), and a backlight source was provided. In the following examples, a commercially available polarizing plate (HLC2-5618) was employed as the upper-side polarizing plate and a polarizing plate integral with an optical compensation film was employed as the lower-side polarizing plate, but such arrangement may be inverted without any difficulty. However, the integral polarizing plate is considered to be used more frequently as the lower-side polarizing plate (in case it is employed as the upper-side polarizing plate, a functional film has to be provided at the observing side (upper side) whereby a production yield may be reduced), so that the aforementioned arrangement is considered as a more preferable embodiment.

<Preparation of Liquid Crystal Cell>

A liquid crystal cell was prepared by preparing substrates with a cell gap of 3.6 μm, pouring a liquid crystal compound having a negative dielectric constant anisotropy (MLC6608, manufactured by Merck Inc.) between the substrates and sealing the substrate thereby forming a liquid crystal layer between the substrates. The liquid crystal layer had a retardation (a product Δn-d of a thickness d (μm) of the liquid crystal layer and a refractive index anisotropy Δn) of 300 nm, and the liquid crystal was aligned in a vertical alignment.

In a liquid crystal display (FIG. 3) utilizing the aforementioned vertical alignment liquid crystal cell, a commercially available super high contrast grade (for example HLC2-5618 manufactured by Sanritz Co.) was employed as an upper-side polarizing plate (observing side). Also as a lower-side polarizing plate (backlight side) there was employed a polarizing plate (A3-A11) prepared in Example 2, <2-1-1> utilizing an optical compensation sheet (Nos. 3-11) prepared in Example 1, in such a manner that the cellulose acylate film prepared in Example 1 (corresponding to TAC1-2 in FIG. 3) was positioned at the side of the liquid crystal cell. The upper-side polarizing plate and the lower-side polarizing plate were adhered with an adhesive to the liquid crystal cell. A cross Nicol arrangement was formed by placing the transmission axis of the upper-side polarizing plate in a vertical direction and the transmission axis of the lower-side polarizing plate in a lateral direction. In preparing the liquid crystal display, there were employed a polarizing plate stored in a sealed moisture impermeable bag after a humidity control for 2 hours under conditions of 25° C., 60% RH, and a polarizing plate stored in a sealed moisture impermeable bag without a humidity control.

The prepared liquid crystal display employed the commercial product in the upper-side polarizing plate and the integral polarizing plate of the invention in the lower-side polarizing plate. In an observation of such liquid crystal display, a neutral black display was realized in a front direction and in an angled viewing direction. Also a measuring instrument (EZ-Contrast 160D, manufactured by ELDIM Ltd.) was used to measure a viewing angle (a range showing a contrast ratio of 10 or higher and not showing a gradational inversion at black side) in 8 levels from a black display (L1) to a white display (L8).

Then a color hue in a black display, at a directional angle of 45° in the lateral direction of the liquid crystal display panel and a polar angle of 60° with respect to a normal line to the display panel, was measured with a measuring instrument (EZ-Contrast 160D, manufactured by ELDIM Ltd.) to obtain an initial value. Then the panel was let to stand for 1 week in a room of a normal temperature and a normal humidity (about 25° C., 60% RH without humidity control) and the color hue in a black display was measured again.

Results of measurements of the viewing angle and the change in hue are shown in Table 4. All the samples showed a wide viewing angle and little hue change. Particularly little hue change was observed in the samples in which the polarizing plate was subjected to a humidity control prior to the assembling of the liquid crystal display.

### Example 3-2

In a liquid crystal display (FIG. 3) utilizing the aforementioned vertical alignment liquid crystal cell, a polarizing plate (A3-A11) prepared in Example 2, <2-1-1> utilizing an optical compensation sheet (Nos. 3-11) prepared in Example 1 was adhered as a lower-side polarizing plate, and a polarizing plate (B0) prepared in Example 2, <2-3-1> was adhered as an upper-side polarizing plate, utilizing an adhesive. A cross Nicol arrangement was formed by placing the transmission axis of the polarizing plate of the observing side in a vertical direction and the transmission axis of the polarizing plate of the backlight side in a lateral direction. In executing these operations, the work space was air conditioned at a temperature of 20-25° C. and a humidity of 50-70% RH. In preparing the liquid crystal display, there were employed a polarizing plate stored in a sealed moisture impermeable bag after a humidity control for 2 hours under conditions of 25° C., 60% RH, and a polarizing plate stored in a sealed moisture impermeable bag without a humidity control.

In an observation of thus prepared liquid crystal display, a neutral black display was realized in a front direction and in an angled viewing direction. Also measurements were made on the viewing angle and the change in hue as in Example 3-1, and results are shown in Table 4.

### Example 3-3

In a liquid crystal display (FIG. 3) utilizing the aforementioned vertical alignment liquid crystal cell, a polarizing plate (A3-A13) prepared in Example 2, <2-1-1> utilizing an optical compensation sheet (Nos. 3-11) prepared in Example 1 was adhered as a lower-side polarizing plate, and a polarizing plate (C0) prepared in Example 2, <2-5-1> was adhered as an upper-side polarizing plate, utilizing an adhesive. A cross Nicol arrangement was formed by placing the transmission axis of the polarizing plate in the observing side in a vertical direction and the transmission axis of the polarizing plate of the backlight side in a lateral direction. In executing these operations, the work space was air conditioned at a temperature of 20-25° C. and a humidity of 50-70% RH. In preparing the liquid crystal display, there were employed a polarizing plate stored in a sealed moisture impermeable bag after a humidity control for 2 hours under conditions of 25° C., 60% RH, and a polarizing plate stored in a sealed moisture impermeable bag without a humidity control.

In an observation of thus prepared liquid crystal display, a neutral black display was realized in a front direction and in an angled viewing direction. Also measurements were made on the viewing angle and the change in hue as in Example 3-1, and results are shown in Table 4.

### Comparative Example 3-1

A process was conducted in the identical manner as in Example 3-1 except that the lower-side polarizing plate was replaced by A3c, B3c or C3c. The employed polarizing plate was not subjected to a humidity control.

In an observation of thus prepared liquid crystal display, a neutral black display was realized in a front direction and in an angled viewing direction. Also measurements were made on the viewing angle and the change in hue as in Example 3-1, and results are shown in Table 4.

TABLE 4

| | viewing angle | | |
|---|---|---|---|
| | | direction at | |
| Liquid | direction of | 45° from | |
| crystal | transmission | transmission | black hue change (ΔE*) at |
| display | axis | axis | 1 week after assembling |
| Ex. 3-1 | >80° | >80° | 0.010-0.013 (no humidity control) |
| | | | 0.002 (with humidity control) |
| Ex. 3-2 | ″ | ″ | 0.010-0.013 (no humidity control) |
| | | | 0.002 (with humidity control) |
| Ex. 3-3 | ″ | ″ | 0.010-0.013 (no humidity control) |
| | | | 0.002 (with humidity control) |
| Comp. | 65° | 63° | 0.020-0.032 (no humidity control) |
| Ex. 3-1 | | | |

### Example 3-4

### Mounting on VA-Mode Panel

### Two Plate Type

A liquid crystal display shown in FIG. 3 was prepared. More specifically, in an order from an observing side (upper side), there were laminated an upper side polarizing plate (TAC2 without functional film, a polarizer, and TAC1), a VA-mode liquid crystal cell, and a lower side polarizing plate (TAC1, polarizer, and TAC2), and a backlight source was provided.

<Preparation of Liquid Crystal Cell>

A liquid crystal cell was prepared by preparing substrates with a cell gap of 3.6 μm, pouring a liquid crystal compound having a negative dielectric constant anisotropy (MLC6608, manufactured by Merck Inc.) between the substrates and sealing the substrate thereby forming a liquid crystal layer between the substrates. The liquid crystal layer had a retardation (a product Δn-d of a thickness d (μm) of the liquid crystal layer and a refractive index anisotropy Δn) of 300 nm, and the liquid crystal was aligned in a vertical alignment.

In a liquid crystal display (FIG. 3) utilizing the aforementioned vertical alignment liquid crystal cell, a polarizing plate (A14) prepared in Example 2, <2-1-1> utilizing an optical compensation sheet (No. 14) prepared in Example 1 was employed as an upper-side polarizing plate and as a lower-side polarizing plate, and adhered with an adhesive on each of the observing side and the backlight side, in such a manner that the cellulose acylate film prepared in Example 1 (corresponding to TAC1-1 and TAC1-2 in FIG. 3) was positioned at the side of the liquid crystal cell. A cross Nicol arrangement was formed by placing the transmission axis of the polarizing plate of the observing side in a vertical direction and the transmission axis of the polarizing plate of the backlight side in a lateral direction. In executing these operations, the work space was air conditioned at a temperature of 20-25° C. and a humidity of 50-70% RH. In preparing the liquid crystal display, there were employed a polarizing plate stored in a sealed moisture impermeable bag after a humidity control for 2 hours under conditions of 25° C., 60% RH, and a polarizing plate stored in a sealed moisture impermeable bag without a humidity control.

In an observation of such liquid crystal display, a neutral black display was realized in a front direction and in an angled viewing direction. Also a measuring instrument (EZ-Contrast 160D, manufactured by ELDIM Ltd.) was used to measure a viewing angle (a range showing a contrast ratio of 10 or higher and not showing a gradational inversion at black side) in 8 levels from a black display (L1) to a white display (L8).

Then a color hue in a black display, at a directional angle of 45° in the lateral direction of the liquid crystal display panel and a polar angle of 60° with respect to a normal line to the display panel, was measured with a measuring instrument (EZ-Contrast 160D, manufactured by ELDIM Ltd.) to obtain an initial value. Then the panel was let to stand for 1 week in a room of a normal temperature and a normal humidity (about 25° C., 65% RH without a humidity control) and the color hue in a black display was measured again.

Results of measurements of the viewing angle and the change in hue are shown in Table 5. All the samples showed a wide viewing angle and little hue change. Particularly little hue change was observed in the samples in which the polarizing plate was subjected to a humidity control prior to the assembling of the liquid crystal display.

### Comparative Example 3-4

In a liquid crystal display (FIG. 3) utilizing the vertical alignment liquid crystal cell, a polarizing plate (A2c or A6c) prepared in Example 2, <2-1-1> utilizing an optical compensation sheet (No. 2c or 6c) prepared in Comparative Example was employed as an upper-side polarizing plate and as a lower-side polarizing plate, and adhered with an adhesive on each of the observing side and the backlight side, in such a manner that the cellulose acylate film prepared in Example 1 (TAC1) was positioned at the side of the liquid crystal cell. A cross Nicol arrangement was formed by placing the transmission axis of the upper-side polarizing plate in a vertical direction and the transmission axis of the lower-side polarizing plate in a lateral direction.

Also in a liquid crystal display (FIG. 3) utilizing the vertical alignment liquid crystal cell, a polarizing plate (A2c or A6c) prepared in Example 2, <2-1-1> utilizing an optical compensation sheet (No. 2c or 6c) prepared in Example 1 was adhered as a lower-side polarizing plate, and a polarizing plate (B3 or B17) prepared in Example 2, <2-3-1> was adhered as an upper-side polarizing plate, in such a manner that the cellulose acylate film (TAC1) prepared in Example 1 was positioned at the side of the liquid crystal cell, utilizing an adhesive. A cross Nicol arrangement was formed by placing the transmission axis of the upper-side polarizing plate in a vertical direction and the transmission axis of the lower-side polarizing plate in a lateral direction.

Furthermore, in a liquid crystal display (FIG. 3) utilizing the vertical alignment liquid crystal cell, a polarizing plate (A2c or A6c) prepared in Example 2, <2-1-1> utilizing an optical compensation sheet (No. 2c or 6c) prepared in Example 1 was adhered as a lower-side polarizing plate, and a polarizing plate (C3 or C17) prepared in Example 2, <2-3-1> was adhered as an upper-side polarizing plate, in such a manner that the cellulose acylate film (TAC1) prepared in Example 1 was positioned at the side of the liquid crystal cell, utilizing an adhesive. A cross Nicol arrangement was formed by placing the transmission axis of the upper-side polarizing plate in a vertical direction and the transmission axis of the lower-side polarizing plate in a lateral direction.

In executing these operations, the work space was air conditioned at a temperature of 20-25° C. and a humidity of 50-70% RH. The employed polarizing plates were not subjected to a humidity control.

Results are shown in Table 5. In comparison with the case of the polarizing plate of the invention, the polarizing plate of the comparative example showed a more evident change in hue.

TABLE 5

| | viewing angle | | |
|---|---|---|---|
| | | direction at | |
| Liquid | direction of | 45° from | |
| crystal | transmission | transmission | black hue change (ΔE*) at |
| display | axis | axis | 1 week after assembling |
| Ex. 3-4 | >80° | >80° | 0.010-0.013 (no humidity |
| | | | control) |
| | | | 0.002 (with humidity control) |
| Comp. | >80° | >80° | 0.020-0.032 (no humidity |
| Ex. 3-1 | | | control) |

### INDUSTRIAL APPLICABILITY

A liquid crystal display of the invention shows little change in viewing angle characteristics under environmental changes.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

The present application claims foreign priority based on Japanese Patent Application Nos. JP2004-196011, JP2004-278942 and JP2005-51963, filed Jul. 1, 2004, Sep. 27, 2004 and Feb. 25, 2005, respectively, the contents of which is incorporated herein by reference.

1. A cellulose acylate film comprising a cellulose acylate as a polymer component, wherein the cellulose acylate is a fatty acid ester of cellulose, and a hydroxyl group of the cellulose is substituted with an acetyl group or an acyl group having 3 or more carbon atoms,
wherein the cellulose acylate film is a film stretched substantially by 10% or more in a casting direction or in a transversal direction perpendicular to the casting direction, and the cellulose acylate film satisfies relations (II) to (IV):
30 ppm≦D(MD)≦90 ppm (II)
25 ppm≦D(TD)≦90 ppm (III)
1.0≦D(MD)/D(TD)≦5.0 (IV)
wherein D(MD) represents a linear thermal expansion rate in the casting direction, and D(TD) represents a linear thermal expansion rate D(TD) in the traverse direction.

2. The cellulose acylate film according to claim 1, which satisfies a relation (I):
2.0≦A+B≦3.0 (I)
wherein A represents a substitution degree of the acetyl group, and B represents a substitution degree of the acyl group having 3 or more carbon atoms.

3. The cellulose acylate film according to claim 1, which has a color difference ΔE*ab before and after a standing for 500 hours at 90° C. of 0.5 or less and a color difference before and after a standing for 24 hours at 140° C. of 1.5 or less.

4. The cellulose acylate film according to claim 1, wherein the linear thermal expansion rates D(MD) and D(TD) satisfy a relation (V):
50 ppm≦D(MD)≦75 ppm,30 ppm D(TD)≦75 ppm (V).

5. The cellulose acylate film according to claim 1, which satisfies relations (VI-a), (VI-b) and (VI):
2.0≦DS2+DS3+DS6≦3.0 (VI-a)
DS6/(DS2+DS3+DS6)≧0.315 (VI-b)
1.0≦D(MD)/D(TD)≦3.0 (VI)
wherein DS2 represents a substitution degree of a 2-position hydroxyl group of a glucose unit of the cellulose acylate film by the acetyl group or the acyl group, D3 represents a substitution degree of a 3-position hydroxyl group by the acetyl group or the acyl group, and D6 represents a substitution degree of a 6-position hydroxyl group by the acetyl group or the acyl group.

6. The cellulose acylate film according to claim 1, wherein the acyl group is a butanoyl group.

7. The cellulose acylate film according to claim 1, wherein the acyl group is a propionyl group, and the substitution degree B is 0.6 or higher.

8. The cellulose acylate film according to claim 1, wherein Re(λ) and Rth(λ) defined by relations (IX) and (X), respectively, satisfy relations (IX) to (XII):
Re(λ)=(nx−ny)×d (IX)
Rth(λ)={(nx+ny)/2−nz}×d (X)
30 nm≦Re₍₅₉₀₎≦200 nm (XI)
70 nm≦Rth₍₅₉₀₎≦400 nm (XII)
wherein Re(λ) is a retardation value by nm in a film plane of the cellulose acylate film at a wavelength λ nm, Rth(λ) is a retardation value by nm in a thickness direction of the cellulose acylate film at a wavelength λ nm, nx is a refractive index in a slow axis direction of the film plane, ny is a refractive index in a fast axis direction of the film plane, nz is refractive index in the thickness direction, and d is a thickness of the cellulose acylate film.

9. The cellulose acylate film as described in claim 8, wherein Re₍₅₉₀₎ and Rth₍₅₉₀₎ satisfy relations (XIII) and (XIV):
40≦Re₍₅₉₀₎≦100 (XIII)
170 nm≦Rth₍₅₉₀₎≦300 nm (XIV).

10. The cellulose acylate film as described in claim 1, which comprises at least one retardation generating agent of a rod-shaped or discotic compound.

11. The cellulose acylate film as described in claim 1, which comprises at least one of a plasticizer, an ultraviolet absorber and a peeling accelerator.

12. The cellulose acylate film as described in claim 1, which has a thickness of 40 to 180 μm.

13. The cellulose acylate film as described in claim 1, wherein a difference ΔRe between an Re value at 25° C., 10% RH and an Re value at 25° C., 80% RH is 0 to 10 nm, and a difference ΔRth between an Rth value at 25° C., 10% RH and an Rth value at 25° C., 80% RH is 0 to 30 nm.

14. The cellulose acylate film according to claim 1, wherein the cellulose acylate film is a film stretched by one of a monoaxial stretching method, a simultaneous biaxial stretching method and a successive biaxial stretching method.

15. The cellulose acylate film as described in claim 1, wherein Re₍₆₃₀₎ and Rth₍₆₃₀₎ at 25° C., 60% RH satisfy relations (A) to (C):
46≦Re₍₆₃₀₎≦150 (A)
Rth₍₆₃₀₎=a−5.9Rth₍₆₃₀₎ (B)
580≦a≦670 (C)
wherein Re₍₆₃₀₎ is a retardation value by nm in a film plane of the cellulose acylate film at a wavelength of 630 nm, Rth₍₆₃₀₎ is a retardation value by nm in a thickness direction of the cellulose acylate film at a wavelength of 630 nm, and a is a regulating coefficient by nm of an optical characteristics of the cellulose acylate film.

16. The cellulose acylate film according to claim 1, which has a thickness distribution R of 0 to 8%, the thickness distribution R being calculated by R(%)=(Rₘₐₓ−Rₘᵢₙ)/Rₐᵥₑ×100, wherein Rₘₐₓ, Rₘᵢₙ and Rₐᵥₑ represents a maximum value, a minimum value and an average value of a thickness in the transversal direction, respectively.

17. The cellulose acylate film as described in claim 1, which has a Re₍₅₉₀₎ distribution of 5% or less.

18. The cellulose acylate film as described in claim 1, which has a Rth₍₅₉₀₎ distribution of 10% or less.

19. The cellulose acylate film as described in claim 1, wherein the cellulose acylate has a polymerization degree of 250 to 350 and a total substitution degree of 2.65 to 2.95, and the cellulose acylate film satisfies relations:
6 kgf/mm²≦BS(MD)≦14 kgf/mm²
12 kgf/mm²≦BS(TD)≦20 kgf/mm²
wherein BS(MD) represents a breaking strength of the cellulose acylate film in the casting direction, and BS(TD) represents a breaking strength of the cellulose acylate film in a transversal direction.

20. A polarizing plate comprising: two protective films; and a polarizer between the two protective film, wherein one of the two protective films is a cellulose acylate film according to claim 1.

21. The polarizing plate according to claim 20, which satisfies at least one of formulae (a) to (d):
40.0≦TT≦45.0 (a)
30.0≦PT≦40.0 (b)
CT≦2.0 (c)
95.0≦P (d)
wherein TT represents a single plate transmittance at 25° C. and 60% RH, PT represents a parallel transmittance at 25° C. and 60% RH, CT represents a cross transmittance at 25° C. and 60% RH, and P represents a polarization at 25° C., 60% RH.

22. The polarizing plate according to claim 20, which satisfies at least one of formulae (e) to (g):
T₍₃₈₀₎≦2.0 (e)
T₍₄₁₀₎≦1.0 (f)
T₍₇₀₀₎≦0.5 (g)
wherein T(λ) represent a cross transmittance at the wavelength of λ nm.

23. The polarizing plate according to claim 20, which satisfies at least one of formulae (j) and (k):
−6.0≦ΔCT≦6.0 (j)
−10.0≦ΔP≦0 (k)
wherein ΔCT and ΔP represents a change in cross transmittance and polarization degree, respectively, in a test that the polarizing plate is allowed to stand at 60° C. and 95% RH for 500 hours; and the change means a value obtained by subtracting a measurement value before the test from a measurement value after the test.

24. The polarizing plate according to claim 23, wherein one of the two protective films comprises at least one of a hard coat layer, an antiglare layer and an antireflective layer.

25. A liquid crystal display comprising a polarizing plate according to claim 20.

26. A liquid crystal display of an OCB or VA mode comprising two polarizing plates according to claim 20; and a liquid crystal cell between the two polarizing plates.

27. A liquid crystal display of a VA mode comprising a liquid crystal cell; a backlight; and a polarizing plate according to claim 20 between the liquid crystal cell and the backlight.
